(19) United States
(12) Patent Application Publication
(10) Pub. No.: US 2025/0392362 A1
(43) Pub. Date: Dec. 25, 2025

(54) METHODS, TERMINAL DEVICE, NETWORK DEVICE, AND MEDIUM FOR COMMUNICATION

(71) Applicant: NEC CORPORATION, Tokyo (JP)

(72) Inventors: Yukai GAO, Beijing (CN); Peng GUAN, Beijing (CN); Gang WANG, Beijing (CN)

(73) Assignee: NEC CORPORATION, Tokyo (JP)

(21) Appl. No.: 18/879,493

(22) PCT Filed: Jul. 1, 2022
(86) PCT No.: PCT/CN2022/103477

§ 371 Date: Dec. 27, 2024

(51) Int. Cl. H04B 7/06; H04W 72/0446

(52) U.S. Cl. CPC H04B 7/0626; H04B 7/0639; H04W 72/0446

(57) ABSTRACT

Example embodiments of the present disclosure relate to methods, devices, and computer storage medium for communication. A method for communication comprises determining, at a terminal device, whether to apply Doppler/time domain compression or a Doppler/time domain basis type for reporting a precoding matrix indicator (PMI) to a network device. The method further comprises transmitting, to the network device, an indication of whether to apply the Doppler/time domain compression or the Doppler/time domain basis type. In this way, it is more flexible to switch between high/medium mobility and low mobility. Therefore, communication performance for high/medium mobility terminal devices can be improved, without increasing overhead for low mobility terminal devices.

### FIELD

Example embodiments of the present disclosure generally relate to the field of communication techniques and in particular, to methods, a terminal device, a network device, and a computer readable medium for communication.

### BACKGROUND

Several technologies have been proposed to improve communication performances. For example, multi-input multi-output (MIMO) has been proposed. MIMO includes features that facilitate utilization of a large number of antenna elements at base station for both sub-6 GHz and over-6 GHz frequency bands. Precoding is a generalized beamforming scheme to support multi-layer transmission in a MIMO system. Using precoding, multiple streams are transmitted from the transmit antennas with independent and appropriate weighting per antenna such that the throughput is maximized at the receiver output.

However, in the scenario where a terminal device (also referred to as “user equipment”, UE) is moving at a relatively high velocity, when the terminal device begins to measure to prepare for a measurement report at a first time point, there may be a suitable first codebook for the first time point. When the terminal device finishes preparation for the measurement report at a second time point, there may be a suitable second codebook for the second time point. Due to the high velocity and position change of the terminal device, there may be differences between the first codebook and the second codebook, which may lead to inappropriate precoding results and degrade the communication performance.

### SUMMARY

In general, example embodiments of the present disclosure provide a solution for reporting a precoding matrix indicator (PMI) by a terminal device to a network device.

In a first aspect, there is provided a method for communication. The method comprises determining, at a terminal device, whether to apply Doppler/time domain compression or a Doppler/time domain basis type for reporting a precoding matrix indicator (PMI) to a network device; and transmitting, to the network device, an indication of whether to apply the Doppler/time domain compression or the Doppler/time domain basis type.

In a second aspect, there is provided a method for communication. The method comprises receiving, at a network device from a terminal device, an indication of whether Doppler/time domain compression or a Doppler/time domain basis type is to be applied for reporting a precoding matrix indicator (PMI) to the network device; and processing, based on the indication, the PMI reported by the terminal device.

In a third aspect, there is provided a terminal device. The terminal device comprises a processor and a memory storing computer program codes. The memory and the computer program codes are configured to, with the processor, cause the terminal device to perform the method according to the first aspect above.

In an fourth aspect, there is provided a network device. The network device comprises a processor and a memory storing computer program codes. The memory and the computer program codes are configured to, with the processor, cause the network device to perform the method according to the second aspect above.

In a fifth aspect, there is provided a computer readable medium having instructions stored thereon. The instructions, when executed by a processor of an apparatus, cause the apparatus to perform the method according to the first aspect or the second aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates a schematic diagram of a communication environment in which embodiments of the present disclosure can be implemented;

FIG. 2A illustrates a schematic diagram of spatial domain, frequency domain and Doppler/time domain basis according to conventional schemes;

FIG. 2B illustrates a schematic diagram of spatial domain, frequency domain and Doppler/time domain basis according to conventional schemes;

FIG. 3 illustrates a signalling chart illustrating communication process in accordance with some embodiments of the present disclosure;

FIG. 4A illustrates a schematic bitmap of a configuration of parameters in accordance with some embodiments of the present disclosure;

FIG. 4B illustrates a schematic bitmap of a configuration of parameters in accordance with some embodiments of the present disclosure;

FIG. 5A illustrates a schematic diagram with Doppler/time compression in accordance with some embodiments of the present disclosure;

FIG. 5B illustrates a schematic diagram without Doppler/time compression in accordance with some embodiments of the present disclosure;

FIG. 5C illustrates a schematic diagram without Doppler/time in accordance with some embodiments of the present disclosure;

FIG. 6 illustrates a schematic diagram without Doppler/time compression in accordance with some embodiments of the present disclosure;

FIG. 7 illustrates a schematic diagram without Doppler/time in accordance with some embodiments of the present disclosure;

FIG. 8A illustrates a schematic diagram without Doppler/time compression in accordance with some embodiments of the present disclosure;

FIG. 8B illustrates a schematic diagram without Doppler/time compression in accordance with some embodiments of the present disclosure;

FIG. 8C illustrates a schematic diagram without Doppler/time compression in accordance with some embodiments of the present disclosure;

FIG. 9 illustrates a schematic diagram of a CSI structure in accordance with some embodiments of the present disclosure;

FIG. 10 illustrates a flowchart of an example method 1000 implemented at a terminal device in accordance with some embodiments of the present disclosure;

FIG. 11 illustrates a flowchart of an example method 1100 implemented at a network device in accordance with some embodiments of the present disclosure;

FIG. 12 illustrates a simplified block diagram of a device 1200 that is suitable for implementing embodiments of the present disclosure;

FIG. 13 illustrates a timing diagram in accordance with some embodiments of the present disclosure;

FIG. 14 illustrates a signaling process in accordance with some embodiments of the present disclosure;

FIGS. 15A-15B illustrate an example of a set of Channel Quality Indicators (CQI) reported in accordance with some embodiments of the present disclosure;

FIGS. 16A-16B illustrate an example of multiple sets of CQIs reported in accordance with some embodiments of the present disclosure;

FIGS. 17A-17B illustrate corresponding time unit indexes reported in accordance with some embodiments of the present disclosure;

FIG. 18 illustrates a timing diagram in accordance with some example embodiments of the present disclosure;

FIGS. 19A-19C illustrate timing diagrams in accordance with some example embodiments of the present disclosure;

FIG. 20 illustrates a flowchart of an example method in accordance with some embodiments of the present disclosure; and

FIG. 21 illustrates a flowchart of an example method in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

In the following, the terms “transmission occasions”, “reception occasions”, “repetitions”, “transmission”, “reception”, “PDSCH transmission occasions”, “PDSCH repetitions”, “PUSCH transmission occasions”, “PUSCH repetitions”, “PUCCH occasions”, “PUCCH repetitions”, “repeated transmissions”, “repeated receptions”, “PDSCH transmissions”, “PDSCH receptions”, “PUSCH transmissions”, “PUSCH receptions”, “PUCCH transmissions”, “PUCCH receptions”, “RS transmission”, “RS reception”, “communication”, “transmissions” and “receptions” can be used interchangeably. The terms “TCI state”, “set of QCL parameter(s)”, “QCL parameter(s)”, “QCL assumption” and “QCL configuration” can be used interchangeably. The terms “TCI field”, “TCI state field”, and “transmission configuration indication” can be used interchangeably. The terms “transmission occasion”, “transmission”, “repetition”, “reception”, “reception occasion”, “monitoring occasion”, “PDCCH monitoring occasion”, “PDCCH transmission occasion”, “PDCCH transmission”, “PDCCH candidate”, “PDCCH reception occasion”, “PDCCH reception”, “search space”, “CORESET”, “multi-chance” and “PDCCH repetition” can be used interchangeably. In the following, the terms “PDCCH repetitions”, “repeated PDCCHs”, “repeated PDCCH signals”, “PDCCH candidates configured for same scheduling”, “PDCCH”, “PDCCH candidates” and “linked PDCCH candidates” can be used interchangeably. The terms “DCI” and “DCI format” can be used interchangeably. In some embodiments, the embodiments in this disclosure can be applied to PDSCH and PUSCH scheduling, and in the following, PDSCH scheduling is described as examples. For example, the embodiments in this disclosure can be applied to PUSCH by replacing “transmit” to “receive” and/or “receive” to “transmit”. The terms “PDSCH” and “PUSCH” can be used interchangeably. The terms “transmit” and “receive” can be used interchangeably. The terms “common beam”, “common beam update/indicate/indication”, “unified TCI state”, “unified TCI state update/indicate/indication”, “beam indication”, “TCI state(s) indication”, “TCI_state_r17”, “tci_Stateld_r17”, “TCI_state_r17 indicating a unified TCI state”, “TCI state shared/applied for all or subset of CORESETs and UE-dedicated reception on PDSCH”, “Rel-17 TCI state”, “TCI state with tci_Stateld_r17”, “TCI state configured for TCI state update in unified TCI framework”, “TCI state indicated in DCI for common beam update/indicate/indication” and “TCI state indicated in DCI and to be applied for all/subset of CORESETs and PDSCH” may be used interchangeably. The terms “subset of CORESETs”, “subset of TCI states”, “subset of unified TCI states”, “subset of downlink (unified) TCI states” and “subset of joint (unified) TCI states” may be used interchangeably. The terms “subset of PUCCHs”, “subset of TCI states”, “subset of unified TCI states”, “subset of uplink (unified) TCI states” and “subset of joint (unified) TCI states” may be used interchangeably. The terms “precoding matrix”, “precoding”, “beam”, “beamforming”, “codebook” and “precoder” may be used interchangeably. The terms “size” and “number of PRBs” may be used interchangeably. The terms “vector”, “beam”, “bases” and “basis” can be used interchangeably. The terms “first vector”, “first beam”, “first bases”, “spatial domain basis vectors”, “spatial domain vectors”, “spatial domain basis”, “spatial domain bases” and “first basis” can be used interchangeably. The terms “second vector”, “second beam”, “second bases”, “frequency domain basis vectors”, “frequency domain vectors”, “frequency domain basis”, “frequency domain bases” and “second basis” can be used interchangeably. The terms “third vector”, “third beam”, “third bases”, “Doppler/time domain basis vectors”, “Doppler/time domain vectors”, “Doppler/time domain basis”, “Doppler/time domain bases”, “Doppler domain basis vectors”, “Doppler domain vectors”, “Doppler domain basis”, “Doppler domain bases”, “time domain basis vectors”, “time domain vectors”, “time domain basis”, “time domain bases” and “third basis” can be used interchangeably. The terms “index”, “indicator”, “indication”, “field”, “bit field” and “bitmap” can be used interchangeably. The terms “physical resource block”, “resource block”, “PRB” and “RB” can be used interchangeably. The terms “bit size”, “size of bits”, “number of bits”, “size of field” and “field size” can be used interchangeably. The terms “time unit”, “Doppler unit”, “a unit in time domain”, “a unit in Doppler domain”, “time point” and “a unit for the third vector” can be used interchangeably.

As mentioned above, precoding is a generalized beamforming scheme to support multi-layer transmission in a MIMO system. Precoding is a technique that exploits transmit diversity by weighting the information stream, i.e. the transmitter sends the coded information to the receiver to achieve pre-knowledge of the channel. Using precoding, multiple streams are transmitted from the transmit antennas with independent and appropriate weighting per antenna such that the throughput is maximized at the receiver output. The terms “precoding matrix”, “precoding”, “beam”, “codebook” and “precoder” may be used interchangeably hereinafter. Moreover, it may be possible that uplink transmission with 8 antenna ports can support more than 4 layers.

To facilitate precoding, CSI (Channel State Information) is measured by the terminal device and reported to the network device. The terminal device obtains CSI information by measuring one or more downlink reference signal (such as one or more cell-specific reference signal or CSI-RS or CSI-RS for tracking or tracking RS (TRS)). The CSI reported by the terminal device can reflect the channel quality of the PRBs (physical resource block) which are allocated to the specific terminal device, and can also reflect the channel quality of the PRBs which are not allocated to the specific terminal device. CSI reporting may be periodic, and may also be aperiodic (event-triggered).

In some embodiments, CSI may comprise at least one of CQI (Channel Quality Indicator), PMI (Precoding Matrix Indicator), CSI-RS resource indicator (CRI), synchronization signal/physical broadcast channel (SS/PBCH) block resource indicator (SSBRI), layer indicator (LI), layer-1 reference signal received power (L1-RSRP), layer-1 signal-to-noise and interference ratio (L1-SINR), capabilityIndex, capabilitysetIndex, PTI (Precoding Type Indicator) and RI (Rand Indication). RI indicates the transmission rank which the terminal device suggests the network device to use in downlink transmission. In other words, RI is the number of layers the terminal device suggests the network device to use in downlink transmission. PMI indicates the precoder matrix which the terminal device suggests the network device to use in the downlink transmission. The precoder matrix is selected based on the assumption that “the number of layers indicated by the reported RI” is used. The PMI reported by the terminal device can only be selected from the codebook defined by the 3GPP specifications.

For the PMI suggestions received from the terminal device, the network device may adopt the last reported PMI suggestions for further downlink transmission with the terminal device, by simply sending an acknowledgement message to the terminal device. Once the terminal device receives this acknowledgement message, it will use the configurations it has suggested the network device to demodulate and decode corresponding DL-SCH transmission. Since there is frequency selectivity when the UE computes PMI, the network device may need to use different precoder matrices for different RB combinations. In this way, CSI report from the terminal device is used to facilitate precoding and improve communication performance.

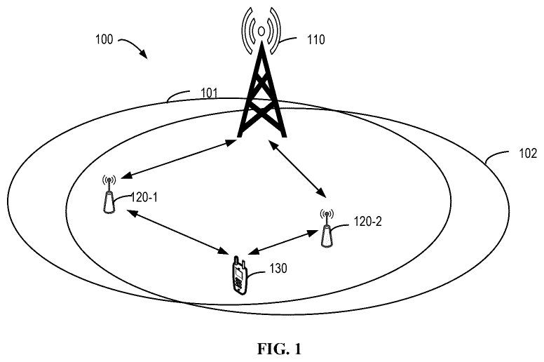

FIG. 1 illustrates an example communication network 100 in which embodiments of the present disclosure can be implemented. As shown in FIG. 1, the network 100 includes a network device 110. For example, the network device 110 may be configured with one or two or three or four TRPs/panels 120-1 and/or 120-2 and/or 120-3 and/or 120-4 (collectively referred to as TRPs 120 or individually referred to as TRP 120). The network 100 also includes a terminal device 130 served by the network device 110. The serving area of the network device 110 is called as a cell 101 and/or a cell 102. It is to be understood that the number of network devices, terminal devices and TRPs as shown in FIG. 1 is only for the purpose of illustration without suggesting any limitations to the present disclosure. The network 100 may include any suitable number of network devices, terminal devices and/or serving cells adapted for implementing implementations of the present disclosure. Although not shown, it would be appreciated that one or more terminal devices may be located in the cell 101 and/or cell 102 and served by the network device 110.

In some scenarios, carrier aggregation (CA) can be supported in the network 100, in which two or more CCs are aggregated in order to support a broader bandwidth. For example, in FIG. 1, the network device 110 may provide to the terminal device 130 a plurality of serving cells including one primary cell (Pcell or Pscell or Spcell) 101 corresponding to a primary CC and at least one secondary cell (Scell) 102 corresponding to at least one secondary CC. It is to be understood that the number of scells is only for the purpose of illustration without suggesting any limitations to the present disclosure. The network 100 may include any suitable number of scells adapted for implementing implementations of the present disclosure.

In some other scenarios, the terminal device 130 may establish connections with two different network devices (not shown in FIG. 1) and thus can utilize radio resources of the two network devices. The two network devices may be respectively defined as a master network device and a secondary network device. The master network device may provide a group of serving cells, which are also referred to as “Master Cell Group (MCG)”. The secondary network device may also provide a group of serving cells, which are also referred to as “Secondary Cell Group (SCG)”. For Dual Connectivity operation, a term “Special Cell (Spcell)” may refer to the Pcell of the MCG or the primary Scell (Pscell) of the SCG depending on if the terminal device 130 is associated to the MCG or the SCG, respectively. In other cases than the Dual Connectivity operation, the term “SpCell” may also refer to the PCell.

In one embodiment, the terminal device 130 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 130 from at least one of the first network device and the second network device. In one embodiment, first information may be transmitted to the terminal device 130 from the first network device and second information may be transmitted to the terminal device 130 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or Downlink Control Information (DCI).

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, Ultra-Reliable Low latency Communication (URLLC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 130.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like. The term “TRP” refers to an antenna array (with one or more antenna elements) available to the network device located at a specific geographical location. For example, a network device may be coupled with multiple TRPs in different geographical locations to achieve better coverage. It is to be understood that the TRP can also be referred to as a “panel”, which also refers to an antenna array (with one or more antenna elements) or a group of antennas.

In one embodiment, the terminal device 130 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 130 from at least one of the first network device and the second network device. In one embodiment, first information may be transmitted to the terminal device 130 from the first network device and second information may be transmitted to the terminal device 130 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or Downlink Control Information (DCI).

In some embodiments, the network device 110 may communicate with the terminal device 130 via a first TRP (for example, TRP 120-1) and/or a second TRP (for example, TRP 120-2) and/or a third TRP (for example, TRP 120-3) and/or a fourth TRP (for example, TRP 120-4). For example, the first TRP and/or the second TRP and/or the third TRP and/or the fourth TRP may be included in a same serving cell or different serving cells provided by the network device 110. Although some embodiments of the present disclosure are described with reference to the first TRP and/or the second TRP and/or the third TRP and/or the fourth TRP within same serving cell provided by the network device 110, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

In the communication network 100, the network device 110 can communicate data and control information to the terminal device 130 and the terminal device 130 can also communication data and control information to the network device 110. A link from the network device 110 to the terminal device 130 is referred to as a downlink (DL), while a link from the terminal device 130 to the network device 110 is referred to as an uplink (UL).

The communications in the network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like.

Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the first TRP and/or the second TRP and/or the third TRP and/or the fourth TRP may be explicitly associated with different higher-layer configured identities. For example, a higher-layer configured identity can be associated with a Control Resource Set (CORESET), a reference signal (RS), or a Transmission Configuration Indication (TCI) state, which is used to differentiate between transmissions between different TRPs 120 and the terminal device 130.

The term “slot” used herein refers to a dynamic scheduling unit. One slot comprises a predetermined number of symbols. For example, the number of symbols in one slot may be 12 or 14. The term “sub-slot” may refer to a number of symbols. For example, the number of symbols in one sub-slot may be 1, 2, 4, 7, or 14. The sub-slot may comprise fewer symbols than one slot. The slot used herein may refer to a normal slot which comprises a predetermined number of symbols and also refer to a sub-slot which comprises fewer symbols than the predetermined number of symbols.

In some embodiments, the terminal device 130 may receive, from the network device 110, at least one configuration for codebook, wherein the at least one configuration for codebook may include at least one of: a plurality of CSI-RS resources, a plurality of antenna ports for one CSI-RS resource, at least one parameter for antenna port configuration, a configuration for codebook type, a configuration for reporting type, at least one parameter for codebook, a number of physical resource blocks (PRBs) in a bandwidth part (BWP), a number of a plurality of first subbands, a size of one first subband, a number of PRBs of one first subband, a number of a plurality of second subbands (e.g. represented as N₃), a size of one second subband, a number of PRBs of one second subband, a number of a plurality of time units (e.g. represented as N₄), a size of one time unit (e.g. represented as Tᵤ or Tᵢ), a number of slots/subslots/symbols of one time unit (e.g. represented as Tᵤ or T_{g}), a number of a plurality of first vectors (e.g. represented as L), a number of a plurality of second vectors (e.g. represented as Mᵥ), a number of a plurality of third vectors (e.g. represented as M_{d}), a first parameter for codebook (e.g. represented as R), a second parameter for codebook (e.g. represented as pᵥ), a third parameter for codebook (e.g. represented as β), a fourth parameter for codebook (e.g. represented as R_{d}), a fifth parameter for codebook (e.g. represented as p_{v,d}), and a sixth parameter for codebook (e.g. represented as β_{d}).

In some embodiments, a number of the plurality of CSI-RS resources may be a positive integer. For example, the number of the plurality of CSI-RS resources may be larger than or equal to 1 and smaller than or equal to 64. In some embodiments, a number of the plurality of antenna ports for one CSI-RS resource may be a positive integer. For example, the number of the plurality of antenna ports for one CSI-RS resource may be at least one of {1, 2, 4, 8, 12, 16, 24, 32}.

In some embodiments, the terminal device 130 may transmit, to the network device 110, a number of layers and at least one codebook indicator based on the at least one configuration for codebook. In some embodiments, the at least one codebook indicator may comprise at least one of: one or more indicators for a plurality of first vectors, one or more indicators for a plurality of second vectors, one or more indicators for a plurality of third vectors, a field for a plurality of first amplitude coefficients corresponding to one layer with an index, a field for a plurality of second amplitude coefficients corresponding to one layer with an index, a field for a plurality of phase coefficients corresponding to one layer with the index, a bitmap for indicating nonzero coefficients corresponding to one layer with the index and an indicator of strongest coefficient corresponding to one layer with the index. In some embodiments, the bitmap for indicating nonzero coefficients may indicate which coefficients in the field for the plurality of second amplitude coefficients are nonzero or reported. In some embodiments, the bitmap for indicating nonzero coefficients may indicate which coefficients in the field for the plurality of phase coefficients are nonzero or reported.

In some embodiments, the at least one codebook indicator may comprise at least one of one or more fields for the plurality of second vectors and one or more fields for the plurality of third vectors. In some embodiments, one field for the plurality of second vectors may correspond to one indicator for the plurality of second vectors. In some embodiments, one field for the plurality of third vectors may correspond to one indicator for the plurality of third vectors. In some embodiments, each one of the one or more fields for the plurality of second vectors may correspond to one layer with an index. In some embodiments, each one of the one or more fields for the plurality of third vectors may correspond to one layer with an index. In some embodiments, the one or more fields for the plurality of second vectors may correspond to each layer of the number of layers. For example, the one or more fields for the plurality of second vectors may be same for each layer of the number of layers. In some embodiments, the one or more fields for the plurality of third vectors may correspond to each layer of the number of layers. For example, the one or more fields for the plurality of third vectors may be same for each layer of the number of layers.

In some embodiments, a plurality of precoding matrices or a plurality of codebooks corresponding to N₃ subbands and/or N₄ time units may be determined based on the at least one codebook indicator.

In some embodiments, the terminal device 130 may be configured with a number of PRBs for a bandwidth part (BWP) or with a size for the BWP. In some embodiments, the number of PRBs for the BWP (e.g. represented as

$${N}_{B W P}^{s i z e} )$$

may be a positive integer. For example, N_{BWP} may be a positive integer. For example,

$$24 \leq {N}_{B W P}^{s i z e} \leq 275 .$$

In some embodiments, the terminal device 130 may be configured with a starting position of the BWP (e.g. represented as

$${N}_{B W P}^{s t a r t} ) .$$

For example,

$${N}_{B W P}^{s t a r t}$$

may be a non-negative integer. For example,

$$0 \leq {N}_{B W P}^{s t a r t} \leq 275 .$$

In some embodiments, the starting position of the BWP and the number of PRBs for the BWP may be configured in one higher layer parameter.

In some embodiments, a first subband may correspond to a subband for channel quality indicator (CQI) or CQI subband or CSI subband. For example, corresponding to one time unit.

In some embodiments, the size of one first subband or the number of PRBs of one first subband may be represented as

$${N}_{P R B}^{S B} , and {N}_{P R B}^{S B}$$

is a positive integer. For example,

$$1 \leq {N}_{P R B}^{SB} \leq 32.$$

For example,

$${N}_{P R B}^{S B}$$

may be at least one of {4, 8, 16, 32}. In some embodiments,

$${N}_{P R B}^{S B}$$

may be based on the value of N_{BWP}. In some embodiments, if 24≤N_{BWP}≤72,

$${N}_{P R B}^{S B}$$

may be 4 or 8. For example,

$${N}_{P R B}^{S B}$$

may be configured to be 4 or 8 based on one higher layer parameter for subband. In some embodiments, if 73≤N_{BWP}≤144

$${N}_{P R B}^{S B}$$

may be 8 or 16. For example,

$${N}_{P R B}^{S B}$$

may be configured to be 8 or 16 based on the higher layer parameter for subband. In some embodiments, if 145≤N_{BWP}≤275,

$${N}_{P R B}^{S B}$$

may be 16 or 32. For example,

$${N}_{P R B}^{S B}$$

may be configured to be 16 or 32 based on the higher layer parameter for subband.

In some embodiments, the at least one parameter for antenna port configuration may comprise at least one of: a number of the plurality of CSI-RS resources, a number of antenna ports for one CSI-RS resource, a first plurality of antenna port groups, a number of the first plurality of antenna port groups, a number of antenna ports in one antenna port group, a first parameter of antenna port configuration and a second parameter of antenna port configuration. For example, one antenna port group may correspond to a TRP or antenna ports of a TRP. In some embodiments, one antenna port group may correspond to one CSI-RS resource. In some embodiments, the number of antenna ports may be same for each CSI-RS resource in the plurality of CSI-RS resources.

In some embodiments, the at least one configuration for codebook may comprise a plurality of antenna ports in one antenna port group or for one CSI-RS resource. In some embodiments, a number of the plurality of antenna ports in one antenna port group or for one CSI-RS resource (e.g. represented as P) may be at least one of {1, 2, 4, 6, 8, 12, 16, 24, 32}. In some embodiments, number of antenna ports in each antenna port group or for each CSI-RS resource in the plurality of CSI-RS resources may be same. For example, P may be a positive integer. For example, P may be at least one of {1, 2, 4, 6, 8, 12, 16, 24, 32}.

In some embodiments, the terminal device may receive at least one of the plurality of CSI-RS resources based on the number of antenna ports for the at least one CSI-RS resource.

In some embodiments, a value of the first parameter of antenna port configuration may be represented as N₁. For example, N₁ may be a positive integer. For example, N₁ may be at least one of {2, 3, 4, 6, 8, 12, 16}. In some embodiments, a value of the second parameter of antenna port configuration may be represented as N₂. For example, N₂ may be a positive integer. For example, N₂ may be at least one of {1, 2, 3, 4}. In some embodiments, the first parameter of antenna port configuration and the second parameter of antenna port configuration may be configured in one higher layer parameter.

In some embodiments, the number of antenna ports in one antenna port group or for one CSI-RS resource may be determined based on the first parameter of antenna port configuration and a second parameter of antenna port configuration. In some embodiments, the number of antenna ports in one antenna port group or for one CSI-RS resource may be P=N₁·N₂·2.

In some embodiments, there may be a parameter “O₁”, and “O₁” may represent a first discrete fourier transform (DFT) oversampling in the first dimension. For example, “O₁” may be at least one of {1, 2, 4}. For another example, “O₁” may be 2 or 4. In some embodiments, there may be a parameter “O₂”, and “O₂” may represent a second DFT oversampling in the second dimension. For example, “O₂” may be at least one of {1, 2, 4}. For another example, “O₂” may be 2 or 4.

In some embodiments, one configuration of (N₁, N₂) may correspond to one configuration of (O₁, O₂). In some embodiments, one configuration of (O₁, O₂) may correspond to one configuration of (N₁, N₂).

In some embodiments, the configurations of (N₁, N₂) and (O₁, O₂) and/or P may be at least one of row and/or column in the following Table 1.

TABLE 1

| P | (N₁, N₂) | (O₁, O₂) |
|---|---|---|
| 4 | (2, 1) | (4, 1) |
| 8 | (2, 2) | (4, 4) |
| 8 | (4, 1) | (4, 1) |
| 12 | (3, 2) | (4, 4) |
| 12 | (6, 1) | (4, 1) |
| 16 | (4, 2) | (4, 4) |
| 16 | (8, 1) | (4, 1) |
| 24 | (4, 3) | (4, 4) |
| 24 | (6, 2) | (4, 4) |
| 24 | (12, 1) | (4, 1) |
| 32 | (4, 4) | (4, 4) |
| 32 | (8, 2) | (4, 4) |
| 32 | (16, 1) | (4, 1) |

In some embodiments, there may be a vector uₘ. In some embodiments, uₘ may be a DFT vector. In some embodiments, if N₂>1,

$${u}_{m} = [ 1 , {e}^{j \frac{2 π m}{{O}_{2} {N}_{2}}} , ... , {e}^{j \frac{2 π m ( {N}_{2} - 1 )}{{O}_{2} {N}_{2}}} ] .$$

In some embodiments, if N₂=2,

$${u}_{m} = [ 1 , {e}^{j \frac{2 π m}{{O}_{2} {N}_{2}}} ] .$$

In some embodiments, the length of the vector uₘ may be N₂. In some embodiments, the size of the vector uₘ may be (N₂)*1 1*(N₂). In some embodiments, if N₂=1, uₘ=1. In some embodiments, m may be the index of the vector uₘ. In some embodiments, m may be a non-negative integer. For example, 0≤m≤O₂N₂−1. In some embodiments, there may be a vector v_{l,m}. In some embodiments,

$${v}_{l , m} = {[ {u}_{m} , {u}_{m} * {e}^{j \frac{2 π l}{{O}_{1} {N}_{1}}} , ... , {u}_{m} * {e}^{j \frac{2 π l ( {N}_{1} - 1 )}{{O}_{1} {N}_{1}}} ]}^{T} .$$

In some embodiments, l may be the index of the vector v_{i,m}. In some embodiments, the length of the vector v_{i,m} may be N₁*N₂ or P/2. In some embodiments, the size of the vector v_{i,m} may be (N₁*N₂)*1 or (P/2)*1 or 1*(N₁*N₂) or 1*(P/2). In some embodiments, if N₁=2 and N₂=2,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, if N₁=4 and

$${N}_{2} = 1 , {v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, l may be a non-negative integer. For example, 0≤l≤O₁N₁−1. In some embodiments, [ ]^{T} may represent a transposition of a vector or a matrix.

In some embodiments, the terminal device 130 may determine or report a number of layers and at least one codebook indicator based on the at least one configuration for codebook to the network device 110. In some embodiments, the number of layers (e.g. represented as vᵣᵢ) may be at least one of {1, 2} or {1, 2, 3, 4} or {1, 2, 3, 4, 5, 6, 7, 8}. In some embodiments, there may be a plurality of layers, and each layer may be with an index, wherein the index of a layer may be represented as r, r may be non-negative integer. For example, 1≤r≤vᵣᵢ. For example, r may be at least one of {1, 2, . . . vᵣᵢ} or {1, 2} or {1, 2, 3, 4} or {1, 2, 3, 4, 5, 6, 7, 8}.

In some embodiments, the at least one codebook indicator may comprise at least one of: one or more indicators (or a field) for a plurality of first vectors, one or more indicators (or one or more fields) for a plurality of second vectors, one or more indicators (or a field) for a first plurality of rotations for the plurality of first vectors, one or more indicators (or a field) for a plurality of third vectors, one or more indicators (or one or more fields) for a second plurality of rotations for the plurality of third vectors, one or more indicators (or one or more fields) for a strongest coefficient, one or more indicators (or a field) for a plurality of first amplitude coefficients, one or more indicators (or one or more fields) for a plurality of second amplitude coefficients, one or more indicators (or one or more fields) for a plurality of phase coefficients, a first number of nonzero coefficients, one or more indicators (or one or more bitmaps) for indicating nonzero coefficients.

In some embodiments, the one or more indicators (or one or more bitmaps) for indicating nonzero coefficients may indicate indexes of second amplitude coefficients and/or indicating indexes of phase coefficients, and values of the second amplitude coefficients corresponding to the indexes and/or the values of the phase coefficients corresponding to the indexes may be nonzero. In some embodiments, the one or more indicators (or one or more bitmaps) for indicating nonzero coefficients may indicate which coefficients in the one or more indications or in the field for the plurality of second amplitude coefficients are nonzero or reported. In some embodiments, the one or more indicators (or one or more bitmaps) for indicating nonzero coefficients may indicate which coefficients in the one or more indications or in the field for the plurality of phase coefficients are nonzero or reported.

In some embodiments, one or more of the at least one codebook indicator or field may be same or applied for each layer of the number of layers. For example, layer common. In some embodiments, each one of the one or more of the at least one codebook indicator or field may correspond to one layer with an index. For example, layer specific.

In some embodiments, the one or more indicators (or the field) for the plurality of first vectors may be same or applied for each layer of the number of layers. For example, layer common. In some embodiments, the one or more indicators (or the field) for the plurality of first vectors may correspond to one layer with an index. For example, layer specific.

In some embodiments, the one or more indicators (or the one or more fields) for the plurality of second vectors may be same or applied for each layer of the number of layers. For example, layer common. In some embodiments, the one or more indicators (or the one or more fields) for the plurality of second vectors may correspond to one layer with an index. For example, layer specific.

In some embodiments, the one or more indicators (or the field) for the first plurality of rotations for the plurality of first vectors may be same or applied for each layer of the number of layers. For example, layer common. In some embodiments, the one or more indicators (or the field) for the first plurality of rotations for the plurality of first vectors may correspond to one layer with an index. For example, layer specific.

In some embodiments, the one or more indicators (or the one or more fields) for the second plurality of rotations for the plurality of third vectors may be same or applied for each layer of the number of layers. For example, layer common. In some embodiments, the one or more indicators (or the one or more fields) for the second plurality of rotations for the plurality of third vectors may correspond to one layer with an index. For example, layer specific.

In some embodiments, the one or more indicators (or the one or more fields) for the plurality of third vectors may be same or applied for each layer of the number of layers. For example, layer common. In some embodiments, the one or more indicators (or the one or more fields) for the plurality of third vectors may correspond to one layer with an index. For example, layer specific.

In some embodiments, the indicator (or the field) for the strongest coefficient may be same or applied for each layer of the number of layers. For example, layer common. In some embodiments, the indicator (or the field) for the strongest coefficient may correspond to one layer with an index. For example, layer specific.

In some embodiments, the one or more indicators (or the one or more fields) for the plurality of first amplitude coefficients may be same or applied for each layer of the number of layers. For example, layer common. In some embodiments, the one or more indicators (or the one or more fields) for the plurality of first amplitude coefficients may correspond to one layer with an index. For example, layer specific.

In some embodiments, the one or more indicators (or the one or more fields) for the plurality of phase coefficients may be same or applied for each layer of the number of layers. For example, layer common. In some embodiments, the one or more indicators (or the one or more fields) for the plurality of phase coefficients may correspond to one layer with an index. For example, layer specific.

In some embodiments, the one or more indicators (or the one or more fields) for the plurality of second amplitude coefficients may be same or applied for each layer of the number of layers. For example, layer common. In some embodiments, the one or more indicators (or the one or more fields) for the plurality of second amplitude coefficients may correspond to one layer with an index. For example, layer specific.

In some embodiments, the one or more indicators (or the field) for indicating nonzero coefficients may be same or applied for each layer of the number of layers. For example, layer common. In some embodiments, the one or more indicators (or the field) for indicating nonzero coefficients may correspond to one layer with an index. For example, layer specific.

In some embodiments, the first number of nonzero coefficients may be same or applied for each layer of the number of layers. For example, layer common. In some embodiments, the first number of nonzero coefficients may correspond to one layer with an index. For example, layer specific.

In some embodiments, the number of the plurality of first vectors, the second parameter for codebook and the third parameter for codebook may be configured or indicated in one higher layer parameter. In some embodiments, the fifth parameter for codebook and the sixth parameter for codebook may be configured or indicated in one higher layer parameter.

In some embodiments, the second parameter for codebook may be at least one of {½, ¼, ⅛}. In some embodiments, the third parameter for codebook may be at least one of {¼, ½, ¾}. In some embodiments, the number of the plurality of first vectors (e.g. represented as L) may be at least one of {2, 4, 6} or at least one of {2, 4, 6, 8} or at least one of{2, 4, 6, 8, 12, 16, 24, 32}. In some embodiments, L may be a positive integer. In some embodiments, L may be at least one of {2, 4, 6} or at least one of {2, 4, 6, 8} or at least one of {2, 4, 6, 8, 12, 16, 24, 32}.

In some embodiments, the third parameter for codebook may further be based on number of layers. In some embodiments, one higher layer parameter may indicate L=2 and β=¼, and if number of layers is 1 or 2, pᵥ=¼, and if number of layers is 3 or 4, pᵥ=⅛. In some embodiments, one higher layer parameter may indicate L=2 and β=½, and if number of layers is 1 or 2, pᵥ=¼, and if number of layers is 3 or 4, pᵥ=⅛. In some embodiments, one higher layer parameter may indicate L=4 and β=¼, and if number of layers is 1 or 2, pᵥ=¼, and if number of layers is 3 or 4, pᵥ=⅛. In some embodiments, one higher layer parameter may indicate L=4 and/3=½, and if number of layers is 1 or 2, pᵥ=¼, and if number of layers is 3 or 4, pᵥ=⅛. In some embodiments, one higher layer parameter may indicate L=4 and β=¾, and pᵥ=¼.

In some embodiments, one higher layer parameter may indicate L=4 and β=½, and if number of layers is 1 or 2, pᵥ=½, and if number of layers is 3 or 4, pᵥ=¼. In some embodiments, one higher layer parameter may indicate L=6 and β=½, and pᵥ=¼. For example, the number of layers is 1 or 2. In some embodiments, one higher layer parameter may indicate L=6 and β=¾, and pᵥ=¼. For example, the number of layers is 1 or 2.

In some embodiments, the first parameter for codebook (For example, represented as R) may be a positive integer. For example, R may be a positive integer. For example, R may be at least one of {1, 2}. In some embodiments, a number of precoding matrices may be determined based on the first parameter for codebook, the number of the plurality of first subbands. In some embodiments, the first parameter for codebook may control the total number of precoding matrices indicated by the PMI as a function of the number of configured first subbands or the number of the plurality of first subbands, the size of one first subband and of the number of PRBs for the BWP.

In some embodiments, second subband may correspond to a subband for precoding matrix indicator (PMI) or PMI subband.

In some embodiments, the size of one second subband or the number of PRBs of one second subband may be represented as N_{PMI}, and N_{PMI} is a positive integer. For example, 1≤N_{PMI}≤32. For example, N_{PMI} may be at least one of {2, 4, 8, 16, 32}. In some embodiments, N_{PMI} may be based on

$${N}_{PRB}^{SB}$$

and R. For example,

$${N}_{PMI} = {N}_{PRB}^{SB} / R .$$

In some embodiments, the number of the plurality of second subbands N₃ or the size or the length of one second vector may be a positive integer. For example, 9≤N₃≤36. For example,

$${N}_{3} = R * {N}_{BWP}^{size} / {N}_{PRB}^{SB} .$$

For another example,

$${N}_{3} = R * ⌊ {N}_{BWP}^{size} / {N}_{PRB}^{SB} ⌋ .$$

For another example

$${N}_{3} = R * ⌈ {N}_{BWP}^{size} / {N}_{PRB}^{SB} ⌉ .$$

For another example,

$${N}_{3} = R * ⌊ {N}_{BWP}^{size} / {N}_{PRB}^{SB} ⌋ + 1.$$

For another example,

$${N}_{3} = R * ⌊ {N}_{BWP}^{size} / {N}_{PRB}^{SB} ⌋ + 2.$$

For another example,

$${N}_{3} = R * ⌊ {N}_{BWP}^{size} / {N}_{PRB}^{SB} ⌋ + 3.$$

For another example,

$${N}_{3} = R * ⌊ {N}_{BWP}^{size} / {N}_{PRB}^{SB} ⌋ + 4.$$

In some embodiments, when R=1, there may be one precoding matrix indicated for each first subband. In some embodiments, when R=2, for one first subband that is not the first/beginning one or the last/ending one of the plurality of first subbands in the BWP, there may be two precoding matrixes indicated for the one of the plurality of first subbands. For example, the first precoding matrix corresponds to the first

$${N}_{PRB}^{SB} / 2$$

PRBs of the one of the plurality of first subbands, and the second precoding matrix corresponds to the last

$${N}_{PRB}^{SB} / 2$$

PRBs of the one of the plurality of first subbands. In some embodiments, when R=2, for one first subband that is the first/beginning one or the last/ending one of the plurality of first subbands in the BWP, if

$$( {N}_{BWP}^{start} mod {N}_{PRB}^{SB} ) \geq \frac{{N}_{PRB}^{SB}}{2} ,$$

there may be one precoding matrix indicated corresponding to the first/beginning one of the plurality of first subbands. In some embodiments, when R=2, for one first subband that is the first/beginning one or the last/ending one of the plurality of first subbands in the BWP, if

$$( {N}_{BWP}^{start} mod {N}_{PRB}^{SB} ) < \frac{{N}_{PRB}^{SB}}{2} ,$$

there may be two precoding matrices indicated corresponding to the first/beginning one of the plurality of first subbands. For example, the first precoding matrix may correspond to the first

$$\frac{{N}_{PRB}^{SB}}{2} - ( {N}_{BWP}^{start} mod {N}_{PRB}^{SB} )$$

PRBs of the first/beginning one of the plurality of first subbands and the second precoding matrix corresponds to the last

$$\frac{{N}_{PRB}^{SB}}{2}$$

PRBs of the first/beginning one of the plurality of first subbands. In some embodiments, when R=2, for one first subband that is the first/beginning one or the last/ending one of the plurality of first subbands in the BWP, if

$$1 + ( {N}_{BWP}^{start} + {N}_{BWP}^{size} - 1 ) mod {N}_{PRB}^{SB} \leq \frac{{N}_{PRB}^{SB}}{2} ,$$

there may be one precoding matrix indicated corresponding to the last/ending one of the plurality of first subbands. In some embodiments, when R=2, for one first subband that is the first/beginning one or the last/ending one of the plurality of first subbands, if

$$1 + ( {N}_{BWP}^{start} + {N}_{BWP}^{size} - 1 ) mod {N}_{PRB}^{SB} > \frac{{N}_{PRB}^{SB}}{2} ,$$

there may be two precoding matrices indicated corresponding to the last/ending one of the plurality of first subbands. For example, the first precoding matrix may correspond to the first

$$\frac{{N}_{PRB}^{SB}}{2}$$

PRBs of the last/ending one of the plurality of first subbands and the second precoding matrix may correspond to the last

$$1 + ( {N}_{BWP , i}^{start} + {N}_{BWP , i}^{size} - 1 ) mod {N}_{PRB}^{SB} - \frac{{N}_{PRB}^{SB}}{2}$$

PRBs of the last/ending one of the plurality of first subbands.

In some embodiments, the number of the plurality of second vectors Mᵥ may be a positive integer. For example,

$${M}_{v} = ⌈ {p}_{v} \frac{{N}_{3}}{R} ⌉ .$$

For example, Mᵥ may be at least one of {1, 2, 3, 4, 5, 6, 7, 8, 9, 10}.

In some embodiments, nchoosek may be a function to choose k values from values. In some embodiments, nchoosek(a,b)=a!/(b!*(a−b)!). In some embodiments, “!” may be factorial. In some embodiments, a!=1*2* . . . *(a−1)*a.

In some embodiments, the at least one codebook indicator may be comprised in a PMI or in a CSI. In some embodiments, the PMI or the CSI may comprise a first part of the PMI (or the CSI) and a second part of the PMI (or the CSI). For example, the size of the second part of the PMI (or the CSI) may be based on the first part of the PMI (or the CSI). In some embodiments, the PMI (or the CSI) may comprise a first part of the PMI (or the CSI), a second part of the PMI (or the CSI) and a third part of the PMI (or the CSI). For example, the size of the second part of the PMI (or the CSI) may be based on the first part of the PMI (or the CSI). For another example, the size of the third part of the PMI (or the CSI) may be based on at least one of the first part of the PMI (or the CSI) and the second part of the PMI (or the CSI).

In some embodiments, the length of one first vector may be based on the number of antenna ports in one antenna port group or for one CSI-RS resource. In some embodiments, the length of one first vector may be the number of the plurality of antenna ports in one antenna port group or for one CSI-RS resource divided by 2. In some embodiments, the length of one first vector may be P/2. For example, P may be at least one of {4, 8, 12, 16, 24, 32}.

In some embodiments, the number of indicators (or the fields) for the strongest coefficient may be based on the number of layers, and each one indicator (or the field) for the strongest coefficient corresponds to a layer with an index.

In some embodiments, the indicator (or the field) for the strongest coefficient corresponds to a layer with an index or the bit size (or bitwidth) of indicator (or the field) for the strongest coefficient corresponds to a layer with an index may be based on at least one of: a value of 2; the first number of nonzero coefficients corresponding to one layer with an index; the number of the plurality of first vectors.

In some embodiments, the bit size of the indicator (or the field) for the strongest coefficient corresponds to a layer with an index may be based on at least one of: the first number of nonzero coefficients corresponding to one layer with the index; 2 multiplies the number of the plurality of first vectors.

In some embodiments, the indicator (or the field) for the strongest coefficient corresponds to a layer with an index may be comprised in the PMI (or the CSI) or in the first part of the PMI (or the CSI) or in the second part of the PMI (or the CSI).

In some embodiments, K_{b2} may be the bit size for each of the phase coefficients. For example, K_{b2} may be 2 or 3 or 4 bits.

In some embodiments, the one or more indicators (or one or more bitmaps) for indicating nonzero coefficients may indicate indexes of second amplitude coefficients and/or indexes of phase coefficients. In some embodiments, each bit or codepoint of the indicator (or bitmap) may indicate whether the second amplitude coefficient and/or the phase coefficient corresponding to a layer with an index, corresponding to a first vector (or a first beam) with an index and corresponding to a second vector with an index and corresponding to a third vector with an index is reported or not (or the value is 0 or not). In some embodiments, a value of each bit is either 0 or 1. For example, 0 may indicate the second amplitude coefficient and/or the phase coefficient corresponding to the layer with an index, corresponding to a first vector (or a first beam) with the index and corresponding to the second vector with an index and corresponding to the third vector with an index is not reported (or the value is 0). For example, 1 may indicate the second amplitude coefficient and/or the phase coefficient corresponding to the layer with an index, corresponding to a first vector (or a first beam) with the index and corresponding to the second vector with an index and corresponding to the third vector with an index is reported (or the value is not 0).

In some embodiments, the number of the one or more indicators (or one or more bitmaps) for indicating nonzero coefficients may be same as the number of layers. For example, each one indicator (or one bitmap) for indicating nonzero coefficients may correspond to one layer with an index.

In some embodiments, the size of the indicator (or the bitmap) for indicating nonzero coefficients corresponding to the layer with an index may be based on the number of the plurality of second vectors corresponding to the layer with an index, the number of the plurality of first vectors and the number of the plurality of third vectors corresponding to the layer with the index.

In some embodiments, the number of the plurality of second vectors may be determined based on at least one of: the number of layers; the size of one first subband; the first parameter for codebook; the size of one second subband; the third parameter for codebook; and the second parameter for codebook.

In some embodiments, a number of the one or more indicators (or the one or more bitmaps) for indicating nonzero coefficients may be based on the number of layers. In some embodiments, each one of the one or more indicators (or the one or more bitmaps) for indicating nonzero coefficients may correspond to a layer with an index.

In some embodiments, the number of one or more indicators (or the one or more fields) for the plurality of second amplitude coefficients corresponding to a layer with an index may be based on at least one of: the first number of nonzero coefficients; a number of values (or bits or codepoints) with value “1” or a number of ones in the indicator (or bitmap) for indicating nonzero coefficients corresponding to the layer with the index.

In some embodiments, the number of one or more indicators (or the one or more fields) for the plurality of phase coefficients corresponding to a layer with an index may be based on at least one of: the first number of nonzero coefficients; a number of values (or bits or codepoints) with value “1” or a number of ones in the indicator (or bitmap) for indicating nonzero coefficients corresponding to the layer with the index.

In some embodiments, the number of the plurality of second vectors Mᵥ may be determined based on at least one of: the number of PRBs for the BWP; the number of layers; the size of one first subband; the number of the plurality of first subbands; the first parameter for codebook the size of one second subband; the number of the plurality of second subbands; and the second parameter for codebook. In some embodiments, the second parameter for codebook may be determined based on the number of layers.

In some embodiments, a size or a length of one second vector may be determined based on at least one of: the number of PRBs for the BWP; the number of layers; the size of one first subband; the number of the plurality of first subbands; the first parameter for codebook; the size of one second subband; the number of the plurality of second subbands; and the second parameter for codebook. In some embodiments, the size or the length of one second vector may be N₃.

In some embodiments, the number of the plurality of third vectors M_{d} may be determined based on at least one of: a number of time units, the number of layers, the size of one time unit, the number of slots/subslots/symbols for one time unit, the time interval between two time units, the fourth parameter for codebook, the fifth parameter for codebook and the sixth parameter for codebook.

In some embodiments, the number of the plurality of third vectors M_{d} may be configured by the network device 110. In some embodiments, the number of the plurality of third vectors M_{d} may be reported by the terminal device 130.

In some embodiments, the number of the plurality of fourth vectors M_{d} may be a positive integer. For example,

$${M}_{d =} ⌈ {p}_{v , d} \frac{{N}_{4}}{{R}_{d}} ⌉ .$$

For example, M_{d} may be at least one of {1, 2, 3, 4, 5, 6, 7, 8, 9, 10}.

In some embodiments, a size or a length of one third vector may be determined based on at least one of: the number of time units, the number of layers, the size of one time unit, the number of slots/subslots/symbols for one time unit, the time interval between two time units, the fourth parameter for codebook, the fifth parameter for codebook and the sixth parameter for codebook. In some embodiments, the size or the length of one third vector may be N₄.

In some embodiments, the fourth parameter for codebook R_{d} may be at least one of {⅛, ¼, ½, 1, 2}.

In some embodiments, the size or the length of one third vector may be a positive integer. For example, 1≤N₄≤256.

In some embodiments, the terminal device may receive at least one CSI-RS, wherein the number of antenna ports for the at least one CSI-RS may be determined based on the at least one parameter for antenna port configuration.

In some embodiments, the first vector may be a vector in spatial domain. In some embodiments, the first vector may be represented as v_{i,m}. In some embodiments, the second vector may be a vector in frequency domain. In some embodiments, the second vector may be a DFT vector. In some embodiments, the third vector may be a vector in Doppler domain or in time domain. In some embodiments, the third vector may be a DFT vector or a Discrete Cosine Transformation (DCT) vector or a Slepian vector or an oversampled/rotated DFT vector or a vector with only one element of value 1, and other elements with value 0 or an identity vector.

In some embodiments, a plurality of precoding matrices or a plurality of codebooks corresponding to N₃ subbands and/or N₄ time units may be determined from L+Mᵥ vectors or L+Mᵥ+M_{d} vectors.

In some embodiments, the length of one first vector may be based on the number of the plurality of antenna ports in one CSI-RS resource divided by 2.

In some embodiments, the length of one second vector may be determined based on a first parameter for codebook and a number of first subbands. In some embodiments, the number of the plurality of second vectors may be determined based on a third parameter for codebook, a number of second subbands and the first parameter for codebook. In some embodiments, the number of second subbands may be based on the first parameter for codebook and the number of first subbands. In some embodiments, a second size of one second subband may be determined based on the first parameter for codebook and a first size of one first subband.

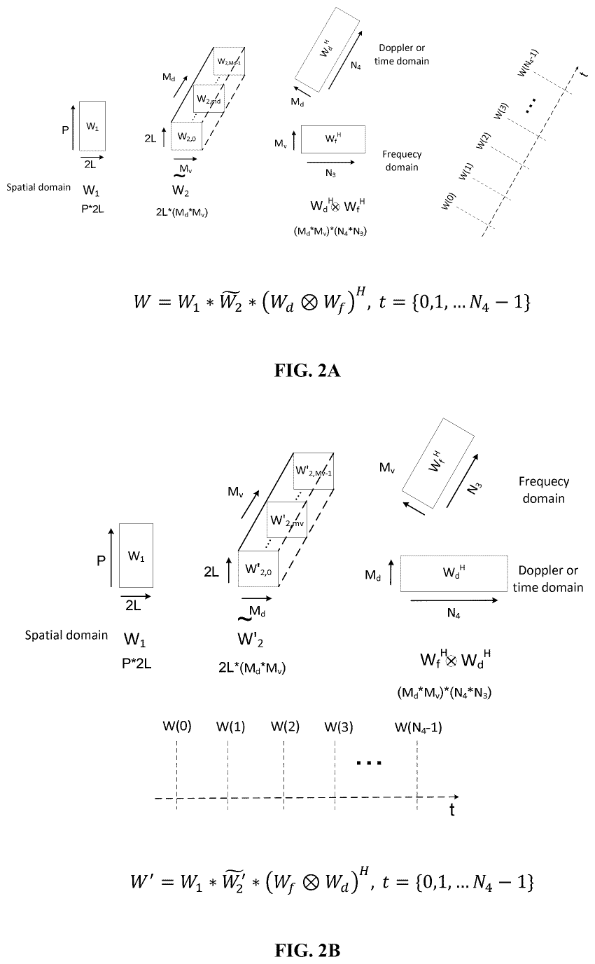

FIG. 2A and FIG. 2B illustrate schematic diagram of spatial domain, frequency domain and Doppler/time domain basis according to conventional schemes. To enhance precoding for UE moving at a considerably high velocity, it is proposed to introduce a Doppler/time domain basis into a plurality of codebooks or a plurality of precoding matrices, for example, a plurality of type II codebooks. As illustrated in FIG. 2A and FIG. 2B, in the spatial domain, a first matrix (For example, composed by spatial domain basis or the plurality of first vectors) W1 has a dimension of P*2L, where P denotes the number of antenna ports for a CSI-RS resource or of an antenna port group, and L denotes the number of beams or first vectors (For example, in each polarization group consisting of two polarization directions. In the frequency domain, a third matrix (For example, composed by frequency domain basis or the plurality of second vectors) W_{f}^{H} has a dimension of Mv*N3, where N3 denotes the number of frequency unit or the number of second subbands. For example, N3 can be understood as the number of subbands in the frequency domain. Mv is the number of frequency basis vectors or the second vectors. In the Doppler/time domain, a fourth matrix (For example, composed by Doppler/time domain basis or the plurality of third vectors) W_{d}^{H} has a dimension of Md*N4, where N4 denotes the number of Doppler/time unit, and Md is the number of Doppler/time basis vectors or the number of the third vectors.

As illustrated in FIG. 2A, in a plurality of codebooks or precoding matrices which comprises spatial domain, frequency domain and Doppler/time domain vectors, the plurality of codebooks or the plurality of precoding matrices corresponding to N₃ subbands and/or N₄ time units W can be expressed as equation (1):

$$W = {W}_{1} * * {( {W}_{d} ⊗ {W}_{f} )}^{H} , t = \{ 0 , 1 , … {N}_{4} - 1 \} \qquad ( 1 )$$

In some embodiments, in each time point or time unit in the Doppler/time domain, such as t=0, 1, 2, 3, . . . , N₄−1, there is a corresponding W(t), as illustrated in FIG. 2A. In some embodiments, there may be N₄*N₃ columns of vectors (For example, each column of vector may be indexed or represented as Cₚ, Cₚ is positive integer, and 1≤Cₚ≤N₄*N₃) in the plurality of codebooks or precoding matrices W In some embodiments, the length or the size of each column of vector may be 2*N₁*N₂ or P. For example, each column of vector may be a precoder corresponding to a time unit in Doppler/time domain and a subband (For example, second subband) in frequency domain. In some embodiments, W(t) may correspond to a subset of codebooks or precoding matrices corresponding to a time unit with an index and corresponding to all second subbands in frequency domain. In some embodiments, W(t) may be composed by a plurality of columns and/or a plurality of rows from the plurality of codebooks or precoding matrices W For example, the plurality of columns may be columns with indexes t+1≤Cₚ≤t+N₃. For example, W(0) may be composed by the plurality of columns of vectors from the first column to the (N₃)-th column from the plurality of codebooks or precoding matrices W.

As illustrated in FIG. 2B, in a plurality of codebooks or precoding matrices which comprises spatial domain, frequency domain and Doppler/time domain vectors, the plurality of codebooks or precoding matrices corresponding to N₃ subbands and/or N₄ time units W′ can be expressed as equation (2):

$${W}^{′} = {W}_{1} * * {( {W}_{f} ⊗ {W}_{d} )}^{H} , t = \{ 0 , 1 , … {N}_{4} - 1 \} \qquad ( 2 )$$

In some embodiments, in each time point or time unit in the Doppler/time domain, such as t=0, 1, 2, 3, . . . , N₄−1, there is a corresponding W(t) as illustrated in FIG. 2B. In some embodiments, there may be N₄*N₃ columns of vectors (For example, each column of vector may be indexed or represented as Cₚ, Cₚ is positive integer, and 1≤Cₚ≤N₄*N₃) in the plurality of codebooks or precoding matrices W′. In some embodiments, the length or the size of each column of vector may be 2*N₁*N₂ or P. For example, each column of vector may be a precoder corresponding to a time unit in Doppler/time domain and a second subband in frequency domain. In some embodiments, W(t) may correspond to a subset of codebooks or precoding matrices corresponding to a time unit with an index and corresponding to all second subbands in frequency domain. In some embodiments, W(t) may be composed by a plurality of columns and/or a plurality of rows from the codebook or precoding matrix W′. For example, the plurality of columns may be columns with indexes Cₚ=t+f*N₄+1, and f is non-negative integer, 0≤f≤N₃−1. For example, W(0) may be composed by the plurality of columns of vectors with indexes {1, N₄+1, 2*N₄+1, . . . (N₃−1)*N₄+1} from the plurality of codebooks or precoding matrices W′.

In some embodiments, the plurality of codebooks or the plurality of precoding matrices corresponding to N₃ subbands and/or N₄ time units may be represented as W or W′. In some embodiments, the plurality of codebooks or the plurality of precoding matrices corresponding to N₃ subbands and/or N₄ time units may be composed by a first matrix (For example, W₁), a second matrix (For example, [symbol] or [symbol] ), a third matrix (For example, W_{f} or W_{f}^{H}) and a fourth matrix (For example, W_{d} or W_{d}^{H}). In some embodiments, the size of the second matrix may be (2L)*(Mᵥ*M_{d}). In some embodiments, each element of the second matrix may be represented as

$${P}_{r}^{( 1 )} * {P}_{r , i , mv , md}^{( 2 )} * {φ}_{r , i , mv , md} .$$

In some embodiments,

$${P}_{r}^{( 1 )}$$

may be the first amplitude coefficient corresponding to layer with index r. In some embodiments,

$${P}_{r}^{( 1 )}$$

may not be needed. In some embodiments,

$${P}_{r}^{( 1 )}$$

may be fixed to be 1. In some embodiments,

$${P}_{r , i , mv , md}^{( 2 )}$$

may be second amplitude coefficient corresponding to the layer with index r and corresponding to one first vector with index i and corresponding to third vector with index mv and corresponding to third vector with index md.

In some embodiments, φ_{r,i,mv,md} may be phase coefficient corresponding to the layer with index r and corresponding to a first vector with index i and corresponding to third vector with index mv and corresponding to third vector with index md.

In some embodiments, the value of

$${P}_{r}^{( 1 )}$$

and/or the value of

$${P}_{r , i , mv , md}^{( 2 )}$$

and/or the value of φ_{r,i,mv,md} may be separate for each one of two polarizations or for different groups of first vectors.

In some embodiments, for the third matrix or the plurality of second vectors (e.g. represented as W_{f}) corresponding to layer with index r,

$${W}_{f} = {[ \begin{matrix}{F}_{{n}_{3 , r}^{( 0 )}} & {F}_{{n}_{3 , r}^{( 1 )}} & ... & {F}_{{n}_{3 , r}^{( {M}_{v} - 1 )}}\end{matrix} ]}^{T} .$$

In some embodiments, the size of W_{f} may be Mᵥ*N₃.

In some embodiments,

$${n}_{3 , l}^{( mv )} ∈ \{ 0 , 1 , ... , {N}_{3} - 1 \} .$$

In some embodiments,

$${F}_{{n}_{3 , r}^{( mv )}} = {[ \begin{matrix}1 & {e}^{j \frac{2 π * 1 * {n}_{3 , r}^{( mv )}}{{N}_{3}}} & {e}^{j \frac{2 π * 2 * {n}_{3 , r}^{( mv )}}{{N}_{3}}} & ... & {e}^{j \frac{2 π * ( {N}_{3} - 1 ) * {n}_{3 , r}^{( mv )}}{{N}_{3}}}\end{matrix} ]}^{T} .$$

In some embodiments,

$${y}_{z , r}^{( mv )} = {e}^{j \frac{2 π * z * {n}_{3 , r}^{( mv )}}{{N}_{3}}} .$$

In some embodiments, z may be an index of a second subband. For example, z={0, 1, . . . N₃−1}.

In some embodiments, one first vector may be represented as vᵢ,

$${v}_{i} = {v}_{{l}^{( i )} , {m}^{( i )}}$$

In some embodiments,

$${W}_{1} = [ \begin{matrix}B & 0 \\ 0 & B\end{matrix} ] ,$$

wherein B=v₀v₁ . . . v_{L-1}. For example, size of W₁ may be (2*N₁*N₂)*(2*L). For example, a size of each element in W₁ may be (N₁*N₂)*L, “0” in W₁ may be a zero matrix with size (N₁*N₂)*L.

In some embodiments,

$${W}_{1} = [ \begin{matrix}{v}_{0} {v}_{1} ... {v}_{L - 1} & 0 \\ 0 & {v}_{0} {v}_{1} ... {v}_{L - 1}\end{matrix} ] .$$

In some embodiments, [symbol] =[W_{2,0} W_{2,1} . . . W_{2,M}_{ᵥ}₋₁] or [symbol] =[W_{2,0} W_{2,1} . . . W_{2,M}_{ᵥ}₋₁]. In some embodiments, mv may be a non-negative integer. For example, 0≤mv≤Mᵥ. In some embodiments, W_{2,mv} may be a matrix with size (2L)*(M_{d}). For example, corresponding to a second vector with index mv and corresponding to the plurality of third vectors.

In some embodiments, [symbol] =[W_{2,0} W_{2,1} . . . W_{2,M}_{_{d}}₋₁] or [symbol] =[W_{2,0} W_{2,1} W_{2,M}_{_{d}}₋₁]. In some embodiments, md may be a non-negative integer. For example, 0≤md≤M_{d}. In some embodiments, W_{2,md} may be a matrix with size (2L)*(Mᵥ). For example, corresponding to a third vector with index md and corresponding to the plurality of second vectors.

In some embodiments, corresponding to the layer with index r, the second matrix may be [symbol] = or

[symbol]

$$[ \begin{matrix}{P}_{0 , 0}^{( 1 )} * {P}_{0 , 0 , 0}^{( 2 )} * & {P}_{0 , 0}^{( 1 )} * {P}_{0 , 1 , 0}^{( 2 )} * & & {P}_{0 , 0}^{( 1 )} * {P}_{0 , {M}_{d} - 1 , 0}^{( 2 )} * & {P}_{0 , 0}^{( 1 )} * {P}_{0 , 0 , 1}^{( 2 )} * & {P}_{0 , 0}^{( 1 )} * {P}_{0 , 1 , 1}^{( 2 )} * & & {P}_{0 , 0}^{( 1 )} * {P}_{0 , {M}_{d} - 1 , 1}^{( 2 )} * \\ {φ}_{0 , 0 , 0}^{( 1 )} & {φ}_{0 , 1 , 0}^{( 1 )} & & {φ}_{0 , {M}_{d} - 1 , 0}^{( 1 )} & {φ}_{0 , 0 , 1}^{( 1 )} & {φ}_{0 , 1 , 1}^{( 1 )} & & {φ}_{0 , {M}_{d} - 1 , 1}^{( 1 )} \\ {P}_{0 , 0}^{( 1 )} * {P}_{1 , 0 , 0}^{( 2 )} * & {P}_{0 , 0}^{( 1 )} * {P}_{1 , 1 , 0}^{( 2 )} * & & {P}_{0 , 0}^{( 1 )} * {P}_{1 , {M}_{d} - 1 , 0}^{( 2 )} * & {P}_{0 , 0}^{( 1 )} * {P}_{1 , 0 , 1}^{( 2 )} * & {P}_{0 , 0}^{( 1 )} * {P}_{1 , 1 , 1}^{( 2 )} * & & {P}_{0 , 0}^{( 1 )} * {P}_{1 , {M}_{d} - 1 , 1}^{( 2 )} * \\ {φ}_{1 , 0 , 0}^{( 1 )} & {φ}_{1 , 1 , 0}^{( 1 )} & & {φ}_{1 , {M}_{d} - 1 , 0}^{( 1 )} & {φ}_{1 , 0 , 1}^{( 1 )} & {φ}_{1 , 1 , 1}^{( 1 )} & & {φ}_{1 , {M}_{d} - 1 , 1}^{( 1 )} \\ ⋮ & ⋮ & & ⋮ & ⋮ & ⋮ & & ⋮ \\ {P}_{0 , 0}^{( 1 )} * {P}_{L - 1 , 0 , 0}^{( 2 )} * & {P}_{0 , 0}^{( 1 )} * {P}_{L - 1 , 1 , 0}^{( 2 )} * & … & {P}_{0 , 0}^{( 1 )} * {P}_{L - 1 , {M}_{d} - 1 , 0}^{( 2 )} * & {P}_{0 , 0}^{( 1 )} * {P}_{L - 1 , 0 , 1}^{( 2 )} * & {P}_{0 , 0}^{( 1 )} * {P}_{L - 1 , 1 , 1}^{( 2 )} * & … & {P}_{0 , 0}^{( 1 )} * {P}_{L - 1 , {M}_{d} - 1 , 1}^{( 2 )} * \\ {φ}_{L - 1 , 0 , 0}^{( 1 )} & {φ}_{L - 1 , 1 , 0}^{( 1 )} & & {φ}_{L - 1 , {M}_{d} - 1 , 0}^{( 1 )} & {φ}_{L - 1 , 0 , 1}^{( 1 )} & {φ}_{L - 1 , 1 , 1}^{( 1 )} & & {φ}_{L - 1 , {M}_{d} - 1 , 1}^{( 1 )} \\ {P}_{1 , 0}^{( 1 )} * {P}_{L , 0 , 0}^{( 2 )} * & {P}_{1 , 0}^{( 1 )} * {P}_{L , 1 , 0}^{( 2 )} * & & {P}_{1 , 0}^{( 1 )} * {P}_{L , {M}_{d} - 1 , 0}^{( 2 )} * & {P}_{1 , 0}^{( 1 )} * {P}_{L , 0 , 1}^{( 2 )} * & {P}_{1 , 0}^{( 1 )} * {P}_{L , 1 , 1}^{( 2 )} * & & {P}_{1 , 0}^{( 1 )} * {P}_{L , {M}_{d} - 1 , 1}^{( 2 )} * \\ {φ}_{L , 0 , 0}^{( 1 )} & {φ}_{L , 1 , 0}^{( 1 )} & & {φ}_{L , {M}_{d} - 1 , 0}^{( 1 )} & {φ}_{L , 0 , 1}^{( 1 )} & {φ}_{L , 1 , 1}^{( 1 )} & & {φ}_{L , {M}_{d} - 1 , 1}^{( 1 )} \\ {P}_{1 , 0}^{( 1 )} * {P}_{L + 1 , 0 , 0}^{( 2 )} * & {P}_{1 , 0}^{( 1 )} * {P}_{L + 1 , 1 , 0}^{( 2 )} * & & {P}_{1 , 0}^{( 1 )} * {P}_{L + 1 , {M}_{d} - 1 , 0}^{( 2 )} * & {P}_{1 , 0}^{( 1 )} * {P}_{L + 1 , 0 , 1}^{( 2 )} * & {P}_{1 , 0}^{( 1 )} * {P}_{L + 1 , 1 , 1}^{( 2 )} * & & {P}_{1 , 0}^{( 1 )} * {P}_{L + 1 , {M}_{d} - 1 , 1}^{( 2 )} * \\ {φ}_{L + 1 , 0 , 0}^{( 1 )} & {φ}_{L + 1 , 1 , 0}^{( 1 )} & & {φ}_{L + 1 , {M}_{d} - 1 , 0}^{( 1 )} & {φ}_{L + 1 , 0 , 1}^{( 1 )} & {φ}_{L + 1 , 1 , 1}^{( 1 )} & & {φ}_{L + 1 , {M}_{d} - 1 , 1}^{( 1 )} \\ ⋮ & ⋮ & & ⋮ & ⋮ & ⋮ & & ⋮ \\ {P}_{1 , 0}^{( 1 )} * {P}_{2 * L - 1 , 0 , 0}^{( 2 )} * & {P}_{1 , 0}^{( 1 )} * {P}_{2 * L - 1 , 1 , 0}^{( 2 )} * & & {P}_{1 , 0}^{( 1 )} * {P}_{2 * L - 1 , {M}_{d} - 1 , 0}^{( 2 )} * & {P}_{1 , 0}^{( 1 )} * {P}_{2 * L - 1 , 0 , 1}^{( 2 )} * & {P}_{1 , 0}^{( 1 )} * {P}_{2 * L - 1 , 1 , 1}^{( 2 )} * & & {P}_{1 , 0}^{( 1 )} * {P}_{2 * L - 1 , {M}_{d} - 1 , 1}^{( 2 )} * \\ {φ}_{2 * L - 1 , 0 , 0}^{( 1 )} & {φ}_{2 * L - 1 , 1 , 0}^{( 1 )} & & {φ}_{2 * L - 1 , {M}_{d} - 1 , 0}^{( 1 )} & {φ}_{2 * L - 1 , 0 , 1}^{( 1 )} & {φ}_{2 * L - 1 , 1 , 1}^{( 1 )} & & {φ}_{2 * L - 1 , {M}_{d} - 1 , 1}^{( 1 )} \\ & & {P}_{0 , 0}^{( 1 )} * {P}_{0 , 0 , {M}_{v} - 1}^{( 2 )} * & {P}_{0 , 0}^{( 1 )} * {P}_{0 , 1 , {M}_{v} - 1}^{( 2 )} * & & {P}_{0 , 0}^{( 1 )} * {P}_{0 , {M}_{d} - 1 , {M}_{v} - 1}^{( 2 )} * & & \\ & & {φ}_{0 , 0 , {M}_{v} - 1}^{( 1 )} & {φ}_{0 , 1 , {M}_{v} - 1}^{( 1 )} & & {φ}_{0 , {M}_{d} - 1 , {M}_{v} - 1}^{( 1 )} & & \\ & & {P}_{0 , 0}^{( 1 )} * {P}_{1 , 0 , {M}_{v} - 1}^{( 2 )} * & {P}_{0 , 0}^{( 1 )} * {P}_{1 , 1 , {M}_{v} - 1}^{( 2 )} * & & {P}_{0 , 0}^{( 1 )} * {P}_{1 , {M}_{d} - 1 , {M}_{v} - 1}^{( 2 )} * & & \\ & & {φ}_{1 , 0 , {M}_{v} - 1}^{( 1 )} & {φ}_{1 , 1 , {M}_{v} - 1}^{( 1 )} & & {φ}_{1 , {M}_{d} - 1 , {M}_{v} - 1}^{( 1 )} & & \\ & & ⋮ & ⋮ & & ⋮ & & \\ & … & {P}_{0 , 0}^{( 1 )} * {P}_{L - 1 , 0 , {M}_{v} - 1}^{( 2 )} * & {P}_{0 , 0}^{( 1 )} * {P}_{L - 1 , 1 , {M}_{v} - 1}^{( 2 )} * & … & {P}_{0 , 0}^{( 1 )} * {P}_{L - 1 , {M}_{d} - 1 , {M}_{v} - 1}^{( 2 )} * & & \\ & & {φ}_{L - 1 , 0 , {M}_{v} - 1}^{( 1 )} & {φ}_{L - 1 , 1 , {M}_{v} - 1}^{( 1 )} & & {φ}_{L - 1 , {M}_{d} - 1 , {M}_{v} - 1}^{( 1 )} & & \\ & & {P}_{1 , 0}^{( 1 )} * {P}_{L , 0 , {M}_{v} - 1}^{( 2 )} * & {P}_{1 , 0}^{( 1 )} * {P}_{L , 1 , {M}_{v} - 1}^{( 2 )} * & & {P}_{1 , 0}^{( 1 )} * {P}_{L , {M}_{d} - 1 , {M}_{v} - 1}^{( 2 )} * & & \\ & & {φ}_{L , 0 , {M}_{v} - 1}^{( 1 )} & {φ}_{L , 1 , {M}_{v} - 1}^{( 1 )} & & {φ}_{L , {M}_{d} - 1 , {M}_{v} - 1}^{( 1 )} & & \\ & & {P}_{1 , 0}^{( 1 )} * {P}_{L + 1 , 0 , {M}_{v} - 1}^{( 2 )} * & {P}_{1 , 0}^{( 1 )} * {P}_{L + 1 , 1 , {M}_{v} - 1}^{( 2 )} * & & {P}_{1 , 0}^{( 1 )} * {P}_{L + 1 , {M}_{d} - 1 , {M}_{v} - 1}^{( 2 )} * & & \\ & & {φ}_{L + 1 , 0 , {M}_{v} - 1}^{( 1 )} & {φ}_{L + 1 , 1 , {M}_{v} - 1}^{( 1 )} & & {φ}_{L + 1 , {M}_{d} - 1 , {M}_{v} - 1}^{( 1 )} & & \\ & & ⋮ & ⋮ & & ⋮ & & \\ & & {P}_{1 , 0}^{( 1 )} * {P}_{2 * L - 1 , 0 , {M}_{v} - 1}^{( 2 )} * & {P}_{1 , 0}^{( 1 )} * {P}_{2 * L - 1 , 1 , {M}_{v} - 1}^{( 2 )} * & & {P}_{1 , 0}^{( 1 )} * {P}_{2 * L - 1 , {M}_{d} - 1 , {M}_{v} - 1}^{( 2 )} * & & \\ & & {φ}_{2 * L - 1 , 0 , {M}_{v} - 1}^{( 1 )} & {φ}_{2 * L - 1 , 1 , {M}_{v} - 1}^{( 1 )} & & {φ}_{2 * L - 1 , {M}_{d} - 1 , {M}_{v} - 1}^{( 1 )} & & \end{matrix} ]$$

In some embodiments,

$${P}_{0 , 0}^{( 1 )} and {P}_{1 , 0}^{( 1 )}$$

(For example, same as

$${P}_{r}^{( 1 )} )$$

may be the first amplitude coefficient corresponding to layer with index r. In some embodiments,

$${P}_{i , mv , md}^{( 2 )}$$

may be second amplitude coefficient corresponding to the layer with index r and corresponding to one first vector with index i and corresponding to third vector with index mv and corresponding to third vector with index md. In some embodiments,

$${φ}_{r , i , mv , md}^{( 1 )}$$

(For example, same as φ_{r,i,mv,md}) may be phase coefficient corresponding to the layer with index r and corresponding to a first vector with index i and corresponding to third vector with index mv and corresponding to third vector with index md.

In some embodiments, for the codebook or precoding matrix or precoder corresponding to layer with index r and corresponding to second subband with index z and corresponding to time unit with index T,

$${W}_{z , T}^{r} = \frac{1}{\sqrt{{N}_{1} {N}_{2} {γ}_{z , r , T}}} [ \begin{matrix}{\sum }_{i = 0}^{L - 1} {v}_{i} {P}_{r , 0}^{( 1 )} {\sum }_{mv = 0}^{{M}_{v} - 1} {y}_{z , r}^{( mv )} {d}_{T , r}^{( md )} {P}_{r , i , 0 , mv , md}^{( 2 )} {φ}_{r , i , 0 , mv , md}^{( 1 )} \\ {\sum }_{i = 0}^{L - 1} {v}_{i} {P}_{r , 1}^{( 1 )} {\sum }_{mv = 0}^{{M}_{v} - 1} {y}_{z , r}^{( mv )} {d}_{T , r}^{( md )} {P}_{r , i , 1 , mv , md}^{( 2 )} {φ}_{r , i , 1 , mv , md}^{( 1 )}\end{matrix} ]$$

In some embodiments, γ_{z,r,T} may be a variant for power calculation or power normalization.

In some embodiments, γ_{z,r,T} may be based on the plurality of second amplitude coefficients, the plurality of phase coefficients and the plurality of first amplitude coefficients. In some embodiments, γ_{z,r,T} may be based on the number of the plurality of second vectors and at least one of: the number of the plurality of first vectors, the number of the plurality of second vectors.

In some embodiments,

$${γ}_{t , l} = {\sum }_{i = 0}^{2 L - 1} {( {p}_{l , ⌊ \frac{i}{L} ⌋}^{( 1 )} )}^{2} {\vert {\sum }_{mv = 0}^{{M}_{v} - 1} {\sum }_{md = 0}^{{M}_{d} - 1} {y}_{t , l}^{( mv )} {d}_{t , l}^{( md )} {p}_{l , i , mv , md}^{( 2 )} {φ}_{l , i , mv , md} \vert}^{2} .$$

In some embodiments, for bits or codepoints or values of the one or more indicators (or one or more bitmaps) for indicating nonzero coefficients with value to be 0, the second amplitude coefficient and/or the phase coefficient corresponding to the bits or codepoints or values may be set to 0.

In some embodiments, for the fourth matrix or the plurality of third vectors (e.g. represented as W_{d}) corresponding to layer with index r,

$${W}_{d} = {[ \begin{matrix}{F}_{{n}_{4}^{( 0 )}} & {F}_{{n}_{4}^{( 1 )}} & ... & {F}_{{n}_{4}^{( {M}_{d} - 1 )}}\end{matrix} ]}^{T} .$$

In some embodiments, the size of W_{d} may be M_{d}*N₄.

In some embodiments,

$${n}_{4}^{( md )} ∈ \{ 0 , 1 , ... , {N}_{4} - 1 \} .$$

In some embodiments,

$${F}_{{n}_{4}^{( md )}} = {[ \begin{matrix}1 & {e}^{j \frac{2 π * 1 * {n}_{4}^{( md )}}{{N}_{4}}} & {e}^{j \frac{2 π * 2 * {n}_{4}^{( md )}}{{N}_{4}}} & ... & {e}^{j \frac{2 π * ( {N}_{4} - 1 ) * {n}_{4}^{( md )}}{{N}_{4}}}\end{matrix} ]}^{T} .$$

In some embodiments,

$${d}_{X}^{( md )} = {e}^{j \frac{2 π * X * {n}_{4}^{( md )}}{{N}_{4}}} .$$

In some embodiments, md may be an index of one third vector. For example, md=0, 1, . . . M_{d}−1.

In some embodiments, a value of one first amplitude coefficient may be at least one

$$of \{ 0 , \frac{1}{\sqrt{128}} , {( \frac{1}{8192} )}^{1 / 4} , \frac{1}{8} , {( \frac{1}{2048} )}^{1 / 4} , \frac{1}{2 \sqrt{8}} , \\ {( \frac{1}{512} )}^{1 / 4} , \frac{1}{4} , {( \frac{1}{128} )}^{1 / 4} , \frac{1}{\sqrt{8}} , {( \frac{1}{32} )}^{1 / 4} , \frac{1}{2} , {( \frac{1}{8} )}^{1 / 4} , \frac{1}{\sqrt{2}} , {( \frac{1}{2} )}^{1 / 4} , 1 \} .$$

In some embodiments, the bit size for one first amplitude coefficient may be 4 bits. In some embodiments, a value of an indicator or a field for one first amplitude coefficient may be at least one of {0, 1, 2, 3, 4, 5, 6, 7, 8, 9, 10, 11, 12, 13, 14, 15}. In some embodiments, an indicator or a field for one first amplitude coefficient with value 0 may correspond to the first amplitude coefficient with value 0. In some embodiments, an indicator or a field for one first amplitude coefficient with value 1 may correspond to the first amplitude coefficient with value

$$\frac{1}{\sqrt{128}} .$$

In some embodiments, an indicator or a field for one first amplitude coefficient with value 2 may correspond to the first amplitude coefficient with value

$${( \frac{1}{8192} )}^{1 / 4} .$$

In some embodiments, an indicator or a field for one first amplitude coefficient with value 3 may correspond to the first amplitude coefficient with value ⅛. In some embodiments, an indicator or a field for one first amplitude coefficient with value 4 may correspond to the first amplitude coefficient with value

$${( \frac{1}{2048} )}^{1 / 4} .$$

In some embodiments, an indicator or a field for one first amplitude coefficient with value 5 may correspond to the first amplitude coefficient with value

$$\frac{1}{2 \sqrt{8}} .$$

In some embodiments, an indicator or a field for one first amplitude coefficient with value 6 may correspond to the first amplitude coefficient with value

$${( \frac{1}{512} )}^{1 / 4} .$$

In some embodiments, an indicator or a field for one first amplitude coefficient with value 7 may correspond to the first amplitude coefficient with value ¼. In some embodiments, an indicator or a field for one first amplitude coefficient with value 8 may correspond to the first amplitude coefficient with value

$${( \frac{1}{128} )}^{1 / 4} .$$

In some embodiments, an indicator or a field for one first amplitude coefficient with value 9 may correspond to the first amplitude coefficient with value

$$\frac{1}{\sqrt{8}} .$$

In some embodiments, an indicator or a field for one first amplitude coefficient with value 10 may correspond to the first amplitude coefficient with value

$${( \frac{1}{32} )}^{1 / 4} .$$

In some embodiments, an indicator or a field for one first amplitude coefficient with value 11 may correspond to the first amplitude coefficient with value ½. In some embodiments, an indicator or a field for one first amplitude coefficient with value 12 may correspond to the first amplitude coefficient with value

$${( \frac{1}{8} )}^{1 / 4} .$$

In some embodiments, an indicator or a field for one first amplitude coefficient with value 13 may correspond to the first amplitude coefficient with value

$$\frac{1}{\sqrt{2}} .$$

In some embodiments, an indicator or a field for one first amplitude coefficient with value 14 may correspond to the first amplitude coefficient with value

$${( \frac{1}{2} )}^{1 / 4} .$$

In some embodiments, an indicator or a field for one first amplitude coefficient with value 15 may correspond to the first amplitude coefficient with value 1.

In some embodiments, a value of one first amplitude coefficient may be at least one

$$\{ 0 , \frac{1}{\sqrt{64}} , \frac{1}{\sqrt{32}} , \frac{1}{4} , \frac{1}{\sqrt{8}} , \frac{1}{2} , \frac{1}{\sqrt{2}} , 1 \} .$$

In some embodiments, the bit size for one first amplitude coefficient may be 4 bits. In some embodiments, a value of an indicator or a field for one first amplitude coefficient may be at least one of {0, 1, 2, 3, 4, 5, 6, 7}. In some embodiments, an indicator or a field for one first amplitude coefficient with value 0 may correspond to the first amplitude coefficient with value 0. In some embodiments, an indicator or a field for one first amplitude coefficient with value 1 may correspond to the first amplitude coefficient with value

$$\frac{1}{\sqrt{64}} .$$

In some embodiments, an indicator or a field for one first amplitude coefficient with value 2 may correspond to the first amplitude coefficient with value

$$\frac{1}{\sqrt{32}} .$$

In some embodiments, an indicator or a field for one first amplitude coefficient with value 3 may correspond to the first amplitude coefficient with value 4. In some embodiments, an indicator or a field for one first amplitude coefficient with value 4 may correspond to the first amplitude coefficient with value

$$\frac{1}{\sqrt{8}} .$$

In some embodiments, an indicator or a field for one first amplitude coefficient with value 5 may correspond to the first amplitude coefficient with value ½. In some embodiments, an indicator or a field for one first amplitude coefficient with value 6 may correspond to the first amplitude coefficient with value

$$\frac{1}{\sqrt{2}} .$$

In some embodiments, an indicator or a field for one first amplitude coefficient with value 7 may correspond to the first amplitude coefficient with value 1.

In some embodiments, the value of the first amplitude coefficient corresponding to the first antenna port group (for example, the antenna port group with index Tₘ) may be 1. In some embodiments, the value of the indicator or the field for the first amplitude coefficient corresponding to the first antenna port group (for example, the antenna port group with index Tₘ) may be 15. In some embodiments, the value of the first amplitude coefficient or the indicator or the field for the first amplitude coefficient corresponding to the first antenna port group (for example, the antenna port group with index Tₘ) may not be reported in the PMI.

In some embodiments, the value of the first amplitude coefficient corresponding to the antenna port group which is not included in the second plurality of antenna port groups may be 0. In some embodiments, the value of the indicator or the field for the first amplitude coefficient corresponding to the antenna port group which is not included in the second plurality of antenna port groups may be 0. In some embodiments, the value of the first amplitude coefficient or the indicator or the field for the first amplitude coefficient corresponding to the antenna port group which is not included in the second plurality of antenna port groups may not be reported in the PMI.

In some embodiments, a value of one second amplitude coefficient may be at least one of

$$\{ \frac{1}{\sqrt{128}} , {( \frac{1}{8192} )}^{1 / 4} , \frac{1}{8} , {( \frac{1}{2048} )}^{1 / 4} , \frac{1}{2 \sqrt{8}} , {( \frac{1}{512} )}^{1 / 4} , \\ \frac{1}{4} , {( \frac{1}{128} )}^{1 / 4} , \frac{1}{\sqrt{8}} , {( \frac{1}{32} )}^{1 / 4} , \frac{1}{2} , {( \frac{1}{8} )}^{1 / 4} , \frac{1}{\sqrt{2}} , {( \frac{1}{2} )}^{1 / 4} , 1 \} .$$

In some embodiments, the bit size for one second amplitude coefficient may be 4 bits. In some embodiments, a value of an indicator or a field for one second amplitude coefficient may be at least one of {1, 2, 3, 4, 5, 6, 7, 8, 9, 10, 11, 12, 13, 14, 15}. In some embodiments, an indicator or a field for one second amplitude coefficient with value 0 may correspond to the second amplitude coefficient with value 0. In some embodiments, an indicator or a field for one second amplitude coefficient with value 1 may correspond to the second amplitude coefficient with value

$$\frac{1}{\sqrt{128}} .$$

In some embodiments, an indicator or a field for one second amplitude coefficient with value 2 may correspond to the second amplitude coefficient with value

$${( \frac{1}{8192} )}^{1 / 4} .$$

In some embodiments, an indicator or a field for one second amplitude coefficient with value 3 may correspond to the second amplitude coefficient with value ⅛. In some embodiments, an indicator or a field for one second amplitude coefficient with value 4 may correspond to the second amplitude coefficient with value

$${( \frac{1}{2048} )}^{1 / 4} .$$

In some embodiments, an indicator or afield for one second amplitude coefficient with value 5 may correspond to the second amplitude coefficient with value

$$\frac{1}{2 \sqrt{8}} .$$

In some embodiments, an indicator or a field for one second amplitude coefficient with value 6 may correspond to the second amplitude coefficient with value

$${( \frac{1}{512} )}^{1 / 4} .$$

In some embodiments, an indicator or a field for one second amplitude coefficient with value 7 may correspond to the second amplitude coefficient with value ¼. In some embodiments, an indicator or a field for one second amplitude coefficient with value 8 may correspond to the second amplitude coefficient with value

$${( \frac{1}{128} )}^{1 / 4} .$$

In some embodiments, an indicator or a field for one second amplitude coefficient with value 9 may correspond to the second amplitude coefficient with value

$$\frac{1}{\sqrt{8}} .$$

In some embodiments, an indicator or a field for one second amplitude coefficient with value 10 may correspond to the second amplitude coefficient with value

$${( \frac{1}{32} )}^{1 / 4} .$$

In some embodiments, an indicator or a field for one second amplitude coefficient with value 11 may correspond to the second amplitude coefficient with value ½. In some embodiments, an indicator or a field for one second amplitude coefficient with value 12 may correspond to the second amplitude coefficient with value

$${( \frac{1}{8} )}^{1 / 4} .$$

In some embodiments, an indicator or a field for one second amplitude coefficient with value 13 may correspond to the second amplitude coefficient with value

$$\frac{1}{\sqrt{2}} .$$

In some embodiments, an indicator or a field for one second amplitude coefficient with value 14 may correspond to the second amplitude coefficient with value

$${( \frac{1}{2} )}^{1 / 4} .$$

In some embodiments, an indicator or a field for one second amplitude coefficient with value 15 may correspond to the second amplitude coefficient with value 1.

In some embodiments, a value of one second amplitude coefficient may be at least one of

$$\{ 0 , \frac{1}{\sqrt{64}} , \frac{1}{\sqrt{32}} , \frac{1}{4} , \frac{1}{\sqrt{8}} , \frac{1}{2} , \frac{1}{\sqrt{2}} , 1 \} .$$

In some embodiments, the bit size for one second amplitude coefficient may be 4 bits. In some embodiments, a value of an indicator or a field for one second amplitude coefficient may be at least one of {0, 1, 2, 3, 4, 5, 6, 7}. In some embodiments, an indicator or a field for one second amplitude coefficient with value 0 may correspond to the second amplitude coefficient with value 0. In some embodiments, an indicator or a field for one second amplitude coefficient with value 1 may correspond to the second amplitude coefficient with value

$$\frac{1}{\sqrt{64}} .$$

In some embodiments, an indicator or a field for one second amplitude coefficient with value 2 may correspond to the second amplitude coefficient with value

$$\frac{1}{\sqrt{32}} .$$

In some embodiments, an indicator or a field for one second amplitude coefficient with value 3 may correspond to the second amplitude coefficient with value ¼. In some embodiments, an indicator or a field for one second amplitude coefficient with value 4 may correspond to the second amplitude coefficient with value

$$\frac{1}{\sqrt{8}} .$$

In some embodiments, an indicator or a field for one second amplitude coefficient with value 5 may correspond to the second amplitude coefficient with value ½. In some embodiments, an indicator or a field for one second amplitude coefficient with value 6 may correspond to the second amplitude coefficient with value

$$\frac{1}{\sqrt{2}} .$$

In some embodiments, an indicator or a field for one second amplitude coefficient with value 7 may correspond to the second amplitude coefficient with value 1.

In some embodiments, a value of one second amplitude coefficient may be at least one of

$$\{ \frac{1}{8 \sqrt{2}} , \frac{1}{8} , \frac{1}{4 \sqrt{2}} , \frac{1}{4} , \frac{1}{2 \sqrt{2}} , \frac{1}{2} , \frac{1}{\sqrt{2}} , 1 \} .$$

In some embodiments, the bit size for one second amplitude coefficient may be 3 bits. In some embodiments, a value of an indicator or a field for one second amplitude coefficient may be at least one of {0, 1, 2, 3, 4, 5, 6, 7}. In some embodiments, an indicator or a field for one second amplitude coefficient with value 0 may correspond to the second amplitude coefficient with value

$$\frac{1}{8 \sqrt{2}} .$$

In some embodiments, an indicator or a field for one second amplitude coefficient with value 1 may correspond to the second amplitude coefficient with value ⅛. In some embodiments, an indicator or a field for one second amplitude coefficient with value 2 may correspond to the second amplitude coefficient with value

$$\frac{1}{4 \sqrt{2}} .$$

In some embodiments, an indicator or a field for one second amplitude coefficient with value 3 may correspond to the second amplitude coefficient with value ¼. In some embodiments, an indicator or a field for one second amplitude coefficient with value 4 may correspond to the second amplitude coefficient with value

$$\frac{1}{2 \sqrt{2}} .$$

In some embodiments, an indicator or a field for one second amplitude coefficient with value 5 may correspond to the second amplitude coefficient with value ½. In some embodiments, an indicator or a field for one second amplitude coefficient with value 6 may correspond to the second amplitude coefficient with value

$$\frac{1}{\sqrt{2}} .$$

In some embodiments, an indicator or a field for one second amplitude coefficient with value 7 may correspond to the second amplitude coefficient with value 1. In some embodiments, one second amplitude coefficient may be a differential value corresponding to one first amplitude coefficient.

In some embodiments, a value of one second amplitude coefficient may be at least one of

$$\{ \frac{1}{\sqrt{2}} , 1 \} .$$

In some embodiments, the bit size for one second amplitude coefficient may be 1 bit. In some embodiments, a value of an indicator or a field for one second amplitude coefficient may be at least one of {0, 1}. In some embodiments, an indicator or a field for one second amplitude coefficient with value 0 may correspond to the second amplitude coefficient with value

$$\frac{1}{\sqrt{2}} .$$

In some embodiments, an indicator or a field for one second amplitude coefficient with value 1 may correspond to the second amplitude coefficient with value 1. In some embodiments, one second amplitude coefficient may be a differential value corresponding to one first amplitude coefficient.

In some embodiments, the value of the second amplitude coefficient corresponding to the antenna port group which is not included in the second plurality of antenna port groups may be 0. In some embodiments, the value of the indicator or the field for the second amplitude coefficient corresponding to the antenna port group which is not included in the second plurality of antenna port groups may be 0. In some embodiments, the value of the second amplitude coefficient or the indicator or the field for the second amplitude coefficient corresponding to the antenna port group which is not included in the second plurality of antenna port groups may not be reported in the PMI.

In some embodiments, for bits or codepoints or values of the one or more indicators (or one or more bitmaps) for indicating nonzero coefficients with value to be 0, the value of the first amplitude coefficient corresponding to the bits or codepoints or values may be set to be 0 and/or the value of an indicator or afield for the first amplitude coefficient corresponding to the bits or codepoints or values may be set to be 0. In some embodiments, the value of the first amplitude coefficient corresponding to the bits or codepoints or values and/or the value of an indicator or a field for the first amplitude coefficient corresponding to the bits or codepoints or values may not be reported in the PMI.

In some embodiments, for bits or codepoints or values of the one or more indicators (or one or more bitmaps) for indicating nonzero coefficients with value to be 0, the value of the second amplitude coefficient corresponding to the bits or codepoints or values may be set to be 0 and/or the value of an indicator or a field for the second amplitude coefficient corresponding to the bits or codepoints or values may be set to be 0. In some embodiments, the value of the second amplitude coefficient corresponding to the bits or codepoints or values and/or the value of an indicator or a field for the second amplitude coefficient corresponding to the bits or codepoints or values may not be reported in the PMI.

In some embodiments, for bits or codepoints or values of the one or more indicators (or one or more bitmaps) for indicating nonzero coefficients with value to be 0, the value of at least one of the phase coefficient corresponding to the bits or codepoints or values may be set to be 0 and/or the value of an indicator or a field for at least one of the phase coefficient corresponding to the bits or codepoints or values may be set to be 0. In some embodiments, the value of at least one of the phase coefficient corresponding to the bits or codepoints or values and/or the value of an indicator or a field for at least one of the phase coefficient corresponding to the bits or codepoints or values may not be reported in the PMI.

In some embodiments, a value of one phase coefficient may be e^{j2π·φ}^{ₚ}^{/NPSK}. In some embodiments, φₚ may be a value of one indicator or one field for the phase coefficient. In some embodiments, a value of one second phase coefficient may be e^{j2π·φ}^{ₚ}^{/NPSK}. In some embodiments, φₚ may be a non-negative integer. In some embodiments, 0≤φₚ≤N_{PSK}−1. In some embodiments, φₚ may be at least one of {0, 1, 2, 3} or {0, 1, 2, 3, 4, 5, 6, 7} or {0, 1, 2, 3, 4, 5, 6, 7, 8, 9, 10, 11, 12, 13, 14, 15}. In some embodiments, N_{PSK} may be the size for indication of φₚ. In some embodiments, N_{PSK} may be a positive integer. In some embodiments, N_{PSK} may be at least one of {2, 4, 8, 16, 32, 64}.

In some embodiments, K_{b2} may be the bit size for each of the phase coefficients. For example, K_{b2} may be 2 (e.g. N_{PSK}=4) or 3 (e.g. N_{PSK}=8) or 4 bits (e.g. N_{PSK}=16) or 5 bits (e.g. N_{PSK}=32) or 6 bits (e.g. N_{PSK}=64).

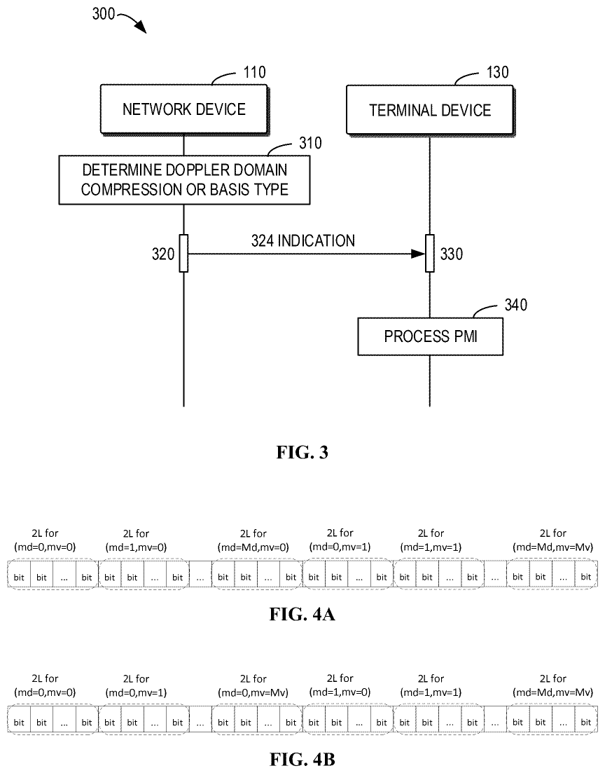

Reference is now made to FIG. 3, which illustrates a signaling chart illustrating communication process 300 in accordance with some embodiments of the present disclosure. Only for the purpose of discussion, the process 300 will be described with reference to FIG. 1. The process 300 may involve the terminal device 130 and the network device 110.

In some embodiments of the present disclosure, the terminal device 130 determines (310) whether to apply Doppler/time domain compression or a Doppler/time domain basis type for reporting a precoding matrix indicator (PMI) to the network device 110. In one example, the terminal device 130 may determine whether to apply Doppler/time domain compression for reporting a PMI to the network device 110. In another example, the terminal device 130 may determine a Doppler/time domain basis type for reporting a PMI to the network device 110.

In some embodiments, a time unit may comprise a plurality of slots or subslots or symbols. For example, the number of the plurality of slots or subslots or symbols in a time unit may be represented as Tᵤ, Tᵤ may be a positive integer. For example, 1≤Tᵤ≤64. For example, Tᵤ may be at least one of {1, 2, 3, 4, 5, 6, 7, 8, 12, 16, 32}.

In some embodiments, a time interval between two time units may be plurality of slots or subslots or symbols. For example, the number of the plurality of slots or subslots or symbols for the time interval may be represented as Tᵢ, Tᵢ may be a positive integer. For example, 1≤Tᵢ≤64. For example, Tᵢ may be at least one of {1, 2, 3, 4, 5, 6, 7, 8, 12, 16, 32}. For example, in this case, each time unit may comprise one slot or subslot.

In some embodiments, the number of slots/subslots/symbols in a time unit and/or the time interval between two time units may be fixed or predetermined. In some embodiments, the number of slots/subslots in a time unit and/or the time interval between two time units may be configured by the network device 110. In some embodiments, the value of Tᵤ and/or the value of T may be fixed or predetermined or configured by the network device 110.

In some embodiments, the terminal device 130 may determine a length of a time unit (For example, Tᵤ) or a time interval between two time units (For example, Tt) which is associated with a Doppler/time domain to be a time interval between channel state information (CSI)-reference signal (RS) resources for measurement. Alternatively, the network device 110 may determine the length of a time unit or a time interval between two time units which is associated with a Doppler/time domain to be the time interval between CSI-RS resources for measurement. For example, the network device 110 may send this to the terminal device 130. In such a case, the terminal 130 receives the length of time unit from the network device 110.

In some embodiments, the Doppler/time domain basis type may include a first type and a second type. In some embodiments, the first type may represent Doppler/time domain compression is applied. In some embodiments, the second type may represent Doppler/time domain compression is not applied. In some embodiments, the first type may represent the third vector or the Doppler/time domain vector may be a DFT or DCT or oversampled DFT or Slepain vector. In some embodiments, the second type may represent the third vector or the Doppler/time domain vector may be a vector with only one element with value 1 and other elements with value 0 or an identity vector.

In some embodiments, if the Doppler/time domain compression is applied or the Doppler/time domain basis type is the first type, the terminal device 130 may determine a rank indicator (RI) as 1 or 2 accordingly. In other words, in case of RI>2, the number of Doppler/time domain basis may be 1 or there is no reporting of Doppler/time domain basis or there is no Doppler/time domain compression or the Doppler/time Domain basis type is the second type. Alternatively or additionally, such determination may be performed by the network device 110. In other words, if the Doppler/time domain compression is to be applied or the Doppler/time domain basis type is the first type, the network device 110 may determine the rank indicator (RI) as 1 or 2 accordingly.

Reference is now made back to FIG. 3. In some embodiments, the terminal device 130 transmits (320) an indication 324 to the network device 110. The indication 324 indicates whether to apply the Doppler/time domain compression or the Doppler/time domain basis type. For example, the terminal device 130 may transmit to the network device 110 the indication 324 of whether or not to apply the Doppler/time domain compression. As another example, the terminal device 130 may transmit to the network device 110 the indication 324 of the Doppler/time domain basis type. In some embodiments, such indication 324 can be included in a CSI report which is reported to the network device 110. FIG. 4A illustrates a schematic bitmap of a configuration of parameters in accordance with some embodiments of the present disclosure. In the schematic bitmap, Md is arranged first, then Mv is arranged. The size of the bitmap may be 2L*Md*Mv for one layer with index r. For specific Md and Mv values, each bit in the bitmap is mapped to a specific Doppler-frequency domain coefficient. The indication of non-zero coefficients in bitmap form may be reported by the terminal device 130 to the network device 110. For example, the terminal device 130 may include in the CSI a first indication field indicating non-zero coefficients, and then report the CSI to the network device 110.

FIG. 4B illustrates another schematic bitmap of a configuration of parameters in accordance with some embodiments of the present disclosure. In the schematic bitmap, unlike the bitmap illustrated in FIG. 4A, Mv is arranged first, then Md is arranged. For specific Md and Mv values, each bit in the bitmap is mapped to a specific frequency-Doppler domain coefficient.

In one example, the length, N4, of Doppler/time domain basis or one third vector may be configured by the network device 110 or reported by the terminal device 130. For example, the terminal device 130 may include the length N4 in CSI part 1 and then report the CSI to the network device 110. As another example, the terminal device 130 may receive the length N4 from the network device 110.

In another example, the number of third vectors Md may be configured by the network device 110 or reported by the terminal device 130. For example, the terminal device 130 may include the number Md in CSI part 1 and then report the CSI to the network device 110. As another example, the terminal device 130 may receive the number Md from the network device 110.

In another example, the length of time unit (e.g. a number of slots) may be configured by the network device 110 or reported by the terminal device. For example, the terminal device 130 may include the length of time unit in CSI part 1 and then report the CSI to the network device 110. As another example, the terminal device 130 may receive the length of time unit from the network device 110.

In some embodiments, the terminal device 130 may report, to the network device 110, the number of Doppler/time domain basis vectors, a length of the Doppler/time domain basis vectors, a length of a time unit associated with a Doppler/time domain, a bitmap of non-zero coefficients in a second matrix associated with coefficients for a codebook, or any combination of the above. Alternatively or additionally, the terminal device 130 can receive, from the network device 110, the number of the Doppler/time domain basis vectors, the length of the Doppler/time domain basis vectors, the length of the time unit associated with the Doppler/time domain configured by the network device 110, or any combination of the above.

On the other side of communication, the terminal device 130 may receive from the terminal device 130 the number of Doppler/time domain basis vectors, a length of the Doppler/time domain basis vectors, a length of a time unit associated with a Doppler/time domain, a bitmap of non-zero coefficients in a second matrix associated with coefficients for a codebook, or any combination of the above. Alternatively, the terminal device 130 may transmit, to the terminal device 130, the number of the Doppler/time domain basis vectors, the length of the Doppler/time domain basis vectors, the length of the time unit associated with the Doppler/time domain configured by the network device 110, or any combination of the above.

In one example, the length, N4, of Doppler/time domain basis may be configured by the network device 110 or reported by the terminal device 130. For example, the terminal device 130 may include the length N4 in CSI part 1 and then report the CSI to the network device 110. As another example, the terminal device 130 may receive the length N4 from the network device 110.

In another example, the number of bases Md may be configured by the network device 110 or reported by the terminal device 130. For example, the terminal device 130 may include the number Md in CSI part 1 and then report the CSI to the network device 110. As another example, the terminal device 130 may receive the number Md from the network device 110.

In another example, the length of time unit (e.g. a number of slots) may be configured by the network device 110 or reported by the terminal device 130. For example, the terminal device 130 may include the length of time unit in CSI part 1 and then report the CSI to the network device 110. As another example, the terminal device 130 may receive the length of time unit from the network device 110.

Referring back to FIG. 3, on the other side of communication, the network device 110 receives (330) from the terminal device 130 the indication 324 of whether to apply the Doppler/time domain compression or the Doppler/time domain basis type. For example, the indication 324 of whether to apply the Doppler/time domain compression or the Doppler/time domain basis type may be reported from the terminal device 130 in the form of CSI report, and the network device 110 may receive such a CSI report to acquire the indication to be aware how the terminal device 130 suggests concerning whether to apply the Doppler/time domain compression or the Doppler/time domain basis type.

After receiving (330) the indication 324 from the terminal device 130, the network device 110 processes (340) based on the indication 324 the PMI reported by the terminal device 130. For example, if the indication 324 indicates to apply the Doppler/time domain compression or the Doppler/time domain basis type, the network device 110 may process the reported PMI by applying the Doppler/time domain compression or the Doppler/time domain basis type. As another example, if the indication 324 indicates not to apply the Doppler/time domain compression or the Doppler/time domain basis type, the network device 110 may process the reported PMI by not applying the Doppler/time domain compression or the Doppler/time domain basis type.

In this way, it is more flexible to switch between high/medium mobility and low mobility. For example, during a business trip on a high speed rail, the businessman may be provided with Doppler/time domain compression or the Doppler/time domain basis type. When he gets off the high speed rail and walks on the street, he may be provided with no Doppler/time domain compression or the Doppler/time domain basis type, just as in the conventional way. Therefore, communication performance for high/medium mobility terminal devices can be improved, without increasing overhead for low mobility terminal devices.

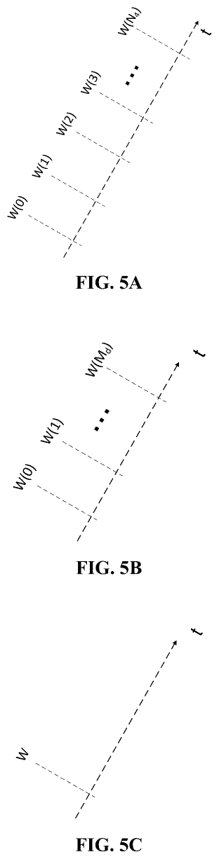

FIG. 5A illustrates a schematic diagram with Doppler/time compression in accordance with some embodiments of the present disclosure. As illustrated in FIG. 5A, a plurality of Doppler/time domain basis vectors are selected from a set of Doppler/time domain basis vectors, denoted as W(0), W(1), W(2), W(3), . . . W(N4-1), where N4 denotes the number of Doppler/time unit. For compression effect, the number of the selected plurality of Doppler/time domain basis vectors should be smaller than N4.

For comparison, FIG. 5B illustrates a schematic diagram without Doppler/time compression in accordance with some embodiments of the present disclosure. In this case, it may be the same as multiple W2 reported for different time unit indexes. Specifically, where there is no Doppler shift, the legacy codebook may be utilized, which is illustrated in FIG. 5C.

As illustrated in FIGS. 5A, 5B and 5C, according to the present disclosure, it is more flexible to switch between high/medium mobility and low mobility. Therefore, communication performance for high/medium mobility terminal devices can be improved, without increasing overhead for low mobility terminal devices.

In some embodiments, the indication 324 of applying the Doppler/time domain compression or the Doppler/time domain basis type indicates a plurality of Doppler/time domain basis vectors selected from a set of Doppler/time domain basis vectors.

For example, there may be at least one codebook indication field indicating index of Doppler/time domain basis, implying that Doppler/time domain compression (e.g. DFT basis) is adopted. Alternatively, as another example, the at least one codebook indication field may indicate no Doppler/time domain basis, implying legacy codebook or W1, W_{f} and multiple W2 (i.e. multiple codebook on different time units) is adopted.

In some embodiments, the indication 324 of not applying the Doppler/time domain compression or the Doppler/time domain basis type indicates a plurality of codebooks or a plurality of PMIs or a plurality of second matrixes for different indexes of time units associated with a Doppler/time domain but without the Doppler/time domain compression. Each of the plurality of second matrixes may be associated with coefficients for a codebook. For example, a second matrix may be referred to as M₂.

In some embodiments, the terminal device 130 may determine whether to apply the Doppler/time domain compression or the Doppler/time domain basis type as follows. If the terminal device 130 determines that a velocity of the terminal device 130 is higher than or equal to a predefined threshold velocity or a correlation between at least two CSI-RS resources is lower than or equal to a predefined threshold value, then the terminal device 130 can determine to apply the Doppler/time domain compression or the Doppler/time domain basis type. Otherwise, if the terminal device 130 determines that the velocity of the terminal device is lower than or equal to the predefined threshold velocity or a correlation between at least two CSI-RS resources is higher than or equal to a predefined threshold value, then the terminal device 130 may determine not to apply the Doppler/time domain compression or the Doppler/time domain basis type.

In one example, the terminal device 130 may determine its velocity by calculating distance and time. Then the terminal device 130 may determine whether its velocity is higher than or equal to a predefined threshold Th1. If the determined (calculated) velocity is higher than or equal to the predefined threshold Th1, the terminal device 130 may determine to apply the Doppler/time domain compression or the Doppler/time domain basis type. On the contrary, if the determined (calculated) velocity is lower than the predefined threshold Th1, the terminal device 130 may determine not to apply the Doppler/time domain compression or the Doppler/time domain basis type.

In another example, the terminal device 130 may determine whether a correlation between at least two CSI-RS resources is lower than or equal to a predefined threshold value Th2. If so, the terminal device 130 may determine to apply the Doppler/time domain compression or the Doppler/time domain basis type. If not, the terminal device 130 may determine not to apply the Doppler/time domain compression or the Doppler/time domain basis type.

In some embodiments, a first matrix associated with a Doppler/time domain and indicated in at least one codebook information field in the PMI comprises the plurality of Doppler/time domain basis vectors.

For W(t), the index(es) of t(md) for those non-zero W(t) can be controlled by W_{d}. The selection of t for non-zero W(t) or selection of time unit index(es) for non-zero W(t) can be based on same indication field for selection of Doppler/time basis.

The fourth matrix or the plurality of third vectors or Doppler/time basis may be represented by:

$${W}_{d} = [ \begin{matrix}{d}_{0}^{( 0 )} & {d}_{1}^{( 0 )} & & {d}_{{N}_{4} - 1}^{( 0 )} \\ {d}_{0}^{( 1 )} & {d}_{1}^{( 1 )} & & {d}_{{N}_{4} - 1}^{( 1 )} \\ {d}_{0}^{( 2 )} & {d}_{1}^{( 2 )} & … & {d}_{{N}_{4} - 1}^{( 2 )} \\ ⋮ & ⋮ & & ⋮ \\ {d}_{0}^{( {M}_{d} - 1 )} & {d}_{1}^{( {M}_{d} - 1 )} & & {d}_{{N}_{4} - 1}^{( {M}_{d} - 1 )}\end{matrix} ]$$

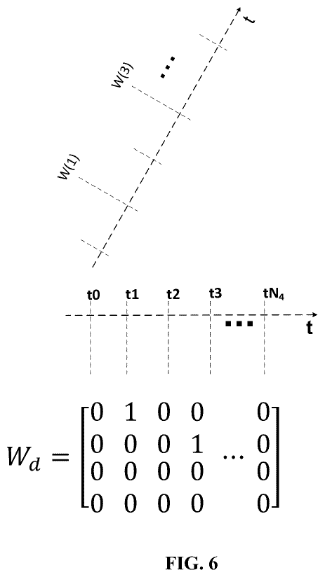

For example, in case W_{d} is composed by Doppler/time basis (in other words, in case of Doppler/time compression), the indication field indicates the index(es) of Doppler/time basis. As another example, in case W_{d} is permutation matrix, which means there is no Doppler/time compression, the indication field indicates the index(es) of columns with non-zero vectors (only one element is 1, and other elements are 0 in each vector) in W_{d}. This is illustrated in FIG. 6.

FIG. 6 illustrates a schematic diagram without Doppler/time compression in accordance with some embodiments of the present disclosure. As illustrated in FIG. 6, the elements in the first column are all 0, and the vector for column t(md) in W_{d} may be that the (md+1)th element is 1, and other are 0. In some embodiments, a first matrix associated with the Doppler/time domain and indicated in at least one codebook information field in the PMI is a permutation matrix.

In some embodiments, the terminal device 130 may select the indexes of the time units based on an indication field for selecting Doppler/time domain basis vectors from a set of Doppler/time domain basis vectors, and that indication field is designed in the CSI, then the terminal device 130 may send the CSI report to the network device 110. For example, the matrix W_{d} for FIG. 5B may be expressed as

$${W}_{d} = [ \begin{matrix}1 & 0 & 0 & 0 & … & 0 \\ 0 & 1 & 0 & 0 & … & 0 \\ 0 & 0 & ⋮ & 0 & … & 0 \\ 0 & 0 & 0 & 1 & … & 0\end{matrix} ]$$

As described above, with such a matrix W_{d}, it is indicated that no Doppler/time compression is adopted. In other words, the matrix associated with the Doppler/time domain and indicated in at least one codebook information field in the PMI is a permutation matrix.

On the other side of communication, the terminal device 130 may receive the CSI report, and may determine the indexes of the time units based on the indication field in the CSI. The indication field is used for selecting Doppler/time domain basis vectors from a set of Doppler/time domain basis vectors, as mentioned above.

For W(t), the index(es) of t for those non-zero W(t) can be controlled by W_{d}. For example, the selection of t for non-zero W(t) or selection of time unit index(es) for non-zero W(t) can be based on same indication field (e.g. the second indication field) for selection of Doppler/time basis. As another example, in the matrix W_{d}, the elements corresponding to t=0, 2, 4, . . . 2n may be all zero, and the vector for column t(md) may be set to that the (md+1)th element is 1, and others are 0.

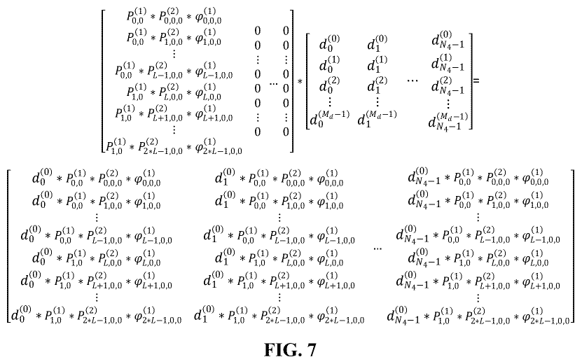

FIG. 7 illustrates a schematic diagram without Doppler/time in accordance with some embodiments of the present disclosure. In some embodiments, if there is no Doppler (which means there is no Doppler shift), based on the new codebook structure introduced in the present disclosure, the indication of not applying the Doppler/time domain compression or the Doppler/time domain basis type indicates a codebook without a first matrix associated with a Doppler/time domain or without at least one codebook information field in the PMI.

In one example, only one Doppler/time basis may be selected (in other words, Md=1), and value of Md can be reported to the network device 110 by the terminal device 130. In such a case, the network device 110 may learn from the received report that the terminal device 130 suggests not applying the Doppler/time domain compression or the Doppler/time domain basis type, and this indicates a codebook without a first matrix (e.g., the matrix W_{d} as described before) associated with a Doppler/time domain. This scenario is illustrated in FIG. 5C for illustrative purpose. As illustrated in FIG. 5C, only one Doppler/time basis may be selected. In such a case, a legacy codebook may be used, as mentioned above.

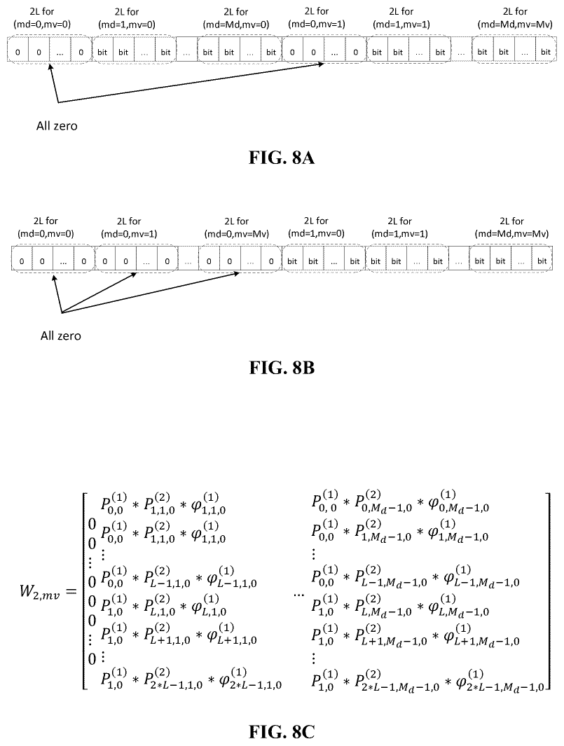

In another example, only one column of coefficients corresponding to Doppler/time bases is non-zero. In such a case, the network device 110 may learn from the received report that the terminal device 130 suggests not applying the Doppler/time domain compression or the Doppler/time domain basis type, and this indicates a codebook without at least one codebook information field in the PMI. As illustrated in FIG. 8C, only one column of coefficients corresponding to Doppler/time bases W_{2,mv} is non-zero. More specifically, only the first column of coefficients corresponding to Doppler/time bases W_{2,mv} is non-zero. This indicates that there is no Doppler/time domain. The network device 110 may learn from the received report that the terminal device 130 suggests not applying the Doppler/time domain compression or the Doppler/time domain basis type.

In some embodiments, the codebook may be indicated by indicating one Doppler/time domain basis vector in a set of Doppler/time domain basis vectors. Alternatively, in some embodiments, the codebook is indicated by indicating one column of a second matrix associated with coefficients for the codebook as non-zero and all elements in other columns of the second matrix as zero. As mentioned above, in the example illustrated in FIG. 8C, only the first column of coefficients corresponding to Doppler/time basis W_{2,mv} is non-zero. By indicating this one Doppler/time domain basis vector in a set of Doppler/time domain basis vectors as illustrated in FIG. 8, the network device 110 may learn from the received report that the terminal device 130 suggests using the codebook corresponding to the one Doppler/time domain basis vector in future communication.

FIG. 8A illustrates a schematic diagram without Doppler/time compression in accordance with some embodiments of the present disclosure. A bitmap with a size of 2L×Md×Mv is illustrated in FIG. 8A. As mentioned above in the description of FIG. 2A and FIG. 2B, 2L represents the number of spatial domain basis vectors, Md represents the number of Doppler/time domain basis vectors, and Mv represents the number of frequency domain basis vectors. The columns indicated by (md=0, mv=0) and (md=0, mv=1) in the bitmap have all-zero values.

FIG. 8B illustrates another schematic diagram without Doppler/time compression in accordance with some embodiments of the present disclosure. The columns indicated by (md=0, mv=0), (md=0, mv=1), . . . , and (md=0, mv=Mv) in the bitmap have all-zero values.

FIG. 8C illustrates another schematic diagram without Doppler/time compression in accordance with some embodiments of the present disclosure. As illustrated in FIG. 8C, the first column in the matrix W_{2,mv} has all-zero values.

In some embodiments, the non-zero column is indicated by a bitmap of a size of 2L×Md×Mv, 2L representing the number of spatial domain basis vectors, Md representing the number of Doppler/time domain basis vectors, and Mv representing the number of frequency domain basis vectors. For example, in the example illustrated in FIGS. 8A and 8B, zero-value columns as well as non-zero columns are indicated by a bitmap of a size of 2L×Md×Mv, as mentioned above. The position of non-zero columns indicated in the bitmap may be arbitrary; the position of non-zero columns illustrated in the FIGS. 8A and 8B and 8C is only for illustrative purpose, and the present disclosure is not limited to such examples in this regard.

As another example, if the bitmap for indicating non-zero coefficients indicates that at least one column (e.g. the number of column may be Mz (1<=Mz<=Md)) of coefficients for W2,md (corresponding to each Doppler/time basis, and the column index for all-zero elements are same in each one of W2,md) is 0, W_{d} may be a permutation matrix and there may be no Doppler/time compression. In such a case, Md-Mz W2 matrixes may be actually reported by the terminal device 130 to the network device 110, and the index of time unit corresponding to each W2 may be based on a second indication field.

In some embodiments, the terminal device 130 may arrange a column of a strongest coefficient after the first column with all zero coefficients in the second matrix. For example, if W_{d} is a permutation matrix (in other words, if no Doppler/time compression is employed), index of column corresponding to the strongest coefficient may be further indicated by the terminal device 130 to the network device 110. The strongest coefficients cannot be rotated to the first column. If no Doppler/time compression is based on at least one column of all zero values, the index of column corresponding to the strongest coefficient may be the first column with all non-zero-value coefficients after the first column with all zero-value coefficients. This scenario may be expressed as the following equation (3)

$${W}_{2 , mv} = [ \begin{matrix}{vec}_{0} & {vec}_{1} & {vec}_{2} & … & {vec}_{Md - 1} ]\end{matrix} \qquad ( 3 )$$

In equation (3), vec₀ denotes the first column with all zero-value coefficients, and vec₁ denotes the first column with all non-zero-value coefficients after vec₀. If no Doppler/time compression is based on at least one column of all zero values, the index of column corresponding to the strongest coefficient may be vec₁.

It is to be noted that the first column with all zero-value coefficients may not be necessarily the first column in W_{2,mv}; it may be at any position. In another example, the first column with all zero-value coefficients may be not the first column in W_{2,mv}. The following equation (4) illustrates such a scenario.

$${W}_{2 , mv} = [ \begin{matrix}{vec}_{0} & {vec}_{1} & {vec}_{2} & … & {vec}_{Md - 1} ]\end{matrix} \qquad ( 4 )$$

In equation (4), vec₁ denotes the first column with all zero-value coefficients, and vec₂ denotes the first column with all non-zero-value coefficients after vec₁. If no Doppler/time compression is based on at least one column of all zero values, the index of column corresponding to the strongest coefficient may be vec₂.

In some embodiments, the terminal device 130 can rotate a column including a strongest coefficient of a second matrix associated with coefficients for a codebook to be the first column of the second matrix. For example, at least in case of W_{d} composed by DFT bases, and in case there is common Doppler/time domain basis for spatial domain and frequency domain, the strongest coefficient for layer r can be rotated to the first column.

The rotation may be performed with a rotation matrix R defined as bellow:

$$R = [ \begin{matrix}{R}_{d} & 0 & 0 & 0 & & 0 \\ 0 & {R}_{d} * {e}^{j * 2 π \frac{{α}_{1}}{{N}_{3}}} & 0 & 0 & & 0 \\ 0 & 0 & {R}_{d} * {e}^{j * 2 π \frac{2 {α}_{1}}{{N}_{3}}} & 0 & … & 0 \\ 0 & 0 & 0 & 0 & & 0 \\ 0 & 0 & 0 & ⋱ & & 0 \\ 0 & 0 & 0 & 0 & & {e}^{j * 2 π \frac{( {N}_{3} - 1 ) {α}_{1}}{{N}_{3}}} * {R}_{d}\end{matrix} ] \qquad ( 4 )$$

wherein Rd is defined as:

$${R}_{d} = [ \begin{matrix}1 & 0 & 0 & 0 & & 0 \\ 0 & {e}^{j * 2 π \frac{{β}_{1}}{{N}_{4}}} & 0 & 0 & & 0 \\ 0 & 0 & {e}^{j * 2 π \frac{2 {β}_{1}}{{N}_{4}}} & 0 & … & 0 \\ 0 & 0 & 0 & 0 & & 0 \\ 0 & 0 & 0 & ⋱ & & 0 \\ 0 & 0 & 0 & 0 & & {e}^{j * 2 π \frac{( {N}_{4} - 1 ) {β}_{1}}{{N}_{4}}}\end{matrix} ] \qquad ( 5 )$$

wherein, β₁ may be

$${n}_{4 , r}^{( md )}$$

wherein md may be the index of basis corresponding to strongest coefficient, α₁ may be

$${n}_{3 , r}^{( mv )}$$

wherein mv may be the index of basis corresponding to strongest coefficient. By rotating a column including a strongest coefficient of the matrix W_{d} associated with coefficients for a codebook to be the first column of the matrix W_{d}, overhead for CSI transmission can be saved.

In some embodiments, the terminal device 130 may determine a bit size of an indication field of the strongest coefficient based on 2L, 2L representing the number of spatial domain basis vectors; and determining a bit size of an indication field of Doppler/time domain basis vectors based on Ns−1 and Md−1, Md representing the number of Doppler/time domain basis vectors, and Ns representing one of the following: a length of Doppler/time domain basis vectors, the number of oversampled Doppler/time domain basis vectors, and the number of Doppler/time domain basis vectors in a window selected from the Doppler/time domain basis vectors or the oversampled Doppler/time domain basis vectors.

For example, as mentioned above, at least in case of W_{d} composed by DFT bases, and in case there is common Doppler/time domain basis for spatial domain and frequency domain, the strongest coefficient for layer r can be rotated to the first column.

$${mv}_{r}^{*} ∈ \{ 0 , 1 , … , {M}_{υ} - 1 \}$$

is assumed to be the index of frequency domain basis corresponding to the strongest coefficient of layer r. The codebook indices of n_{3,r} may be remapped with respect to

$${n}_{3 , r}^{( {mv}_{r}^{*} )} as {n}_{3 , r}^{( mv )} = ( {n}_{3 , r}^{( mv )} - {n}_{3 , r}^{( {mv}_{r}^{*} )} )$$

mod N₃, such that

$${n}_{3 , r}^{( {mv}_{r}^{*} )} = 0 ,$$

after remapping. The index mv may be remapped with respect to

$${mv}_{r}^{*} as mv = ( mv - {mv}_{r}^{*} )$$

mod M_{U}, such that the index of the strongest coefficient is

$${mv}_{r}^{*} = 0$$

(r=1, . . . , RI), after remapping.

Further,

$${md}_{r}^{*} ∈ \{ 0 , 1 , … , {M}_{d} - 1 \}$$

is assumed to be the index of Doppler/time domain basis corresponding to the strongest coefficient of layer r. The codebook indices of n_{4,r} may be remapped with respect to

$${n}_{4 , r}^{( {md}_{r}^{*} )} as {n}_{4 , r}^{( md )} = ( {n}_{4 , r}^{( md )} - {n}_{4 , r}^{( {md}_{r}^{*} )} )$$

mod N₄, such that

$${n}_{4 , r}^{( {md}_{r}^{*} )} = 0 ,$$

after remapping. The index md may be remapped with respect to

$${md}_{r}^{*} as md = ( md - {md}_{r}^{*} )$$

mod M_{d}, such that the index of the strongest coefficient is

$${md}_{r}^{*} = 0$$

(r=1, . . . , RI), after remapping. In this example, the bit size of the third indication field (SCI) may be ceil(log 2(2L)), and the bit size of the second indication field (Doppler/time domain basis indication) may be ceil(log 2(Ns−1, Md−1)).

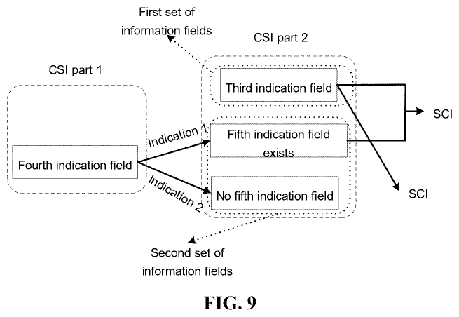

FIG. 9 illustrates a schematic diagram of a CSI structure in accordance with some embodiments of the present disclosure. As illustrated in FIG. 9, there is a CSI part 1 and a CSI part 2. There is a fourth indication field in CSI part 1. The fourth indication field comprises an indication 1 and an indication 2. The indication 1 indicates that a fifth indication field exists in the CSI part 2, and the indication 2 indicates that there is no fifth indication field in the CSI part 2. The CSI part 2 further comprises a third indication field, which constitutes a first set of information fields. The indication fields indicate whether the fifth indication field exists or not constitute a second set of information fields.

In some embodiments, the selection of Doppler/time basis may be reported by the terminal device 130 to the network device 110. For example, the terminal device 130 may transmit the selection of Doppler/time basis via a second indication field in the CSI report to the network device 110. The size of the second indication field may be ceil(log 2(C(Ns, Md))) or ceil(log 2(Ns−1, Md−1)) (e.g. with rotation, one basis is rotated to be [1,1, . . . 1]), Ns may be at least one of: N4 (e.g. in case of orthogonal DFT basis for Doppler/time basis), N4*O3 (e.g. oversampled DFT basis for Doppler/time basis), N5 (e.g. a window selected from N4 or N4*O3, similar as the case of N3>19 for frequency domain compression, e.g. N5=A*Md, A may be 2 or 3 or 4).

$$\tilde{W} = [ \begin{matrix}{v}_{0} {v}_{1} … {v}_{L - 1} & 0 \\ 0 & {v}_{0} {v}_{1} … {v}_{L - 1}\end{matrix} ] * [ \begin{matrix}{W}_{2 , 0} & {W}_{2 , 1} & … & {W}_{2 , {M}_{v} - 1}\end{matrix} ] * [ \begin{matrix}{y}_{0}^{( 0 )} * {W}_{d} & {y}_{1}^{( 0 )} * {W}_{d} & … & {y}_{{N}_{3} - 1}^{( 0 )} * {W}_{d} \\ {y}_{0}^{( 1 )} * {W}_{d} & {y}_{1}^{( 1 )} * {W}_{d} & … & {y}_{{N}_{3} - 1}^{( 1 )} * {W}_{d} \\ ⋮ & ⋮ & ⋮ & ⋮ \\ {y}_{0}^{( {M}_{v} - 1 )} * {W}_{d} & {y}_{1}^{( {M}_{v} - 1 )} * {W}_{d} & … & {y}_{{N}_{3} - 1}^{( {M}_{v} - 1 )} * {W}_{d}\end{matrix} ] \qquad ( 6 )$$

Further, strongest coefficient indicator (SCI) may be reported by the terminal device 130 to the network device 110. For example, the terminal device 130 may transmit the SCI via a third indication field in the CSI report to the network device 110. As shown in FIG. 9, the third indication field is included in the CSI part 2, and the third indication field constitutes a first set of information fields. It is to be noted the SCI indication is a per layer indication.

In one example, if no Doppler/time compression (or basis type) is indicated/reported by the terminal device 130 with a fourth indication field (e.g. in CSI part 1)), in the first set of information fields of CSI part 2, there may be a third indication field to indicate SCI for layer with index r, and the bit size of the third indication field may be ceil(log 2(2L)).

Also in this example, if the fourth indication field indicates Doppler/time compression (e.g. DFT basis type), then the third indication field in the first set of information fields of CSI part 2 indicates the index of strongest coefficient, which is the same as the legacy scheme and rotation may be applied.

Also in this example, if the fourth indication field indicates no Doppler/time compression, there may be a fifth indication field in first or second set of information fields of CSI part 2, to indicate the index of column corresponding to the strongest coefficient, and the bit size of the fifth indication field may be ceil(log 2(Md)). In such a way, the third indication field and the fifth indication field jointly indicate the index of strongest coefficient, where the fifth indication field indicates which column of the matrix W_{d} has the strongest coefficient, and the third indication field further indicates which element in that column indicated by the fifth indication field has the strongest coefficient.

In some embodiments, if the Doppler/time domain compression or the Doppler/time domain basis type is applied, an indication field indicates an element index of a strongest coefficient of a second matrix in a predefined column of the second matrix, the second matrix being associated with coefficients for a codebook. For example, in case of the indication field in a CSI part 1 indicates Doppler/time compression (e.g. DFT basis type), then an indication field in the first set of information fields of a CSI part 2 can indicate the index of strongest coefficient (i.e. legacy scheme). For instance, rotation may be applied in this event.

If the Doppler/time domain compression or the Doppler/time domain basis type is not applied, another indication field indicates a column index of the strongest coefficient in the second matrix and the indication field for indicating the element index indicates the element index of the strongest coefficient in the column. For example, in case of the indication field in a CSI part 1 indicate no Doppler/time compression, there may be another indication field in first or second set of information fields of the CSI part 2, to indicate the index of column corresponding to the strongest coefficient, and the bit size may be ceil(log 2(W_{d})). In other words, the indication field for indicating the element index and the fifth indication field for indicating the column index jointly indicate the index of strongest coefficient.

For example, as mentioned above, if the Doppler/time domain compression or the Doppler/time domain basis type is not applied, the fifth indication field may indicate which column of the matrix W_{d} (which is associated with coefficients for a codebook in accordance with the present disclosure, as mentioned before) has the strongest coefficient, and the third indication field may further indicate which element in that column indicated by the fifth indication field has the strongest coefficient.

In some embodiments, the indication 324 of whether to apply the Doppler/time domain compression or the Doppler/time domain basis type is comprised in a first part of channel state information (CSI), and the indication field for an element index and the indication field for a column index are comprised in a second part of the CSI. For example, as illustrated in FIG. 9, the fourth indication field, namely, the indication 324 of whether to apply the Doppler/time domain compression or the Doppler/time domain basis type, may be comprised in a first part of channel state information (CSI), which is denoted as “CSI part 1”. The indication field for an element index (which corresponds to “third indication field” in FIG. 9) and the indication field for a column index (which corresponds to “fifth indication field” in FIG. 9) are comprised in a second part of the CSI, which is denoted as “CSI part 2”.

In some embodiments, if the Doppler/time domain compression or the Doppler/time domain basis type is applied, an indication field of a first size indicates an element index of a strongest coefficient in a second matrix in a predefined column of the second matrix, the second matrix being associated with coefficients for a codebook; and if the Doppler/time domain compression or the Doppler/time domain basis type is not applied, the indication field of a second size indicates a column index and an element index in the column for the strongest coefficient in the second matrix.

For example, as illustrated in FIG. 9, the bit size of third indication field for indicating SCI for layer with index r may depend on the indication of the fourth indication field in CSI part 1. In such a case, the fourth indication field may indicate whether there is Doppler/time compression or not (or indicate basis type for W_{d}). Also in this example, if the fourth indication field indicates Doppler/time compression (e.g. DFT basis type), then the bit size for the third field in the first set of information fields of CSI part 2 may be ceil(log 2(2L)). In this case, rotation may be applied. Also in this example, if the fourth indication field indicates no Doppler/time compression, then the bit size for the third indication field in the first set of information fields of CSI part 2 may be ceil(log 2(2L*W_{d})).

In some embodiments, the indication 324 of whether to apply the Doppler/time domain compression or the Doppler/time domain basis type is comprised in a first part of channel state information (CSI), and the indication field for the strongest coefficient indication is comprised in a second part of the CSI.

As illustrated in FIG. 9, the fourth indication field indicates whether to apply the Doppler/time domain compression or the Doppler/time domain basis type, and the fourth indication field is comprised in a first part of channel state information (CSI), which is denoted as “CSI part 1” in FIG. 9. The fifth indication field is used for the strongest coefficient indication, and the fifth indication field is comprised in a second part of the CSI, which is denoted as “CSI part 2” in FIG. 9.

In some embodiments, the terminal device 130 may determine a bit size for indicating each of a plurality of phase coefficients in a second matrix based on a length of the third vector or the Doppler/time domain basis vectors, the second matrix being associated with coefficients for the plurality of codebooks or precoding matrices. In some embodiments, if the value of N4 is no larger than or less than a first value, the bit size of phase coefficient may be

$$4 ( e . g . {e}^{j \frac{2 π * φ}{16}} ) .$$

For example, the first value may be a positive integer. For example, 1≤the first value ≤31. In some embodiments, if the value of N4 is larger than or no less than the first value and/or less than or no larger than a second value, the bit size of phase coefficient may be

$$5 ( e . g . {e}^{j \frac{2 π * φ}{32}} ) .$$

For example, the second value may be a positive integer. For example, 1≤the second value ≤256. For example, based on the codebook structure, actually specific Doppler/time domain basis for spatial domain and/or frequency domain basis can be achieved based on different values of phase coefficients corresponding to different spatial domain basis and/or frequency domain basis, at least when the length of N4 is similar as 16 (which is the phase resolution ratio). This implies that, the bit size for phase coefficient may be based on the value of N4. For example, if the value of N4 is in a first subset (e.g. N4<=24), bit size of phase coefficient may be

$$4 ( e . g . {e}^{j \frac{2 π * φ}{16}} ) ,$$

and if the value of N4 is in a second subset (e.g. N4>24 or N4>32), bit size of phase coefficient may be

$$5 ( e . g . {e}^{j \frac{2 π * φ}{32}} ) .$$

In such a case, common Doppler/time basis may be applied for spatial/frequency domain bases.

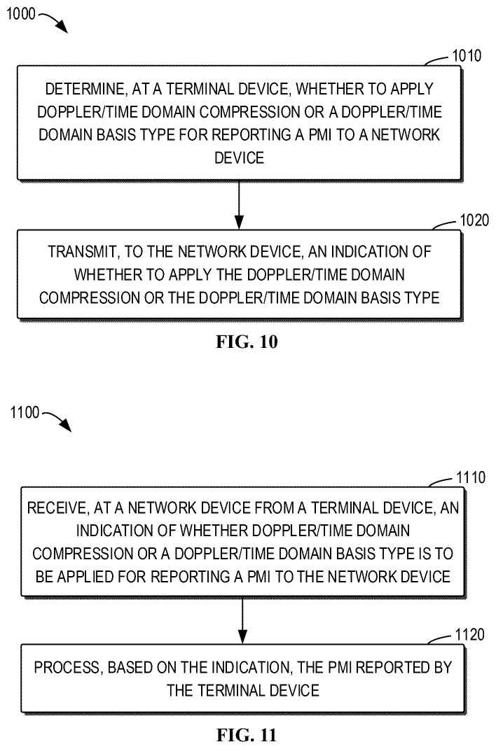

FIG. 10 illustrates a flowchart of an example method 1000 implemented at a terminal device in accordance with some embodiments of the present disclosure. For the purpose of discussion, the method 1000 will be described from the perspective of the terminal device 130 with reference to FIG. 1.

At block 1010, the terminal device 130 determines whether to apply Doppler/time domain compression or a Doppler/time domain basis type for reporting a precoding matrix indicator (PMI) to the network device 110. At block 1020, the terminal device 130 transmits, to the network device 110, an indication of whether to apply the Doppler/time domain compression or the Doppler/time domain basis type.

In some example embodiments, the indication of applying the Doppler/time domain compression or the Doppler/time domain basis type indicates a plurality of Doppler/time domain basis vectors selected from a set of Doppler/time domain basis vectors.

In some example embodiments, a first matrix associated with a Doppler/time domain and indicated in at least one codebook information field in the PMI comprises the plurality of Doppler/time domain basis vectors.

In some example embodiments, the indication of not applying the Doppler/time domain compression or the Doppler/time domain basis type indicates a plurality of codebooks or a plurality of PMIs or a plurality of second matrixes for different indexes of time units associated with a Doppler/time domain but without the Doppler/time domain compression, each of the plurality of second matrixes being associated with coefficients for a codebook.

In some example embodiments, the method 1000 further comprising: selecting the indexes of the time units based on an indication field for selecting Doppler/time domain basis vectors from a set of Doppler/time domain basis vectors.

In some example embodiments, a first matrix associated with the Doppler/time domain and indicated in at least one codebook information field in the PMI is a permutation matrix.

In some example embodiments, the indication of not applying the Doppler/time domain compression or the Doppler/time domain basis type indicates a codebook without a first matrix associated with a Doppler/time domain or without at least one codebook information field in the PMI.

In some example embodiments, the codebook is indicated by: indicating one Doppler/time domain basis vector in a set of Doppler/time domain basis vectors.

In some example embodiments, the codebook is indicated by: indicating one column of a second matrix associated with coefficients for the codebook as non-zero and all elements in other columns of the second matrix as zero.

In some example embodiments, the non-zero column is indicated by a bitmap of a size of 2L×Md×Mv, 2L representing the number of spatial domain basis vectors, Md representing the number of Doppler/time domain basis vectors, and Mv representing the number of frequency domain basis vectors.

In some example embodiments, the method 1000 further comprises: arranging a column of a strongest coefficient after the first column with all zero coefficients in the second matrix.

In some example embodiments, the method 1000 further comprises: rotating a column including a strongest coefficient of a second matrix associated with coefficients for a codebook to be the first column of the second matrix.

In some example embodiments, the method 1000 further comprises: determining a bit size of an indication field of the strongest coefficient based on 2L, 2L representing the number of spatial domain basis vectors; and determining a bit size of an indication field of Doppler/time domain basis vectors based on Ns−1 and Md−1, Md representing the number of Doppler/time domain basis vectors, and Ns representing one of the following: a length of Doppler/time domain basis vectors, the number of oversampled Doppler/time domain basis vectors, and the number of Doppler/time domain basis vectors in a window selected from the Doppler/time domain basis vectors or the oversampled Doppler/time domain basis vectors.

In some example embodiments, if the Doppler/time domain compression or the Doppler/time domain basis type is applied, a first indication field (for example, an indication field for an element index) indicates an element index of a strongest coefficient of a second matrix in a predefined column of the second matrix, the second matrix being associated with coefficients for a codebook; and if the Doppler/time domain compression or the Doppler/time domain basis type is not applied, a second indication field (for example, an indication field for a column index) indicates a column index of the strongest coefficient in the second matrix and the first indication field indicates the element index of the strongest coefficient in the column.

In some example embodiments, the indication of whether to apply the Doppler/time domain compression or the Doppler/time domain basis type is comprised in a first part of channel state information (CSI), and the first indication field and the second indication field are comprised in a second part of the CSI.

In some example embodiments, if the Doppler/time domain compression or the Doppler/time domain basis type is applied, an indication field of a first size indicates an element index of a strongest coefficient in a second matrix in a predefined column of the second matrix, the second matrix being associated with coefficients for a codebook; and if the Doppler/time domain compression or the Doppler/time domain basis type is not applied, the indication field of a second size indicates a column index and an element index in the column for the strongest coefficient in the second matrix.

In some example embodiments, the indication of whether to apply the Doppler/time domain compression or the Doppler/time domain basis type is comprised in a first part of channel state information (CSI), and the indication field for the strongest coefficient indication is comprised in a second part of the CSI.

In some example embodiments, the method 1000 further comprises: determining a bit size for indicating each of a plurality of phase coefficients in a second matrix based on a length of Doppler/time domain basis vectors, the second matrix being associated with coefficients for a codebook.

In some example embodiments, the method 1000 further comprises: reporting, to the network device, at least one of the number of Doppler/time domain basis vectors, a length of the Doppler/time domain basis vectors, a length of a time unit associated with a Doppler/time domain, and a bitmap of non-zero coefficients in a second matrix associated with coefficients for a codebook, or receiving at least one of the following from the network device: the number of the Doppler/time domain basis vectors, the length of the Doppler/time domain basis vectors, and the length of the time unit associated with the Doppler/time domain configured by the network device.

In some example embodiments, the method 1000 further comprises: determining a length of a time unit associated with a Doppler/time domain as a time interval between channel state information (CSI)-reference signal (RS) resources for measurement.

In some example embodiments, the method 1000 further comprises: in response to applying the Doppler/time domain compression or the Doppler/time domain basis type, determining a rank indicator (RI) as 1 or 2.

In some example embodiments, determining whether to apply the Doppler/time domain compression or the Doppler/time domain basis type comprises: in response to determining that a velocity of the terminal device is higher than or equal to a predefined threshold velocity or a correlation between at least two CSI-RS resources is lower than or equal to a predefined threshold value, determining to apply the Doppler/time domain compression or the Doppler/time domain basis type; and in response to determining that the velocity of the terminal device is lower than or equal to the predefined threshold velocity or a correlation between at least two CSI-RS resources is higher than or equal to a predefined threshold value, determining not to apply the Doppler/time domain compression or the Doppler/time domain basis type.

FIG. 11 illustrates a flowchart of an example method 1100 implemented at a network device in accordance with some embodiments of the present disclosure. For the purpose of discussion, the method 1100 will be described from the perspective of the network device 110 with reference to FIG. 1.

At block 1110, the network device 110 receives, from a terminal device 130, an indication of whether Doppler/time domain compression or a Doppler/time domain basis type is to be applied for reporting a precoding matrix indicator (PMI) to the network device. At block 1120, the network device 110 processes, based on the indication, the PMI reported by the terminal device 130.

In some example embodiments, the indication that the Doppler/time domain compression or the Doppler/time domain basis type is to be applied indicates a plurality of Doppler/time domain basis vectors selected from a set of Doppler/time domain basis vectors.

In some example embodiments, a first matrix associated with a Doppler/time domain and indicated in at least one codebook information field in the PMI comprises the plurality of Doppler/time domain basis vectors.

In some example embodiments, the indication that the Doppler/time domain compression or the Doppler/time domain basis type is not to be applied indicates a plurality of codebooks or a plurality of PMIs or a plurality of second matrixes for different indexes of time units associated with a Doppler/time domain but without the Doppler/time domain compression, each of the plurality of second matrixes being associated with coefficients for a codebook.

In some example embodiments, the method 1100 further comprises: determining the indexes of the time units based on an indication field for selecting Doppler/time domain basis vectors from a set of Doppler/time domain basis vectors.

In some example embodiments, a first matrix associated with the Doppler/time domain and indicated in at least one codebook information field in the PMI is a permutation matrix.

In some example embodiments, the indication that the Doppler/time domain compression or the Doppler/time domain basis type is not to be applied indicates a codebook without a first matrix associated with a Doppler/time domain or without at least one codebook information field in the PMI.

In some example embodiments, the codebook is indicated by one Doppler/time domain basis vector in a set of Doppler/time domain basis vectors being indicated.

In some example embodiments, the codebook is indicated by one column of a second matrix associated with coefficients for the codebook being indicated as non-zero and all elements in other columns of the second matrix being indicated as zero.

In some example embodiments, the non-zero column is indicated by a bitmap of a size of 2L×Md×Mv, 2L representing the number of spatial domain basis vectors, Md representing the number of Doppler/time domain basis vectors, and Mv representing the number of frequency domain basis vectors.

In some example embodiments, the method 1100 further comprises determining that a column of a strongest coefficient is after the first column with all zero coefficients in the second matrix.

In some example embodiments, the method 1100 further comprises determining that a strongest coefficient of a second matrix associated with coefficients for a codebook is in the first column of the second matrix.

In some example embodiments, the method 1100 further comprises determining a bit size of an indication field of the strongest coefficient based on 2L, 2L representing the number of spatial domain basis vectors; and determining a bit size of an indication field of Doppler/time domain basis vectors based on Ns−1 and Md−1, Md representing the number of Doppler/time domain basis vectors, and Ns representing one of the following: a length of Doppler/time domain basis vectors, the number of oversampled Doppler/time domain basis vectors, and the number of Doppler/time domain basis vectors in a window selected from the Doppler/time domain basis vectors or the oversampled Doppler/time domain basis vectors.

In some example embodiments, if the Doppler/time domain compression or the Doppler/time domain basis type is applied, a first indication field (for example, an indication field for an element index) indicates an element index of a strongest coefficient of a second matrix in a predefined column of the second matrix, the second matrix being associated with coefficients for a codebook; and if the Doppler/time domain compression or the Doppler/time domain basis type is not applied, a second indication field (for example, an indication field for a column index) indicates a column index of the strongest coefficient in the second matrix and the first indication field indicates the element index of the strongest coefficient in the column.

In some example embodiments, the indication of whether the Doppler/time domain compression or the Doppler/time domain basis type is to be applied is comprised in a first part of the channel state information (CSI), and the first indication field and the second indication field are comprised in a second part of the CSI.

In some example embodiments, if the Doppler/time domain compression or the Doppler/time domain basis type is applied, an indication field of a first size indicates an element index of a strongest coefficient in a second matrix in a predefined column of the second matrix, the second matrix being associated with coefficients for a codebook; and if the Doppler/time domain compression or the Doppler/time domain basis type is not applied, the indication field of a second size indicates a column index and an element index in the column for the strongest coefficient in the second matrix.

In some example embodiments, the indication of whether the Doppler/time domain compression or the Doppler/time domain basis type is to be applied is comprised in a first part of channel state information (CSI), and the indication field for the strongest coefficient indication is comprised in a second part of the CSI.

In some example embodiments, the method 1100 further comprises: determining a bit size for indicating each of a plurality of phase coefficients in a second matrix based on a length of Doppler/time domain basis vectors, the second matrix being associated with coefficients for a codebook.

In some example embodiments, the method 1100 further comprises: receiving, from the terminal device, at least one of the number of Doppler/time domain basis vectors, a length of the Doppler/time domain basis vectors, a length of a time unit associated with a Doppler/time domain, and a bitmap of non-zero coefficients in a second matrix associated with coefficients for a codebook; or transmitting at least one of the following to the terminal device: the number of the Doppler/time domain basis vectors, the length of the Doppler/time domain basis vectors, and the length of the time unit associated with the Doppler/time domain configured by the network device.

In some example embodiments, the method 1100 further comprises: determining a length of a time unit associated with a Doppler/time domain as a time interval between channel state information (CSI)-reference signal (RS) resources for measurement.

In some example embodiments, the method 1100 further comprises: in response to the Doppler/time domain compression or the Doppler/time domain basis type being applied, determining a rank indicator (RI) as 1 or 2.

Details of some embodiments according to the present disclosure have been described with reference to FIGS. 1-11. Now an example implementation of the terminal device and the network device will be discussed below.

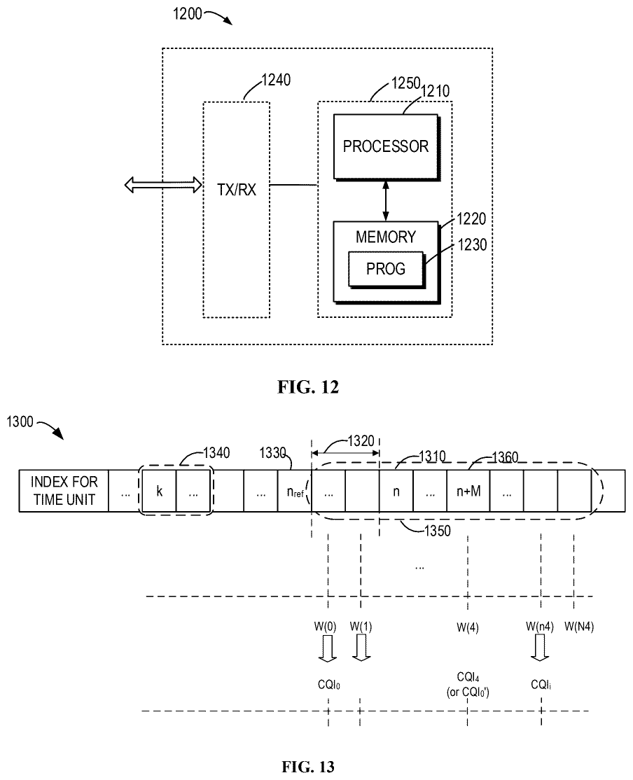

FIG. 12 illustrates a simplified block diagram of a device 1200 that is suitable for implementing embodiments of the present disclosure. The device 1200 can be considered as a further example implementation of the terminal device 130 and/or the network device 110 as shown in FIG. 1. Accordingly, the device 1200 can be implemented at or as at least a part of the terminal device 130 or the network device 110.

As shown in FIG. 12, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1210 stores at least apart of a program 1230. The TX/RX 1240 is for bidirectional communications. The TX/RX 1240 has at least one antenna to facilitate communication, though in practice an Access Node mentioned in this disclosure may have several ones. The communication interface may represent any interface that is necessary for communication with other network elements, such as X2 interface for bidirectional communications between eNBs, Si interface for communication between a Mobility Management Entity (MME)/Serving Gateway (S-GW) and the eNB, Un interface for communication between the eNB and a relay node (RN), or Uu interface for communication between the eNB and a terminal device.

The program 1230 is assumed to include program instructions that, when executed by the associated processor 1210, enable the device 1200 to operate in accordance with the embodiments of the present disclosure, as discussed herein with reference to FIGS. 3-11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

In summary, embodiments of the present disclosure may provide the following solutions.

A method of communication comprises: determining, at a terminal device, whether to apply Doppler/time domain compression or a Doppler/time domain basis type for reporting a precoding matrix indicator (PMI) to a network device; and transmitting, to the network device, an indication of whether to apply the Doppler/time domain compression or the Doppler/time domain basis type.

In one embodiment, the indication of applying the Doppler/time domain compression or the Doppler/time domain basis type indicates a plurality of Doppler/time domain basis vectors selected from a set of Doppler/time domain basis vectors.

In one embodiment, a first matrix associated with a Doppler/time domain and indicated in at least one codebook information field in the PMI comprises the plurality of Doppler/time domain basis vectors.

In one embodiment, the indication of not applying the Doppler/time domain compression or the Doppler/time domain basis type indicates a plurality of codebooks or a plurality of PMIs or a plurality of second matrixes for different indexes of time units associated with a Doppler/time domain but without the Doppler/time domain compression, each of the plurality of second matrixes being associated with coefficients for a codebook.

In one embodiment, the method as above further comprises: selecting the indexes of the time units based on an indication field for selecting Doppler/time domain basis vectors from a set of Doppler/time domain basis vectors.

In one embodiment, a first matrix associated with the Doppler/time domain and indicated in at least one codebook information field in the PMI is a permutation matrix.

In one embodiment, the indication of not applying the Doppler/time domain compression or the Doppler/time domain basis type indicates a codebook without a first matrix associated with a Doppler/time domain or without at least one codebook information field in the PMI.

In one embodiment, the codebook is indicated by: indicating one Doppler/time domain basis vector in a set of Doppler/time domain basis vectors.

In one embodiment, the codebook is indicated by: indicating one column of a second matrix associated with coefficients for the codebook as non-zero and all elements in other columns of the second matrix as zero.

In one embodiment, the non-zero column is indicated by a bitmap of a size of 2L×Md×Mv, 2L representing the number of spatial domain basis vectors, Md representing the number of Doppler/time domain basis vectors, and Mv representing the number of frequency domain basis vectors.

In one embodiment, the method as above further comprises: arranging a column of a strongest coefficient after the first column with all zero coefficients in the second matrix.

In one embodiment, the method as above further comprises: rotating a column including a strongest coefficient of a second matrix associated with coefficients for a codebook to be the first column of the second matrix.

In one embodiment, the method as above further comprises: determining a bit size of an indication field of the strongest coefficient based on 2L, 2L representing the number of spatial domain basis vectors; and determining a bit size of an indication field of Doppler/time domain basis vectors based on Ns−1 and Md−1, Md representing the number of Doppler/time domain basis vectors, and Ns representing one of the following: a length of Doppler/time domain basis vectors, the number of oversampled Doppler/time domain basis vectors, and the number of Doppler/time domain basis vectors in a window selected from the Doppler/time domain basis vectors or the oversampled Doppler/time domain basis vectors.

In one embodiment, if the Doppler/time domain compression or the Doppler/time domain basis type is applied, a first indication field indicates an element index of a strongest coefficient of a second matrix in a predefined column of the second matrix, the second matrix being associated with coefficients for a codebook; and if the Doppler/time domain compression or the Doppler/time domain basis type is not applied, a second indication field indicates a column index of the strongest coefficient in the second matrix and the first indication field indicates the element index of the strongest coefficient in the column.

In one embodiment, the indication of whether to apply the Doppler/time domain compression or the Doppler/time domain basis type is comprised in a first part of channel state information (CSI), and the first indication field and the second indication field are comprised in a second part of the CSI.

In one embodiment, if the Doppler/time domain compression or the Doppler/time domain basis type is applied, an indication field of a first size indicates an element index of a strongest coefficient in a second matrix in a predefined column of the second matrix, the second matrix being associated with coefficients for a codebook; and if the Doppler/time domain compression or the Doppler/time domain basis type is not applied, the indication field of a second size indicates a column index and an element index in the column for the strongest coefficient in the second matrix.

In one embodiment, the indication of whether to apply the Doppler/time domain compression or the Doppler/time domain basis type is comprised in a first part of channel state information (CSI), and the indication field for the strongest coefficient indication is comprised in a second part of the CSI.

In one embodiment, the method as above further comprises: determining a bit size for indicating each of a plurality of phase coefficients in a second matrix based on a length of Doppler/time domain basis vectors, the second matrix being associated with coefficients for a codebook.

In one embodiment, the method as above further comprises: reporting, to the network device, at least one of the number of Doppler/time domain basis vectors, a length of the Doppler/time domain basis vectors, a length of a time unit associated with a Doppler/time domain, and a bitmap of non-zero coefficients in a second matrix associated with coefficients for a codebook, or receiving at least one of the following from the network device: the number of the Doppler/time domain basis vectors, the length of the Doppler/time domain basis vectors, and the length of the time unit associated with the Doppler/time domain configured by the network device.

In one embodiment, the method as above further comprises: determining a length of a time unit associated with a Doppler/time domain as a time interval between channel state information (CSI)-reference signal (RS) resources for measurement.

In one embodiment, the method as above further comprises: in response to applying the Doppler/time domain compression or the Doppler/time domain basis type, determining a rank indicator (RI) as 1 or 2.

In one embodiment, determining whether to apply the Doppler/time domain compression or the Doppler/time domain basis type comprises: in response to determining that a velocity of the terminal device is higher than or equal to a predefined threshold velocity or a correlation between at least two CSI-RS resources is lower than or equal to a predefined threshold value, determining to apply the Doppler/time domain compression or the Doppler/time domain basis type; and in response to determining that the velocity of the terminal device is lower than or equal to the predefined threshold velocity or a correlation between at least two CSI-RS resources is higher than or equal to a predefined threshold value, determining not to apply the Doppler/time domain compression or the Doppler/time domain basis type.

A method for communication comprises: receiving, at a network device from a terminal device, an indication of whether Doppler/time domain compression or a Doppler/time domain basis type is to be applied for reporting a precoding matrix indicator (PMI) to the network device; and processing, based on the indication, the PMI reported by the terminal device.

In one embodiment, the indication that the Doppler/time domain compression or the Doppler/time domain basis type is to be applied indicates a plurality of Doppler/time domain basis vectors selected from a set of Doppler/time domain basis vectors.

In one embodiment, a first matrix associated with a Doppler/time domain and indicated in at least one codebook information field in the PMI comprises the plurality of Doppler/time domain basis vectors.

In one embodiment, the indication that the Doppler/time domain compression or the Doppler/time domain basis type is not to be applied indicates a plurality of codebooks or a plurality of PMIs or a plurality of second matrixes for different indexes of time units associated with a Doppler/time domain but without the Doppler/time domain compression, each of the plurality of second matrixes being associated with coefficients for a codebook.

In one embodiment, the method as above further comprises: determining the indexes of the time units based on an indication field for selecting Doppler/time domain basis vectors from a set of Doppler/time domain basis vectors.

In one embodiment, a first matrix associated with the Doppler/time domain and indicated in at least one codebook information field in the PMI is a permutation matrix.

In one embodiment, the indication that the Doppler/time domain compression or the Doppler/time domain basis type is not to be applied indicates a codebook without a first matrix associated with a Doppler/time domain or without at least one codebook information field in the PMI.

In one embodiment, the codebook is indicated by one Doppler/time domain basis vector in a set of Doppler/time domain basis vectors being indicated.

In one embodiment, the codebook is indicated by one column of a second matrix associated with coefficients for the codebook being indicated as non-zero and all elements in other columns of the second matrix being indicated as zero.

In one embodiment, the non-zero column is indicated by a bitmap of a size of 2L×Md×Mv, 2L representing the number of spatial domain basis vectors, Md representing the number of Doppler/time domain basis vectors, and Mv representing the number of frequency domain basis vectors.

In one embodiment, the method as above further comprises: determining that a column of a strongest coefficient is after the first column with all zero coefficients in the second matrix.

In one embodiment, the method as above further comprises: determining that a strongest coefficient of a second matrix associated with coefficients for a codebook is in the first column of the second matrix.

In one embodiment, the method as above further comprises: determining a bit size of an indication field of the strongest coefficient based on 2L, 2L representing the number of spatial domain basis vectors; and determining a bit size of an indication field of Doppler/time domain basis vectors based on Ns−1 and Md−1, Md representing the number of Doppler/time domain basis vectors, and Ns representing one of the following: a length of Doppler/time domain basis vectors, the number of oversampled Doppler/time domain basis vectors, and the number of Doppler/time domain basis vectors in a window selected from the Doppler/time domain basis vectors or the oversampled Doppler/time domain basis vectors.

In one embodiment, if the Doppler/time domain compression or the Doppler/time domain basis type is applied, a first indication field indicates an element index of a strongest coefficient of a second matrix in a predefined column of the second matrix, the second matrix being associated with coefficients for a codebook; and if the Doppler/time domain compression or the Doppler/time domain basis type is not applied, a second indication field indicates a column index of the strongest coefficient in the second matrix and the first indication field indicates the element index of the strongest coefficient in the column.

In one embodiment, the indication of whether the Doppler/time domain compression or the Doppler/time domain basis type is to be applied is comprised in a first part of the channel state information (CSI), and the first indication field and the second indication field are comprised in a second part of the CSI.

In one embodiment, if the Doppler/time domain compression or the Doppler/time domain basis type is applied, an indication field of a first size indicates an element index of a strongest coefficient in a second matrix in a predefined column of the second matrix, the second matrix being associated with coefficients for a codebook; and if the Doppler/time domain compression or the Doppler/time domain basis type is not applied, the indication field of a second size indicates a column index and an element index in the column for the strongest coefficient in the second matrix.

In one embodiment, the indication of whether the Doppler/time domain compression or the Doppler/time domain basis type is to be applied is comprised in a first part of channel state information (CSI), and the indication field for the strongest coefficient indication is comprised in a second part of the CSI.

In one embodiment, the method as above further comprises: determining a bit size for indicating each of a plurality of phase coefficients in a second matrix based on a length of Doppler/time domain basis vectors, the second matrix being associated with coefficients for a codebook.

In one embodiment, the method as above further comprises: receiving, from the terminal device, at least one of the number of Doppler/time domain basis vectors, a length of the Doppler/time domain basis vectors, a length of a time unit associated with a Doppler/time domain, and a bitmap of non-zero coefficients in a second matrix associated with coefficients for a codebook; or transmitting at least one of the following to the terminal device: the number of the Doppler/time domain basis vectors, the length of the Doppler/time domain basis vectors, and the length of the time unit associated with the Doppler/time domain configured by the network device.

In one embodiment, the method as above further comprises: determining a length of a time unit associated with a Doppler/time domain as a time interval between channel state information (CSI)-reference signal (RS) resources for measurement.

In one embodiment, the method as above further comprises: in response to the Doppler/time domain compression or the Doppler/time domain basis type being applied, determining a rank indicator (RI) as 1 or 2.

A terminal device comprising: a processor; and a memory storing computer program codes; the memory and the computer program codes configured to, with the processor, cause the terminal device to perform the method as above.

A network device comprising: a processor; and a memory storing computer program codes; the memory and the computer program codes configured to, with the processor, cause the network device to perform the method as above.

A computer readable medium having instructions stored thereon, the instructions, when executed by a processor of an apparatus, causing the apparatus to perform the method as above.

As mentioned above, the preferred pre-coder matrix for a terminal device may be time-sensitive. For example, in some situations, the terminal device may be an electronic device in a medium or high-velocity movement, and the channel characteristics between the network device and the terminal device may be varied fast relatively, such that the pre-coder matrix recommended by the terminal device (or a pre-coder matrix corresponding to an indication of codebook, such as, PMI, reported by the terminal device) is not applicable when the network device is to schedule data transmission to the terminal device.

In one solution, on the CSI reporting and measurement for the Type-II codebook refinement for high/medium velocities, a predetermined length (for example, N₄) of Doppler-Domain (DD) or Time-Domain (TD) basis vector are used to enhance the CSI report.

However, the details of enhancing the CSI report or CQI conditioned on Pre-coder Matrix Indicator (PMI) included in the CSI report are not considered. Further, the association between the CQI reported in the CSI report and an index of time unit/time duration is also a key aspect.

The example embodiments of the disclosure propose a mechanism for CSI reporting and measurement. In this mechanism, a terminal device determines a first set of CQIs conditioned on a first PMI, and the first PMI corresponds to a first time unit. A second timing of the first time unit is not earlier than a first timing of a first time duration for reporting CSI. Then, the terminal device transmits a CSI report comprising the first set of CQIs and the first PMI to a network device.

In this way, the network device may be aware of the CQI, codebook, or pre-coder Matrix measured and recommended by the terminal device for time units not earlier or later than the time duration for reporting CSI. Then, the network device may schedule data transmission for the terminal device based on this CQI, codebook, or pre-coder Matrix. As such, channel characteristics varieties caused by the movement of the terminal device having high/medium velocities can be countered when the network device is to schedule data transmission for the terminal device.

The terminal device 130 may move from a first position to a second position when performing CSI-RS measurement and transmitting the CSI report. For discussion clarity, the timing sequence with respect to the measurement of CSI RS, the transmission of the CSI report and the CQI time window is illustrated exemplarily in FIG. 13 The CQI time window comprises at least a part of time units associated with PMIs determined by the terminal device for the CSI report, and the CQIs reported in the CSI report are conditioned on these PMIs.

In the system 100, a link from the network devices 110 to the terminal device 130 is referred to as a downlink (DL), while a link from the terminal device 130 to the network devices 110 is referred to as an uplink (UL). In downlink, the network device 110 is a transmitting (TX) device (or a transmitter) and the terminal device 130 is a receiving (RX) device (or a receiver). In uplink, the terminal device 130 is a transmitting TX device (or a transmitter) and the network device 110 is a RX device (or a receiver). It is to be understood that the network device 110 may provide one or more serving cells. In some embodiments, the network device 110 can provide multiple cells.

The communications in the communication system 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future.

Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

FIG. 13 illustrates a timing diagram 1300 in accordance with some embodiments of the present disclosure.

In the timing diagram 1300, the time duration 1310 is used for transmitting CSI report. The terminal device 130 may transmit the CSI report in the time duration 1310. The time duration 1310 may comprise one or more slots. As an example in FIG. 13, the time duration 1310 is the slot with index n. In different cases, the time duration 1310 is determined respectively.

In periodic or semi-persistence CSI report, the time duration 1310 is periodic in the time-domain, the terminal device 130 may transmit the CSI report to the network device 110 in the time duration 1310 having predefined periodic. In this case, a CSI reference resource slot 1330 (which may be also referred to as n_{ref} 1330) may be determined based on the predefined time duration 1310. In general, the time length 1320 between the n_{ref} 1330 and the time duration 1310 is predefined or the n_{ref} 1330 may be determined by finding a slot having an index smaller than an index of time duration 1310 by a predefined value. In an example, the n_{ref} 1330 is calculated by the following equation (1):

$$n - {n}_{CSI \_ ref} - {K}_{offset} \cdot \frac{{2}^{{μ}_{D L}}}{{2}^{{μ}_{{K}_{offset}}}} \qquad ( 1 )$$

where K_{offset} is a parameter configured by higher layer], and where K_{offset} is the subcarrier spacing configuration for K_{offset} with a value of 0 for frequency range 1, where

$$n = ⌊ {n}^{′} \cdot \frac{{2}^{{μ}_{DL}}}{{2}^{{μ}_{DL}}} ⌋ + ⌊ ( \frac{{N}_{slot , offset , UL}^{CA}}{{2}^{{μ}_{offset , UL}}} - \frac{{N}_{slot , offset , DL}^{CA}}{{2}^{{μ}_{offset , DL}}} ) \cdot {2}^{{μ}_{D L}} ⌋ ,$$

where μ_{DL} and μ_{UL} are the subcarrier spacing configurations for DL and UL, respectively, and

$${N}_{slot , offset}^{C A}$$

and μ_{offset} are determined by higher-layer configured ca-SlotOffset for the cells transmitting the uplink and downlink.

The determined n_{ref} 1330 represents the timing boundary of measurement on the CSI-RS transmitted from the network device 110. The terminal device 130 should complete the measurement on CSI-RS before or not later than the n_{ref} 1330, in order to reserving processing time of a determining the CSI report by the terminal device 130. In some embodiments, the terminal device 130 measures CSI-RSs in multiple consecutive slots before n_{ref} 1330 to determine at least two PMIs. Further, multiple PMIs of which each corresponds to a slot can be measured by means of DD/TD basis vector. The length of these multiple consecutive slots are also referred to as a CSI-RS measurement window “Wₘₑₐₛ”. As shown in FIG. 13, block 1340 represents a CSI-RS measurement window associated with the n_{ref} 1330 for the time duration 1310. The location of the CSI-RS measurement window is [k, Wₘₑₐₙₛ−1], wherein k is the slot index of the starting slot of the CSI-RS measurement window.

In addition or alternatively to periodic or semi-persistence CSI report, the CSI report may be triggered by Downlink Control Information (DCI) comprising a CSI request from the network device 110. In this case, the time duration 1310 may be determined based on the slot in which the DCI comprising the CSI request is received. If the terminal device 130 is to transmit Physical Uplink Shared Channel (PUSCH), the slot delay or slot offset between the slot for receiving the DCI and the time duration 1310 is based on time domain resource assignment for PUSCH and predefined slot offset for CSI report. Otherwise, the slot delay or slot offset between the slot for receiving the DCI and the time duration 1310 may be only based on the predefined slot offset for CSI report. In this case, the n_{ref} 1330 may be determined based on the time duration 1310 in the same way as discussed above.

The CSI report comprises CSI-RS Resource Indicator (CRI), Rank Indicator (RI), PMI, CQI and Layer Indicator (LI). The RI is calculated conditioned on CRI. The PMI is calculated conditioned on RI and CRI. The CQI is calculated conditioned on PMI, RI and CRI. The LI is calculated conditioned on CQI, PMI, RI and CRI. As mentioned above, for handling the high/medium velocity movement of the terminal device 130, the CSI report comprises CQI conditioned on a PMI corresponding to a time unit that is not earlier than the time duration 1310. The time unit may comprise one or more slots and the time unit may be different from time duration or have the same time length as the time duration.

As shown in FIG. 13, the CSI report may comprise a CQI conditioned on a PMI corresponding to time unit 1360 with index “n+M”, where M is anon-negative integer. The PMI corresponding to time unit 1360 indicates a pre-coder matrix W(4) or a codebook W(4) for the time unit 1360 which is measured based on CSI-RS received in CSI measurement window 1340 and DD/TD basis vector. In some embodiments, the CSI report comprises a plurality of CQIs conditioned on PMIs corresponding to the time units in block 1350. The CQI conditioned on PMI corresponding to the first one of time units in block 1350 is shown as CQI₀ in FIG. 13. In some embodiments, the CSI report comprises a plurality of CQIs conditioned on PMIs corresponding to a part of time units in block 1360. The PMIs corresponding to the part of time units may be selected based on the predefined criteria which is discussed in detail in the following. In this case, the time units associated with the CSI report across the time duration 1310 for transmitting the CSI report. Accordingly, the CQI conditioned on PMI corresponding to the time unit 1360 in block 1350 is shown as CQI₄ in FIG. 13.

In some other embodiments, the CSI report only comprises CQIs conditioned on PMIs corresponding to the time units not earlier or later than the time unit 1360. In this case, the CQI conditioned on PMI corresponding to time unit 1360 is the CQI₀ (which is shown as CQI₀′ in FIG. 13) in the CSI report.

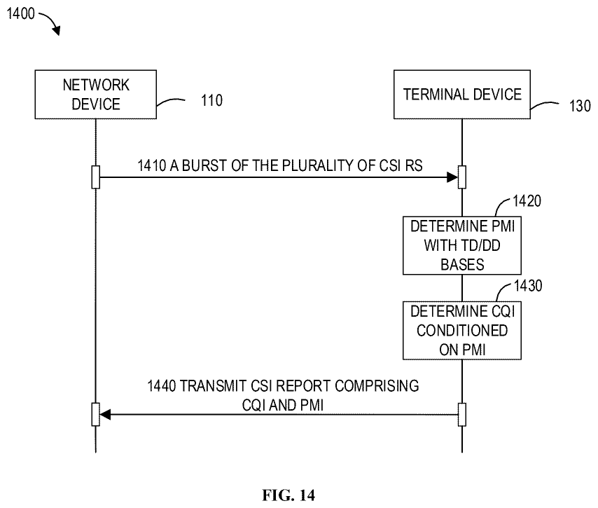

Without any limitation, FIG. 13 shows an example timing diagram according to embodiments of the present disclosure for a better understanding of the solutions proposed by this disclosure. The embodiments of detail processing operations are further discussed with reference to FIGS. 14 to 19C. FIG. 14 illustrates a signaling process 1400 in accordance with some embodiments of the present disclosure.

In the signaling process 1400, at 1410, the network device 110 transmits a burst of a plurality of CSI-RSs to the terminal device 130 for determining channel state between the network device 110 and terminal device 130. In some embodiments, the burst of the plurality of CSI-RSs comprises a plurality of CSI-RS resources, wherein at least one configuration/parameter for the CSI-RS resources may be same, the at least one configuration/parameter may include at least one of: resourceMapping (frequency domain resource, periodicity, number of symbols, subcarrier occupancy, number of ports, CDM type, density), power, TCI states for the plurality of CSI-RS resources. In addition or alternatively, the burst of the plurality of CSI-RSs comprises a first plurality of CSI-RS resources (e.g. the number may be 1), and a second plurality of CSI-RSs for tracking.

In addition or alternatively, the operation 1410 may be also expressed as below.

A UE is not expected to be configured with more than one CSI-RS resource in resource set
for channel measurement for a CSI-ReportConfig with the higher layer parameter
codebookType set to ‘typeII’, ‘typeII-PortSelection’, ‘typeII-r16’, ‘typeII-PortSelection-r16’,
or ‘typeII-PortSelection-r17’.
A UE is expected to be configured with more than one CSI-RS resource in resource set (or
to be configured with more than one resource set) for channel measurement for a CSI-
ReportConfig with the higher layer parameter codebookType set to ‘typeII-r18’.

At 1420, the terminal device 130 calculates PMIs corresponding to a plurality of time units based on the received the burst of the plurality of CSI-RSs and DD/TD basis vector having a predefined length (for example, N4). The determined PMI at least comprises one or more PMIs corresponding to time units not earlier or later than a first time duration for reporting CSI.

In addition or alternatively, the operation 1420 may be also expressed as below.

If the higher layer parameter timeRestrictionForChannelMeasurements is set to
“notConfigured”, the UE shall derive the channel measurements for computing CSI value
reported in uplink slot n based on only the NZP CSI-RS or a burst of NZP CSI-RS, no later
than the CSI reference resource, (defined in TS 38.211[4]) associated with the CSI resource
setting.
If the higher layer parameter timeRestrictionForChannelMeasurements in CSI-
ReportConfig is set to “Configured”, the UE shall derive the channel measurements for
computing CSI reported in uplink slot n based on only the most recent, no later than the
CSI reference resource, occasion of NZP CSI-RS or the burst of NZP CSI-RS (defined in
[4, TS 38.211]) associated with the CSI resource setting.
If the higher layer parameter timeRestrictionForInterferenceMeasurements is set to
“notConfigured”, the UE shall derive the interference measurements for computing CSI
value reported in uplink slot n based on only the CSI-IM and/or NZP CSI-RS or a burst of
NZP CSI-RS for interference measurement no later than the CSI reference resource
associated with the CSI resource setting.
If the higher layer parameter timeRestrictionForInterferenceMeasurements in CSI-
ReportConfig is set to “Configured”, the UE shall derive the interference measurements
for computing the CSI value reported in uplink slot n based on the most recent, no later
than the CSI reference resource, occasion of CSI-IM and/or NZP CSI-RS or the burst of
NZP CSI-RS for interference measurement (defined in [4, TS 38.211]) associated with the
CSI resource setting.

At 1430, the terminal device 130 determines a first set of CQIs conditioned on a first PMI corresponding to a first time unit. A second timing of the first time unit is not earlier than a first timing of a first time duration for reporting the CSI. In this disclosure, at least the terminal device 130 is configured with DD/TD basis reporting for PMI reporting, or the TD/DD compression is applied for codebook.

In some embodiments, the first time unit may be the first one of time units which are not earlier than or later than a third timing, and the third timing may be the first timing. In this case, the first time unit may comprise the slots of the first time duration and the slots after the first time duration. As such, the first PMI corresponding to the first time unit may be PMI(s) measured for a slot in the first time duration or a slot after the first time duration.

In addition or alternatively, the third timing may be a starting or ending of a time duration corresponding to an index determined based on a first index of the first time duration plus M, and the M is a non-negative integer. In this case, the first time unit may comprise the slots after the first time duration when the M is a positive integer. For example, if M=2, the third timing may be a starting or ending of a time duration with the index which is equal to the first index of the first time duration plus 2. As such, in an example, the first PMI corresponding to the first time unit may be PMI(s) measured for a slot after the first time duration, and the difference between an index of the slot and the index of the first time duration is the M. In addition, if M=0, then the third timing may be the first timing.

In some embodiments, a length of the M number of time durations is greater than or equal to a duration for decoding the CSI report by the network device 110. For example, the length of the M number of time durations is equal to the duration for decoding the CSI report and preparing scheduling by the network device 110. In this way, when the network device 110 is to schedule a data transmission to the terminal device 130, the network device 110 may retrieve, from the CSI report, CQI conditioned on PMI corresponding to a future time unit (the time unit for data transmission). As such, the network device 110 may determine a preferred pre-coder matrix or a codebook that is applicable during the data transmission to be performed.

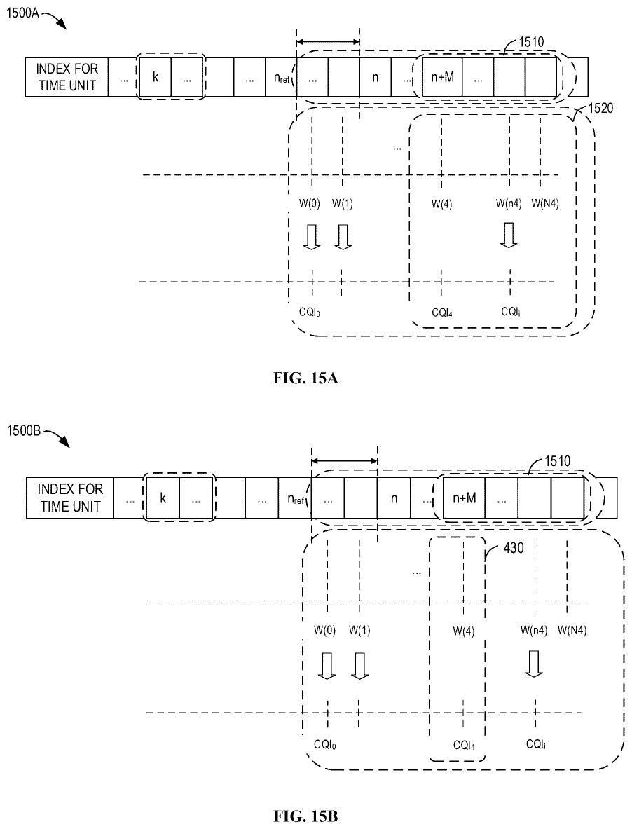

For discussion clarity, the association between the first set of CQIs and the first PMI is further discussed with reference to FIGS. 15A and 15B. FIG. 15A illustrate an example 1500A of a set of Channel Quality Indicators (CQI) reported in accordance with some embodiments of the present disclosure.

In FIG. 15A, as an example, the first set of CQI is calculated conditioned on PMI(s) corresponding to the first time unit in the time window 1510 starting with the time unit n+M. Further, the first set of CQI may comprise at least one of the first wideband CQI and a first plurality of sub-band CQIs.

For calculating the first set of CQIs, the terminal device 130 may calculate multiple PMIs and each of the multiple PMIs corresponds to a time unit in the time window 1510, respectively. For example, for each time unit in the time window 1510, the terminal device 130 may calculate a corresponding PMI.

In some embodiments, the terminal device 130 further calculates a PMI averaged over the multiple PMIs corresponding to the time units in the time window 1510. Then this average PMI is determined as the first PMI. The terminal device 130 calculates the first set of CQIs conditioned on this average PMI. For example, the at least one of the first wideband CQI and the first plurality of sub-band CQIs are determined based on the average PMI.

In some embodiments, the terminal device 130 iteratively filters the PMIs in the time unit order of the time window 1510 to obtain a filtered PMI for the time window 1510. The filtered PMI is determined as the first PMI. The terminal device 130 calculates the first set of CQIs conditioned on this filtered PMI. For example, the at least one of the first wideband CQI and the first plurality of sub-band CQIs are determined based on the filtered PMI.

In this case, the first set of CQIs are determined based on PMIs indicating the calculated codebooks or pre-coder matrices (for example, W(4), . . . , W(n4) and W(N4)) included in the block 1520. The block 1520 corresponds to the time window 1510.

In some other embodiments, the first PMI may be averaged or filtered over the PMIs corresponding to another time window across the time unit n, for example, the time window 250 as shown in FIG. 13. In addition or alternatively, the first PMI may be one PMI corresponding to a time unit in the time window 1510.

FIG. 15B illustrate an example 1500B of a set of Channel Quality Indicators (CQI) reported in accordance with some embodiments of the present disclosure. In FIG. 15B, as an example, the first PMI may be the calculated PMI corresponding to time unit n+M. In this case, the first set of CQIs is directly calculated conditioned on the PMI corresponding the time unit n+M. In this case, the first set of CQIs are determined based on PMI indicating the calculated codebook or pre-coder matrix (W(4)). As shown in FIG. 15B, the first set of PMI may comprise a wideband CQI₄, and a first plurality of sub-band CQI₄.

In addition or alternatively, the first PMI may be also one of: a PMI corresponding to time unit n, or a PMI corresponding to a time unit in the time window 1510. For example, the first PMI may be the PMI indicating the codebook W(4) or pre-coder matrix W(4), as shown in block 1530.

Referring back to FIG. 14, the terminal device 130 may determine a plurality of sets of CQIs associated with a first plurality of time units, and the above first set of CQIs is one of the plurality of sets of CQIs. A set of CQIs of the plurality of sets of CQIs is associated with a time unit of the first plurality of time units, and comprises at least one of a wideband CQI and a plurality of sub-band CQIs. The at least one of the wideband CQI and the plurality of sub-band CQIs are determined based on a PMI corresponding to the associated time unit.

As an example, there may be more than one sets of CQI (comprising the first set of CQIs) for wideband and/or for a plurality of sub-bands corresponding to one set of PMIs, and each set of CQI (for example, CQIᵢ, and each CQIᵢ may include at least one of a wideband CQI_{w_i} and a plurality of sub-band CQI_{sb_i}, wherein i may be the index of set of CQIs, sb may be the index of subband, for example 1≤sb≤19) may be associated with a time unit or a duration or a slot (e.g. T_{CQI_i}). The set of CQIs associated with the T_{CQI_i} may be calculated conditioned on the PMI(s) corresponding to T_{CQI_i} in the one set of PMIs. The number of sets of CQIs may be N_{c}, and N_{c} may be positive integer, and N_{c}≥1. In some embodiments, N_{c} may be configured by network device 110 or reported by the terminal device 130 (for example, in a first part in CSI report-CSI part 1). N_{c} may be 1≤N_{c}≤M_{d}, wherein M_{d} is the number of DD/TD basis corresponding to a set of PMIs.

In some embodiments, the first one of the first plurality of time units may be a time unit later than or not earlier than the first time duration for reporting CSI report. For example, the time unit or first slot of duration or the slot with index T_{CQI} may be no earlier than or later than slot n+Δn.

Referring to the example of FIG. 15A or FIG. 15B, the first one of the first plurality of time units may be the time unit n+M. In this case, the plurality of sets of CQIs may be associated with the time unit n+M and multiple time units after the time unit n+M. Further, each set of CQIs is associated with a corresponding time unit. As an example, if the plurality of sets of CQIs is associated with the time units in time window 1510, and the number of the plurality of sets of CQIs is equal to the number of time units in the time window 1510. In turn, each set of CQIs is associated with a corresponding time unit in the time window 1510. Specifically, the set of CQIs with index i is calculated conditioned on PMI(s) indicating the codebook W(i) or pre-coder matrix W(i). Alternatively, a number of sets of CQIs corresponding to a portion of the time window 1510 are determined.

In some embodiments, the first one of the first plurality of time units may be the first one in a time window across the time duration for reporting the CSI. For example, referring to the example of FIG. 13, the first plurality of time units may be the time units in time window 250. In this case, the plurality of sets of CQIs may be associated with the time unit in time window 250, the number of the plurality of sets of CQIs is equal to the number of time units in the time window 250. In turn, each set of CQIs is associated with a corresponding time unit in the time window 250. Specifically, the set of CQIs with index i is calculated conditioned on PMI(s) indicating the codebook W(i) or pre-coder matrix W (i). Alternatively, a number of sets of CQIs corresponding to a portion of the time window 250 are determined.

Referring back to FIG. 14, at 1440, the terminal device 130 transmits a CSI report comprising the first set of CQIs and the first PMI. In some embodiments, the CSI report comprises the plurality of sets of CQIs associated with a first plurality of time units and corresponding PMIs, as discussed above. In this disclosure, for discussion simplicity, the number of sets in the first plurality of time units may be N_{c}.

In some embodiments, the N_{c} is equal to the number of time units in a corresponding time window (for example, the time window 250 in FIG. 13 or the time window 1510 in FIGS. 15A and 15B). Specifically, each time unit in a corresponding time window has an associated set of CQIs in the CSI report.

Alternatively, the N_{c} is less than the number of time units in a corresponding time window. In this case, rather than all the sets of CQIs associated with the first plurality of time units being reported in the CSI report, only the number of sets of CQIs associated with a portion of the corresponding time window are reported. There may be a criterion for selecting a set of CQIs to be reported.

For example, if a difference between any other set of CQIs (after the first set of CQIs) and the first set of CQIs is above a first threshold, then the other set of CQIs may be reported in the CSI report. For example, referring to the example in FIG. 13, if the difference between the CQI₄ (or the set of CQI₄) conditioned on PMI indicating W(4) and the CQI₀ (or the set of CQI₀) conditioned on PMI indicating W(0) is above a first threshold, then the CQI₄ (or the set of CQI₄) is reported in the CSI report. Otherwise, the terminal device 130 will not transmit the CQI₄ (or the set of CQI₄) in the CSI report.

In addition or alternatively, if a difference between a set of CQIᵢ₋₁ and a set of CQIᵢ is above a second threshold, then the set of CQIᵢ may be reported in the CSI report. For example, referring to the example in FIG. 13, if the difference between the CQI₁ (or the set of CQI₁) conditioned on PMI indicating W(1) and the CQI₀ (or the set of CQI₀) conditioned on PMI indicating W(0) is above a second threshold, then the CQI₂ (or the set of CQI₂) is reported in the CSI report. Otherwise, the terminal device 130 will not transmit the CQI₂ (or the set of CQI₂) in the CSI report.

In addition, in some embodiments, if the difference between sets of CQIs or CQI indexes is very large (For example, lager than a threshold. For example, the threshold may be at least one of {4, 5, 6, 7, 8, 9, 10, 11, 12, 13, 14, 15}), the terminal device 130 may consider that the current conditions are not available for determining the channel state, and drop the CSI report without transmitting it. For example, if the difference between any other set of CQIs (after the first set of CQIs) and the first set of CQIs is above a third threshold or the difference between a set of CQIᵢ₋₁ and a set of CQIᵢ is above a fourth threshold, the CSI report will be dropped.

Regarding the payload of the plurality of sets of CQIs in the CSI report, it is discussed with reference to FIG. 16A and FIG. 16B for purpose of discussion clarity. FIG. 16A illustrates an example 1600A of multiple sets of CQIs reported in accordance with some embodiments of the present disclosure.

Without any limitation, taking the following sets of CQIs as an example for discussing payload: the set of CQI₀ comprising a wideband CQI_{w_0} and/or a plurality of sub-bands CQI_{sb_0}, the set of CQI₄ comprising a wideband CQI_{w_4} and/or a plurality of sub-bands CQI_{sb_4} and the set of CQIᵢ comprising a wideband CQI_{w_i} and/or a plurality of sub-bands CQI_{sb_i}. For simplicity, the set of CQI₀ may be the first set of CQIs in this example, the set of CQI₄ may be also referred to as a second set of CQIs and the set of CQIᵢ may be also referred to as a third set of CQIs.

In some embodiments, only the first set of CQIs is transmitted in the first part of CSI report, for example CSI part 1, the second set of CQIs and the third set of CQIs are transmitted in the second part of CSI report, for example CSI part 2. The first set of CQIs may be the set of CQIs associated with a starting or ending of a time duration corresponding to an index determined based on a first index of the first time duration plus M, wherein M is a non-negative integer. In addition or alternatively, the first set of CQIs may be the set of CQIs associated with a starting time unit of a time window across the first time duration.

FIG. 16B illustrate an example 1600B of multiple sets of CQIs reported in accordance with some embodiments of the present disclosure. As the example shown in FIG. 16B, the wideband CQI_{w_0} and/or the first plurality of sub-bands CQI_{s_0} are transmitted in the first part of CSI report. In turn, the wideband CQI_{w_i} and/or the plurality of sub-bands CQI_{s_i} are transmitted in the second part of CSI report. For example, the wideband CQI_{w_4} and/or the plurality of sub-bands CQI_{s_4} of the second set of CQIs are transmitted in the CQI part 2. In another example, the wideband CQI_{w_i} and/or the plurality of sub-bands CQI_{s_i} of the third set of CQIs are transmitted in the CQI part 2. In some embodiments, the CQI_{w_i} and/or the plurality of sub-bands CQI_{sb_i} may be indicated in a differential form relative to the CQI_{w_0} and/or the plurality of sub-bands CQI_{sb_0}.

Referring back to FIG. 16A, the payload the first wideband CQI_{w_0} may comprise a first number of bits, for example B₁ bits and B₁=4. The first number of bits indicate the absolute value of the first wideband CQI_{w_0}. Further, the payload of each sub-band CQI of the first plurality of sub-bands CQI_{sb_0} may comprise a second number of bits, for example B₂ bits and B₂=2. The second number of bits may indicate differential value related to the first wideband CQI_{w_0}. For example, Sub-band Offset level (for CQI_{sb_0})=sub-band CQI index (for CQI_{sb_0})—wideband CQI index (for CQI_{w_0}). Then, the calculated Sub-band Offset level is determined as the payload for the sub-band CQI_{sb_0}.

Specifically, the mapping between sub-band differential CQI value and offset value is shown in Table 2.

TABLE 2

| Sub-band differential CQI value | Offset level |
|---|---|
| 0 | 0 |
| 1 | 1 |
| 2 | ≥2 |
| 3 | ≤−1 |

For the sets of CQIs other than the first set of CQIs (for example, the second and third sets of CQIs), the corresponding wideband CQIᵢ (for example, CQI_{W_4} and CQI_{w_i}) may be indicated by a third number of bits, for example, B3 bits and B3=1, 2, 3 or 4. The third number of bits indicate a differential value between the wideband CQI (for example, CQI_{w_4} and CQI_{w_i}) in the set of CQIs with index i_{CQI} and the wideband CQI (for example, CQI_{w_0}) in the first set of CQIs. In turn, the first wideband CQI_{w_0} acts as the standard CQI for other wideband CQIs. In an example, for wideband CQI_{w_4}, the third number of bits indicating the differential value between the wideband CQI_{w_4} and the first wideband CQI_{w_0} is the payload of the wideband CQI_{w_4}.

For each sub-band CQI of a plurality of CQI_{sb_i} (for example, CQI_{sb_4} and CQI_{sb_i}), the payload of the sub-band CQI may be a third number of (B3) bits indicating the differential values between the corresponding sub-band CQI and the wideband CQI_{w_0}. In this case, Sub-band Offset level (for CQI_{sb_i})=sub-band CQI index (for CQI_{sb_i})−wideband CQI index (for CQI_{w_0}).

Alternatively, for each sub-band CQI of a plurality of CQI(for example, CQI_{sb_4} and CQI_{sb_i}), the payload of the sub-band CQI may be a second number of (B2) bits indicating the differential values between the corresponding sub-band CQI and the corresponding wideband CQI. In an example, for each sub-band CQI of a plurality of CQI_{sb_4}, the payload of the sub-band CQI may be a second number of (B2) bits indicating the differential values between the sub-band CQI and the wideband CQI_{w_4}. In another example, for each sub-band CQI of a plurality of CQI_{sb_i}, the payload of the sub-band CQI may be a second number of (B2) bits indicating the differential values between the sub-band CQI and the wideband CQI_{w_i}. In this case, Sub-band Offset level (for CQI_{sb_i})=sub-band CQI index (for CQI_{sb_i})−wideband CQI index (for CQI_{sb_i}).

In some embodiments, the differential value table may be different from Table 2, for example only if the CQI difference is large enough, the set of CQIᵢ is needed to be reported. In some other embodiments, the third number of bits only indicate non-negative value or non-positive value, if the first set of CQIs is determined based on searching the strongest set of CQIs or weakest set of CQIs. The strongest set of CQI may comprise a set of CQIs having the strongest absolute values and the weakest set of CQIs may comprise a set of CQIs having the smallest absolute values. Specifically, the mapping between wideband CQI differential CQI value or sub-band differential CQI value and offset value is shown in Table 3 and Table 4.

TABLE 3

| wideband or sub-band | |
|---|---|
| differential CQI value | Offset level |
| 0 | ≥−2 or ≥−1 |
| 1 | ≤−1 or ≤−2 |

TABLE 4

| wideband or sub-band | |
|---|---|
| differential CQI value | Offset level |
| 0 | ≥2 or ≥1 |
| 1 | ≤− 1 or ≤− 2 |

In some other embodiments, for each of the wideband CQIs (for example, CQI_{w_4} and CQI_{w_0}) other than the first wideband CQI₀, the wideband CQI may be indicated in a differential form related to the previous wideband CQI (rather than the first wideband CQI_{w_0}). For example, for the wideband CQ_{w_4}, the payload may comprise third number (B3) of bits indicating the differential values between the CQI_{w_4} and CQI_{w_3} associated with the previous time unit. For the wideband CQI_{w_i}, the payload may comprise third number (B3) of bits indicating the differential values between the CQI_{w_i} and CQI_{w_(i-1)} associated with the previous time unit. In an example, wideband Offset level (for CQI_{w_i})=Wideband CQI index (for CQI_{w_i})−wideband CQI index (for CQI_{w_(i-1)}). The payload for each differential wideband CQI_{w_i} (i≠0 or 1≤i≤S−1) may be B₃ bits.

In turn, in this case, for each sub-band CQI of a plurality of sub-band CQIs (for example, CQI_{sb_4} and CQI_{sb_i}), the payload of the sub-band CQI may be the second number (B2) of or the third number (B3) of bits indicating the differential values between the corresponding sub-band CQI and another CQIs acting as the standard CQI. The standard CQI may comprise one of: the first wideband CQI_{w_0}, the corresponding wideband CQI (for example, CQI_{sb_4} and CQI_{sb_i}), and the sub-band CQI for the same frequency sub-band which corresponds to the previous time unit.

For the wideband CQI_{w_0} or the corresponding wideband CQI (for example, CQI_{w_4} and CQI_{w_i}) which acts as the standard CQI, the payload of the sub-band CQI indicating differential value has been discussed in the above. For the sub-band CQI acting as the standard CQI, in an example, the payload sub-band CQI_{sb_4} may comprise the second number of or the third number of bits indicating a differential value between CQI_{sb_4} and CQI_{sb_3}. CQI_{sb_3} is the CQI for the same frequency sub-band and corresponds to the previous time unit (i.e., the time unit before the time unit associated with CQI_{sb_4} and continuous with the time unit associated with CQI_{sb_4}). Similarly, the payload sub-band CQI_{sb_i} may comprise the second number of or the third number of bits indicating a differential value between CQI_{sb_i} and CQI_{sb_(i-1)}. In an example, Sub-band Offset level (for CQI_{sb_i})=sub-band CQI index (for CQI_{sb_i})−sub-band CQI index (for CQI_{sb_i-1}).

In some further embodiments, for each of the wideband CQIs (for example, CQI_{w_4} and CQI_{sb_i}) other than the first wideband CQI₀, the payload of the wideband CQI may comprise the first number (B1) of or the third number (B3) of bits indicating the absolute values for this wideband CQI. In this case, the payload of each one in the plurality of subband CQI_{sb_i} (i≠0 or 1≤i≤S−1) may indicate the differential value related to the corresponding wideband CQI_{w_i} in the same set of CQI. Sub-band Offset level (for CQI_{sb_i})=sub-band CQI index (for CQI_{sb_i})—wideband CQI index (for CQI_{w_i}). A new CQI table may be used (for example, when the payload for wideband CQI is B₄ bits). In some embodiments, the sub-band CQI may be also indicated based on other standard CQI in the same way as discussed above.

In addition or alternatively, there may be the largest/strongest set of CQIs among the plurality of sets of CQIs. The time unit index or slot (T_{CQI_sc}) corresponding to the strongest CQI set and/or the index of the strongest CQI set may be reported or adjusted by the terminal device 130. In some embodiments, the strongest set of CQIs may be determined as the first set of CQIs as discussed above, such that (sc=0) or T_{CQI_sc}=T_{CQI_0}. Then, the differential value of CQI in other CQI set can be only non-positive. In this case, the wideband CQI in the strongest set of CQIs may act as the standard CQI of which the payload comprises the first number of bits indicating absolute values, and the payload of other CQIs may comprise a number of bits indicating the differential value related to the first set of CQIs which is the strongest set of CQIs. In some embodiments, the payload of other CQI (wideband CQI and a plurality of sub-band CQIs associated with other time units) may be determined in the same ways as above. Accordingly, the payload of the other CQI comprises only non-negative or only non-positive value.

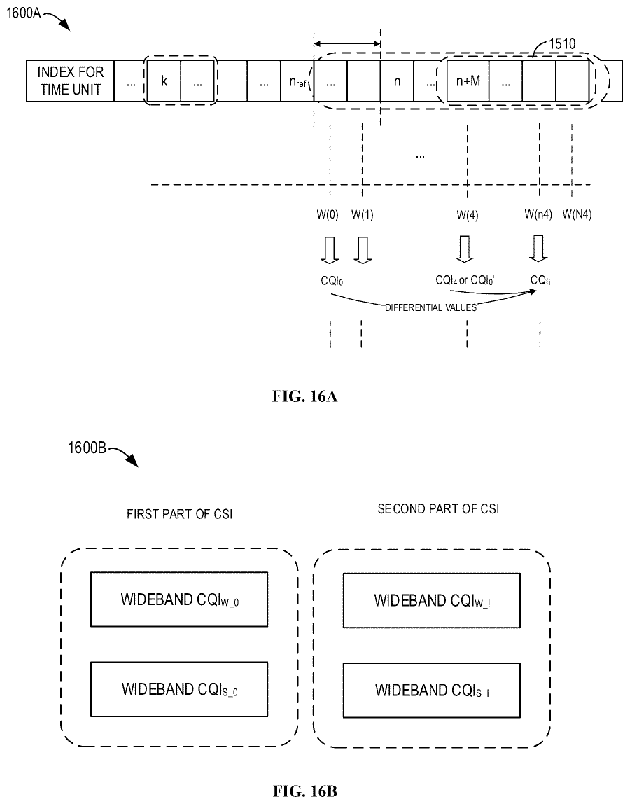

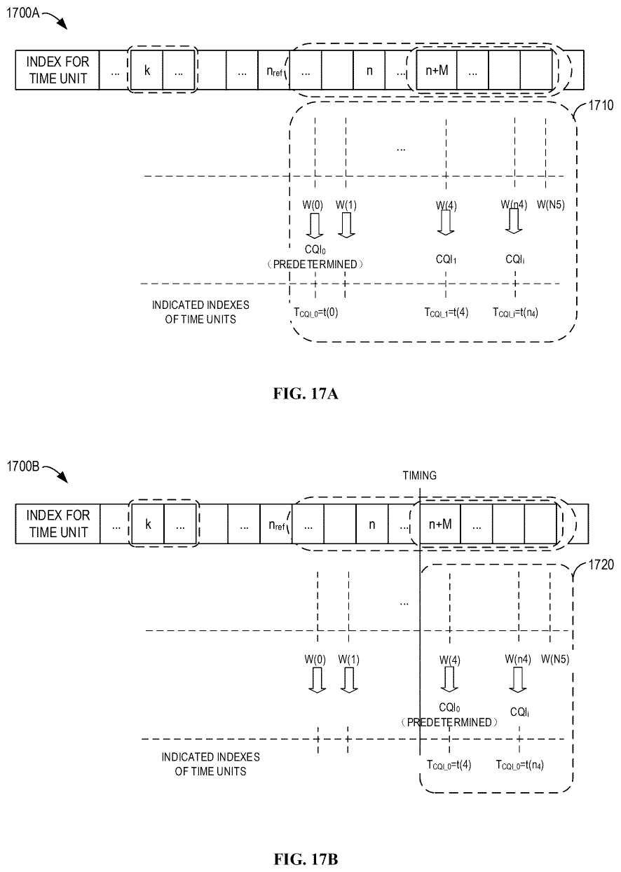

As discussed above, the reported sets of CQIs may be selected based on a predefined criterion, for example, the difference between sets of CQIs is above a first threshold or second threshold. In turn, the time units, slots or time durations associated with the reported sets of the CQIs should be also reported. In some embodiments, there may be a first indication field which is indicative of the associated time units, slots or durations. The terminal device 130 may transmit the first indication field in the second part of CSI report, for example, CSI part 2. For discussion clarity, the payload of the first indication field is discussed with reference to FIGS. 17A and 17B.

FIG. 17A illustrates corresponding time unit indexes 1700A reported in accordance with some embodiments of the present disclosure. As shown in FIG. 17A, as an example, a plurality of sets of CQIs associated with at least a portion of N5 time units is reported in the CSI report, as shown by block 1710 in FIG. 17. N5 may be a positive integer and is smaller than or equal to the length of TD/DD basis vector “N4” as mentioned above. In some embodiments, N5=N4. In some other embodiments, N5=ceil(N4/A), and A may be positive integer, such as A∈{2,3,4,5,6,7,8,10,12,16}.

In this case, the payload of the first indication field may be calculated as ceil [log₂(C(N5, Nc))], where “ceil” is a rounding up function, C(X,X) is the combination operation and Nc is the number of the reported plurality of sets of CQIs as mentioned above. In this way, all the possible combinations of selecting Nc time units from N5 time units are mapped to the bit sequences having the length of ceil [log₂(C(N5, Nc))]. Each bit sequence identifies a set of time units associated with the plurality of sets of CQIs, uniquely.

In some embodiments, C(a,b) may be a function of nchoosek(a,b). In some embodiments, nchoosek may be a function to choose k values from n values. In some embodiments, nchoosek(a,b)=a!/(b!*(a−b)!). In some embodiments, “!” may be factorial. In some embodiments, a!=1*2* . . . *(a−1)*a.

In addition or alternatively, there may be a time unit predefined between the network device 110 and the terminal device 130. For example, the time unit associated with the first set of CQIs as mentioned above, for example, the T_{CQI_0} as shown in FIG. 17A. The network device may be aware of this time unit in advance. In this case, the payload of the first indication field may be calculated as ceil [log₂(C(N5-1, Nc−1))]. In addition or alternatively, the predefined time unit may be any time unit, for example, the staring time unit of a time window across the first time duration, the time unit having index which is equal to n+M.

FIG. 17B illustrates corresponding time unit indexes 1700B reported in accordance with some embodiments of the present disclosure.

The payload for the first indication field may also depend on a timing and either one of N4 (the length of TD/DD basis) or a time window associated with the CSI report, wherein the timing may be the slot for CSI reporting (for example, slot n as shown in FIG. 17B) or the slot n+M. Without any limitation, taking the timing of slot n+M as the example. In this case, the bit size of the first indication field may be ceil [log 2(C(N5-X, Nc))], wherein X may be the number of time units earlier than the timing.

In addition or alternatively, there may be also a predefined time unit associated with the set of CQIs, as shown by T_{CQI_0} in FIG. 17B. In an example, the time unit index corresponding to the first set of CQI (CQI₀) may be predefined/predetermined/fixed to a time unit index or a slot or fixed to a first time unit or first slot no later than or later than the timing. Similarly, the bit size of the first indication field may be ceil [log 2(C(N5-X-1, Nc−1))], wherein X may be the number of time units earlier than the timing. In some embodiments, the predefined time unit may comprise at least one of: a starting time unit of the first plurality of time units; a starting time unit of a second plurality of time units; and the time unit corresponding to the strongest set of CQIs. In some embodiments, the first indication field is transmitted in the second part of CSI report, for example CSI part 2.

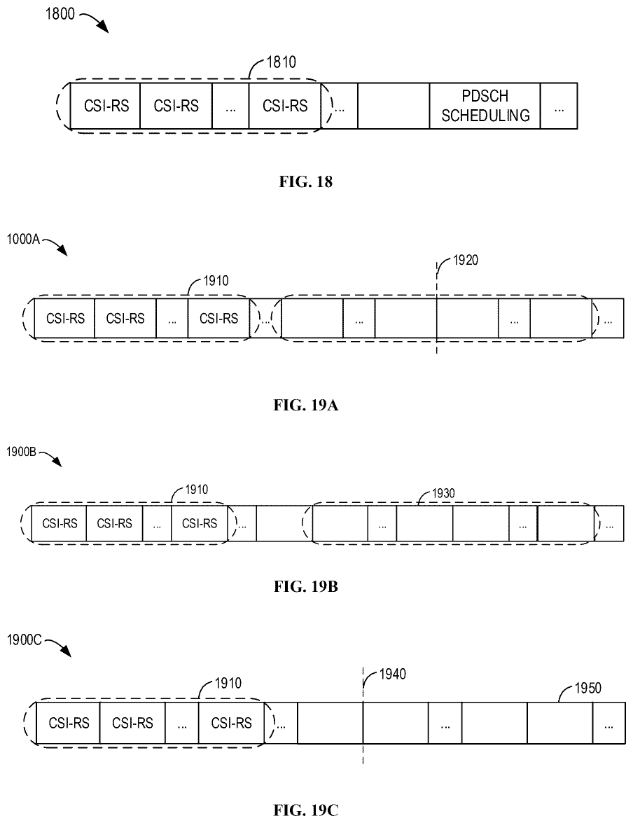

In addition to the payload of the plurality of sets of CQIs and the payload of the first indication field, the resource scheduling with respect to the Doppler property can be further considered. For discussion clarity, the resource scheduling with respect to the Doppler property is discussed with reference to FIG. 18.

FIG. 18 illustrates a timing diagram 1800 in accordance with some example embodiments of the present disclosure. The De-Modulation Reference Signal (DMRS) of Physical Downlink Shared Channel (PDSCH) is QCLed with a QCL source reference signal (for example, CSI-RS or TRS), while in case of TD/DD bases reporting, channel characteristic is reflected with TD/DD bases, the Doppler property corresponding to a time duration for PDSCH scheduling may be different from that corresponding to a time duration for QCL source RS.

In turn, in case of TD/DD bases reporting, the UE may assume that the DMRS port(s) of the PDSCH is quasi co-located with the DL RSs of TCI state(s) except for the quasi co-location parameters {Doppler shift, Doppler spread}. As shown in FIG. 18, the block 1810 represents the CSI measurement window. In addition, the TD/DD bases reported in CSI and/or the QCL source RS may be applied for the quasi co-location parameters {Doppler shift, Doppler spread}.

In addition, if the QCL source RS in TCI state(s) for a PDSCH scheduling is not same as or not QCLed with the RS for CSI acquisition, or within the duration WCSI, the TCI state(s) for PDSCH are changed, the codebook/CSI reporting may not be suitable for scheduling. This issue can be addressed by means of the following embodiments of the disclosure.

FIGS. 19A and 19B illustrates timing diagrams 1900A and 1900B in accordance with some example embodiments of the present disclosure. As shown in FIG. 19A, the block 1910 represents the CSI measurement window, the timing 1920 represents unified TCI state update. In addition, as shown in FIG. 19B, the CSI measurement window is not QCLed with time unit 1930 for QCL source RS in TCI state(s) and PDSCH scheduling.

The terminal device 130 may expect the QCL source RS at least for {Doppler shift} and/or {Doppler spread} in TCI state(s) for PDSCH scheduling is same as or QCLed with the RS for CSI acquisition (codebook with TD/DD bases) with respect to qcl-Type set to ‘typeA’. In addition or alternatively, the TD/DD bases reported in CSI and/or the corresponding RS for CSI acquisition (e.g. QCLed or related to the QCL source RS in TCI state for PDSCH) may be applied for the quasi co-location parameters {Doppler shift, Doppler spread}.

FIG. 19C illustrate timing diagram 1900C in accordance with some example embodiments of the present disclosure. In case of unified TCI framework, if the CSI-RS for CSI acquisition and/or CSI-RS for tracking (e.g. TRS) for TD/DD bases codebook reporting is not QCLed with the RS in the indicated TCI state, the terminal device 130 may drop the CSI report. Alternatively, the UE expect the CSI-RS for CSI acquisition and/or CSI-RS for tracking is QCLed with the RS in the indicated TCI state. As shown in FIG. 19C, timing 1910 represents unified TCI state changed or RS not QCLed with CSI-RS for CSI acquisition. At time unit 1950, the CSI report is dropped.

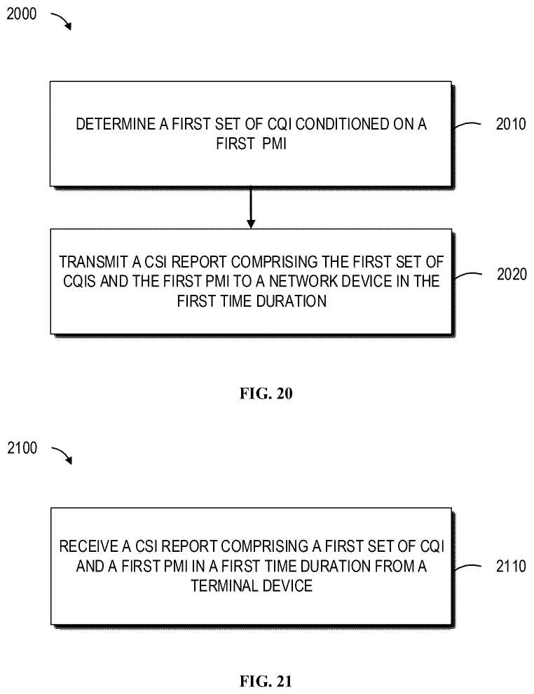

FIG. 20 illustrates a flowchart of an example method 2000 implemented at a terminal device according to some embodiments of the present disclosure. The method 2000 can be implemented at the terminal device 130. It is to be understood that the method 2000 may include additional acts not shown and/or may omit some shown acts, and the scope of the present disclosure is not limited in this regard.

At 2010, the terminal device 130 determines a first set of CQIs conditioned on a first PMI, the first PMI corresponding to a first time unit. A second timing of the first time unit is not earlier than a first timing of a first time duration for reporting CSI. At 2020, the terminal device 130 transmits, to a network device 110 in the first time duration, a CSI report comprising the first set of CQIs and the first PMI.

In some embodiments, the first time unit is the first one of time units which are not earlier than or later than a third timing, wherein the third timing comprises at least one of: the first timing; and a starting or ending of a time duration corresponding to an index determined based on a first index of the first time duration plus M, wherein M is a non-negative integer.

In some embodiments, a length of the M number of time durations is greater than or equal to a duration for decoding the CSI report by the network device. In some embodiments, the first set of CQIs comprises at least one of a first wideband CQI and a first plurality of sub-band CQIs. In some embodiments, the at least one of the first wideband CQI and the first plurality of sub-band CQIs are determined based on at least two PMIs comprising the first PMI. In some embodiments, the at least one of the first wideband CQI and the first plurality of sub-band CQIs are determined based on the first PMI.

In some embodiments, the CSI report comprises a plurality of sets of CQIs associated with a first plurality of time units. The plurality of sets of CQIs comprises the first set of CQIs. A set of CQIs of the plurality of sets of CQIs is associated with a time unit of the first plurality of time units and comprises at least one of a wideband CQI and a plurality of sub-band CQIs. The at least one of the wideband CQI and the plurality of sub-band CQIs are determined based on a PMI corresponding to the associated time unit.

In some embodiments, the CSI report further comprises at least one of a second set of CQIs associated with a second time unit and a third set of CQIs associated with a third time unit, and the second time unit is different from the first time unit and the third time unit is different from the second time unit.

In some embodiments, the second set of CQIs comprises at least one of a second wideband CQI and a second plurality of sub-band CQIs, and wherein the at least one of the second wideband CQI the second plurality of sub-band CQIs are determined based on a second PMI corresponding to the second time unit. The third set of CQIs comprises at least one of a third wideband CQI and a third plurality of sub-band CQIs, and wherein the at least one of the third wideband CQI and the third plurality of sub-band CQIs are determined based on a third PMI corresponding to the third time unit.

In some embodiments, transmitting the CSI report comprises: transmitting the first set of CQIs in a first part of the CSI report; and transmitting at least one of the second set of CQIs and the third set of CQIs in a second part of the CSI report.

In some embodiments, transmitting the CSI report comprising at least one of: in response to a difference between the second set of CQIs and the first set of CQIs is above a first threshold, transmitting the second set of CQIs; and in response to a difference between the third set of CQIs and the second set of CQIs is above a second threshold, transmitting the third set of CQIs.

In some embodiments, a payload of a wideband CQI in a set of CQIs with index i_{CQI} I of the plurality of sets of CQIs comprises at least one of: a first number of bits which indicate a value for the wideband CQI in the set of CQIs with index i_{CQI}; a third number of bits which indicate a differential value between the wideband CQI in the set of CQIs with index i_{CQI} and the wideband CQI in the first set of CQIs; or the third number of bits which indicate a differential value between the wideband CQI in the set of CQIs with index i_{CQI} and the wideband CQI in the set of CQIs with index i_{CQI}−1, and wherein a payload for one sub-band CQI of a plurality of sub-band CQIs in the set of CQIs with index i_{CQI} comprises at least one of: a second number of bits which indicate a differential value between the one sub-band CQI of the plurality of sub-band CQIs in the set of CQIs with index i_{CQI} and the wideband CQI in the set of CQIs with index i_{CQI}; the third number of bits which indicate a differential value between the one sub-band CQI of the plurality of sub-band CQIs in the set of CQIs with index i_{CQI} and the wideband CQI in the first set of CQIs; the second number or the third number of bits which indicate a differential value between the one sub-band CQI of the plurality of sub-band CQIs in the set of CQIs with index i_{CQI} and the one sub-band CQI of the plurality of sub-band CQIs in the set of CQIs with index i_{CQI}−1; and the third number of bits which indicate a differential value between the one sub-band CQI of the second plurality of sub-band CQIs and the wideband CQI with index i_{CQI}−1 in the set of CQIs, and wherein i_{CQI} is a positive integer, and i_{CQI} is larger than 1.

In some embodiments, a payload for the second wideband CQI comprises a first number of bits which indicate an absolute value for the second wideband CQI, and wherein the payload for a second sub-band CQI of the second plurality of sub-band CQIs comprises a second number of bits which indicate a differential value between the second sub-band CQI and the second wideband CQI.

In some embodiments, a payload of the second wideband CQI comprises a third number of bits which indicate a differential value between the second wideband CQI and the first wideband CQI, and wherein the payload for a second sub-band CQI of the second plurality of sub-band CQIs comprises at least one of: the third number of bits which indicate a differential value between the second sub-band CQI and the first wideband CQI; the second number of bits which indicate a differential value between the second sub-band CQI and the second wideband CQI; and the third number of bits which indicate a differential value between the second sub-band CQI and the one sub-band CQI of the first plurality of sub-band CQIs.

In some embodiments, a payload of the third wideband CQI comprises either one of: a third number of bits which indicate a differential value between the third wideband CQI and the second wideband CQI; or the third number of bits which indicate a differential value between the third wideband CQI and the first wideband CQI, and wherein the payload for a third sub-band CQI of the third plurality of sub-band CQIs comprises either one of: the second number of bits which indicate a differential value between the third sub-band CQI and the third wideband CQI; the third number of bits which indicate a differential value between the third sub-band CQI and the second sub-band CQI; or the third number of bits which indicate a differential value between the third sub-band CQI and a first sub-band CQI of the first plurality of sub-band CQIs.

In some embodiments, a payload of the third wideband CQI comprises the first number of bits which indicate an absolute value for the third wideband CQI, and the payload for a third sub-band CQI of the third plurality of sub-band CQIs comprises the second number or the third number of bits which indicate the differential value between the third sub-band CQI and the third wideband CQI.

In some embodiments, the first time unit is one of: a starting time unit of a first plurality of time units; a starting time unit of a second plurality of time units, and the second plurality of time units comprise a second number of time units determined from the first plurality of time units, wherein each time unit in the second plurality of time units is after or no earlier than the first timing; and a time unit corresponding to a strongest set of CQIs of the plurality of sets of CQIs, wherein the strongest set of CQIs comprises a wideband CQI or a sub-band CQI with a largest value among the plurality of sets of CQIs, and the CSI report comprises the index value of the time unit corresponding to the strongest set of CQIs.

In some embodiments, transmitting the CSI report comprises: transmitting an indication filed in a second part of the CSI report, the indication filed indicates the first plurality of time units. In some embodiments, a payload of the indication field is determined based on a fourth number of time units in the first plurality of time units and a number of sets of CQIs in the plurality of CQIs. In some embodiments, a payload of the indication field is determined based on the fifth number of time units in the second plurality of time units and a number of sets of CQIs in the plurality of sets of CQIs.

In some embodiments, the first set of CQIs comprises a set of CQIs which is associated with a predetermined time unit in the first plurality of time units, wherein the predetermined time unit comprises at least one of: a starting time unit of the first plurality of time units; a starting time unit of a second plurality of time units; and wherein the payload of the indication field is determined based on one of: the fourth number minus one and the number of sets of CQIs minus one; and the fifth number of time units in the second plurality of time units minus one and the number of sets of CQIs minus one.

FIG. 21 illustrates a flowchart of an example method 2100 implemented at a terminal device according to some embodiments of the present disclosure. The method 2100 can be implemented at the network device 110. It is to be understood that the method 2100 may include additional acts not shown and/or may omit some shown acts, and the scope of the present disclosure is not limited in this regard.

At 2110, the network device 110 receives, from the terminal device 130, a CSI report comprising a first set of CQI and a first PMI in a first time duration, the first set of CQIs being conditioned on the first PMI. The first PMI corresponds to a first time unit. A second timing of the first time unit is not earlier than a first timing of a first time duration for reporting the CSI.

In some embodiments, the first time unit is the first one of time units which are not earlier than or later than a third timing, wherein the third timing comprises at least one of: the first timing; and a starting or ending of a time duration corresponding to an index determined based on a first index of the first time duration plus M, wherein M is a non-negative integer.

In some embodiments, a length of the M number of time durations is greater than or equal to a duration for decoding the CSI report by the network device 110.

In some embodiments, the first set of CQIs comprises at least one of a first wideband CQI and a first plurality of sub-band CQIs. In some embodiments, the at least one of the first wideband CQI and the first plurality of sub-band CQIs are determined based on at least two PMIs comprising the first PMI. In some embodiments, the at least one of the first wideband CQI and the first plurality of sub-band CQIs are determined based on the first PMI.

In some embodiments, the CSI report comprises a plurality of sets of CQIs associated with a first plurality of time units. The plurality of sets of CQIs comprises the first set of CQIs. A set of CQIs of the plurality of sets of CQIs is associated with a time unit of the first plurality of time units and comprises at least one of a wideband CQI and a plurality of sub-band CQIs. The at least one of the wideband CQI and the plurality of sub-band CQIs are determined based on a PMI corresponding to the associated time unit.

In some embodiments, the CSI report further comprises at least one of a second set of CQIs associated with a second time unit and a third set of CQIs associated with a third time unit, and the second time unit is different from the first time unit and the third time unit is different from the second time unit.

In some embodiments, the second set of CQIs comprises at least one of a second wideband CQI and a second plurality of sub-band CQIs, and wherein the at least one of the second wideband CQI the second plurality of sub-band CQIs are determined based on a second PMI corresponding to the second time unit. The third set of CQIs comprises at least one of a third wideband CQI and a third plurality of sub-band CQIs, and wherein the at least one of the third wideband CQI and the third plurality of sub-band CQIs are determined based on a third PMI corresponding to the third time unit. In some embodiments, receiving the CSI report comprises: receiving the first set of CQIs in a first part of the CSI report; and receiving at least one of the second set of CQIs and the third set of CQIs in a second part of the CSI report.

In some embodiments, a payload of a wideband CQI in a set of CQIs with index i_{CQI} I of the plurality of sets of CQIs comprises at least one of: a first number of bits which indicate a value for the wideband CQI in the set of CQIs with index i_{CQI} z; a third number of bits which indicate a differential value between the wideband CQI in the set of CQIs with index i_{CQI} and the wideband CQI in the first set of CQIs; or the third number of bits which indicate a differential value between the wideband CQI in the set of CQIs with index i_{CQI} and the wideband CQI in the set of CQIs with index i_{CQI}−1, and wherein a payload for one sub-band CQI of a plurality of sub-band CQIs in the set of CQIs with index i_{CQI} comprises at least one of: a second number of bits which indicate a differential value between the one sub-band CQI of the plurality of sub-band CQIs in the set of CQIs with index i_{CQI} and the wideband CQI in the set of CQIs with index i_{CQI}; the third number of bits which indicate a differential value between the one sub-band CQI of the plurality of sub-band CQIs in the set of CQIs with index i_{CQI} and the wideband CQI in the first set of CQIs; the second number or the third number of bits which indicate a differential value between the one sub-band CQI of the plurality of sub-band CQIs in the set of CQIs with index i_{CQI} and the one sub-band CQI of the plurality of sub-band CQIs in the set of CQIs with index i_{CQI}−1; and the third number of bits which indicate a differential value between the one sub-band CQI of the second plurality of sub-band CQIs and the wideband CQI with index i_{CQI}−1 in the set of CQIs, and wherein i_{CQI} is a positive integer, and i_{CQI} is larger than 1.

In some embodiments, a payload for the second wideband CQI comprises a first number of bits which indicate an absolute value for the second wideband CQI, and wherein the payload for a second sub-band CQI of the second plurality of sub-band CQIs comprises a second number of bits which indicate a differential value between the second sub-band CQI and the second wideband CQI.

In some embodiments, a payload of the second wideband CQI comprises a third number of bits which indicate a differential value between the second wideband CQI and the first wideband CQI, and wherein the payload for a second sub-band CQI of the second plurality of sub-band CQIs comprises at least one of: the third number of bits which indicate a differential value between the second sub-band CQI and the first wideband CQI; the second number of bits which indicate a differential value between the second sub-band CQI and the second wideband CQI; and the third number of bits which indicate a differential value between the second sub-band CQI and the one sub-band CQI of the first plurality of sub-band CQIs.

In some embodiments, a payload of the third wideband CQI comprises either one of: a third number of bits which indicate a differential value between the third wideband CQI and the second wideband CQI; or the third number of bits which indicate a differential value between the third wideband CQI and the first wideband CQI, and wherein the payload for a third sub-band CQI of the third plurality of sub-band CQIs comprises either one of: the second number of bits which indicate a differential value between the third sub-band CQI and the third wideband CQI; the third number of bits which indicate a differential value between the third sub-band CQI and the second sub-band CQI; or the third number of bits which indicate a differential value between the third sub-band CQI and a first sub-band CQI of the first plurality of sub-band CQIs.

In some embodiments, a payload of the third wideband CQI comprises the first number of bits which indicate an absolute value for the third wideband CQI, and the payload for a third sub-band CQI of the third plurality of sub-band CQIs comprises the second number or the third number of bits which indicate the differential value between the third sub-band CQI and the third wideband CQI.

In some embodiments, the first time unit is one of: a starting time unit of a first plurality of time units; a starting time unit of a second plurality of time units, and the second plurality of time units comprise a second number of time units determined from the first plurality of time units, wherein each time unit in the second plurality of time units is after or no earlier than the first timing; and a time unit corresponding to a strongest set of CQIs of the plurality of sets of CQIs, wherein the strongest set of CQIs comprises a wideband CQI or a sub-band CQI with a largest value among the plurality of sets of CQIs, and the CSI report comprises the index value of the time unit corresponding to the strongest set of CQIs.

In some embodiments, receiving the CSI report comprises: receiving an indication filed in a second part of the CSI report, the indication filed indicates the first plurality of time units. In some embodiments, a payload of the indication field is determined based on a fourth number of time units in the first plurality of time units and a number of sets of CQIs in the plurality of CQIs. In some embodiments, a payload of the indication field is determined based on the fifth number of time units in the second plurality of time units and a number of sets of CQIs in the plurality of sets of CQIs.

In some embodiments, the first set of CQIs comprises a set of CQIs which is associated with a predetermined time unit in the first plurality of time units, wherein the predetermined time unit comprises at least one of: a starting time unit of the first plurality of time units; a starting time unit of a second plurality of time units; and wherein the payload of the indication field is determined based on one of: the fourth number minus one and the number of sets of CQIs minus one; and the fifth number of time units in the second plurality of time units minus one and the number of sets of CQIs minus one.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, technique terminal devices or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 13 to 21. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

In summary, embodiments of the present disclosure may provide the following solutions.

A communication method, comprising: determining, at a terminal device, a first set of Channel Quality Indicators (CQI) conditioned on a first Precoding Matrix Indicator (PMI), the first PMI corresponding to a first time unit, wherein a second timing of the first time unit is not earlier than a first timing of a first time duration for reporting Channel State Information (CSI); and transmitting, to a network device in the first time duration, a CSI report comprising the first set of CQIs and the first PMI.

In one embodiment, wherein the first time unit is the first one of time units which are not earlier than or later than a third timing, wherein the third timing comprises at least one of: the first timing; and a starting or ending of a time duration corresponding to an index determined based on a first index of the first time duration plus M, wherein M is a non-negative integer.

In one embodiment, wherein a length of the M number of time durations is greater than or equal to a duration for decoding the CSI report by the network device.

In one embodiment, wherein the first set of CQIs comprises at least one of a first wideband CQI and a first plurality of sub-band CQIs.

In one embodiment, wherein the at least one of the first wideband CQI and the first plurality of sub-band CQIs are determined based on at least two PMIs comprising the first PMI.

In one embodiment, wherein the at least one of the first wideband CQI and the first plurality of sub-band CQIs are determined based on the first PMI.

In one embodiment, wherein the CSI report comprises a plurality of sets of CQIs associated with a first plurality of time units, wherein the plurality of sets of CQIs comprises the first set of CQIs, wherein a set of CQIs of the plurality of sets of CQIs is associated with a time unit of the first plurality of time units and comprises at least one of a wideband CQI and a plurality of sub-band CQIs, and wherein the at least one of the wideband CQI and the plurality of sub-band CQIs are determined based on a PMI corresponding to the associated time unit.

In one embodiment, wherein the CSI report further comprises at least one of a second set of CQIs associated with a second time unit and a third set of CQIs associated with a third time unit, and wherein the second time unit is different from the first time unit and the third time unit is different from the second time unit.

In one embodiment, wherein the second set of CQIs comprises at least one of a second wideband CQI and a second plurality of sub-band CQIs, and wherein the at least one of the second wideband CQI the second plurality of sub-band CQIs are determined based on a second PMI corresponding to the second time unit, and wherein the third set of CQIs comprises at least one of a third wideband CQI and a third plurality of sub-band CQIs, and wherein the at least one of the third wideband CQI and the third plurality of sub-band CQIs are determined based on a third PMI corresponding to the third time unit.

In one embodiment, wherein transmitting the CSI report comprises: transmitting the first set of CQIs in a first part of the CSI report; and transmitting at least one of the second set of CQIs and the third set of CQIs in a second part of the CSI report.

In one embodiment, wherein transmitting the CSI report comprising at least one of: in response to a difference between the second set of CQIs and the first set of CQIs is above a first threshold, transmitting the second set of CQIs; and in response to a difference between the third set of CQIs and the second set of CQIs is above a second threshold, transmitting the third set of CQIs.

In one embodiment, wherein a payload of a wideband CQI in a set of CQIs with index iCQI of the plurality of sets of CQIs comprises at least one of: a first number of bits which indicate a value for the wideband CQI in the set of CQIs with index iCQI; a third number of bits which indicate a differential value between the wideband CQI in the set of CQIs with index iCQI and the wideband CQI in the first set of CQIs; or the third number of bits which indicate a differential value between the wideband CQI in the set of CQIs with index iCQI and the wideband CQI in the set of CQIs with index iCQI−1, and wherein a payload for one sub-band CQI of a plurality of sub-band CQIs in the set of CQIs with index iCQI comprises at least one of: a second number of bits which indicate a differential value between the one sub-band CQI of the plurality of sub-band CQIs in the set of CQIs with index iCQI and the wideband CQI in the set of CQIs with index iCQI; the third number of bits which indicate a differential value between the one sub-band CQI of the plurality of sub-band CQIs in the set of CQIs with index iCQI and the wideband CQI in the first set of CQIs; the second number or the third number of bits which indicate a differential value between the one sub-band CQI of the plurality of sub-band CQIs in the set of CQIs with index iCQI and the one sub-band CQI of the plurality of sub-band CQIs in the set of CQIs with index iCQI−1; and the third number of bits which indicate a differential value between the one sub-band CQI of the second plurality of sub-band CQIs and the wideband CQI with index iCQI−1 in the set of CQIs, and wherein iCQI is a positive integer, and iCQI is larger than 1.

In one embodiment, wherein a payload for the second wideband CQI comprises a first number of bits which indicate an absolute value for the second wideband CQI, and wherein the payload for a second sub-band CQI of the second plurality of sub-band CQIs comprises a second number of bits which indicate a differential value between the second sub-band CQI and the second wideband CQI.

In one embodiment, wherein a payload of the second wideband CQI comprises a third number of bits which indicate a differential value between the second wideband CQI and the first wideband CQI, and wherein the payload for a second sub-band CQI of the second plurality of sub-band CQIs comprises at least one of: the third number of bits which indicate a differential value between the second sub-band CQI and the first wideband CQI; the second number of bits which indicate a differential value between the second sub-band CQI and the second wideband CQI; and the third number of bits which indicate a differential value between the second sub-band CQI and the one sub-band CQI of the first plurality of sub-band CQIs.

In one embodiment, wherein a payload of the third wideband CQI comprises either one of: a third number of bits which indicate a differential value between the third wideband CQI and the second wideband CQI; or the third number of bits which indicate a differential value between the third wideband CQI and the first wideband CQI, and wherein the payload for a third sub-band CQI of the third plurality of sub-band CQIs comprises either one of: the second number of bits which indicate a differential value between the third sub-band CQI and the third wideband CQI; the third number of bits which indicate a differential value between the third sub-band CQI and the second sub-band CQI; or the third number of bits which indicate a differential value between the third sub-band CQI and a first sub-band CQI of the first plurality of sub-band CQIs.

In one embodiment, wherein a payload of the third wideband CQI comprises the first number of bits which indicate an absolute value for the third wideband CQI, and wherein the payload for a third sub-band CQI of the third plurality of sub-band CQIs comprises the second number or the third number of bits which indicate the differential value between the third sub-band CQI and the third wideband CQI.

In one embodiment, wherein the first time unit is one of: a starting time unit of a first plurality of time units; a starting time unit of a second plurality of time units, and the second plurality of time units comprise a second number of time units determined from the first plurality of time units, wherein each time unit in the second plurality of time units is after or no earlier than the first timing; and a time unit corresponding to a strongest set of CQIs of the plurality of sets of CQIs, wherein the strongest set of CQIs comprises a wideband CQI or a sub-band CQI with a largest value among the plurality of sets of CQIs, and the CSI report comprises the index value of the time unit corresponding to the strongest set of CQIs.

In one embodiment, wherein transmitting the CSI report comprises: transmitting an indication filed in a second part of the CSI report, the indication filed indicates the first plurality of time units.

In one embodiment, wherein a payload of the indication field is determined based on a fourth number of time units in the first plurality of time units and a number of sets of CQIs in the plurality of CQIs.

In one embodiment, wherein a payload of the indication field is determined based on the fifth number of time units in the second plurality of time units and a number of sets of CQIs in the plurality of sets of CQIs.

In one embodiment, wherein the first set of CQIs comprises a set of CQIs which is associated with a predetermined time unit in the first plurality of time units, wherein the predetermined time unit comprises at least one of: a starting time unit of the first plurality of time units; a starting time unit of a second plurality of time units; and the time unit corresponding to the strongest set of CQIs, and wherein the payload of the indication field is determined based on one of: the fourth number minus one and the number of sets of CQIs minus one; and the fifth number of time units in the second plurality of time units minus one and the number of sets of CQIs minus one.

A method of communication, comprising: receiving, at a network device and from a terminal device, a Channel State Information (CSI) report comprising a first set of Channel Quality Indicators (CQI) and a first Precoding Matrix Indicator (PMI) in a first time duration, the first set of CQIs being conditioned on the first PMI, the first PMI corresponding to a first time unit, and wherein a second timing of the first time unit is not earlier than a first timing of a first time duration for reporting the CSI.

In one embodiment, wherein the first time unit is the first one of time units which are not earlier than or later than a third timing, wherein the third timing comprises at least one of: the first timing; and a starting or ending of a time duration corresponding to an index determined based on a first index of the first time duration plus M, wherein M is a non-negative integer.

In one embodiment, wherein a length of the M number of time durations is greater than or equal to a duration for decoding the CSI report by the network device.

In one embodiment, wherein he first set of CQIs comprises at least one of a first wideband CQI and a first plurality of sub-band CQIs.

In one embodiment, wherein the at least one of the first wideband CQI and the first plurality of sub-band CQIs are determined based on at least two PMIs comprising the first PMI.

In one embodiment, the at least one of the first wideband CQI and the first plurality of sub-band CQIs are determined based on the first PMI.

In one embodiment, wherein the CSI report comprises a plurality of sets of CQIs associated with a first plurality of time units, wherein the plurality of sets of CQIs comprises the first set of CQIs, wherein a set of CQIs of the plurality of sets of CQIs is associated with a time unit of the first plurality of time units and comprises at least one of a wideband CQI and a plurality of sub-band CQIs, and wherein the at least one of the wideband CQI and the plurality of sub-band CQIs are determined based on a PMI corresponding to the associated time unit.

In one embodiment, wherein the CSI report further comprises at least one of a second set of CQIs associated with a second time unit and a third set of CQIs associated with a third time unit, and wherein the second time unit is different from the first time unit and the third time unit is different from the second time unit.

In one embodiment, wherein the second set of CQIs comprises at least one of a second wideband CQI and a second plurality of sub-band CQIs, and wherein the at least one of the second wideband CQI the second plurality of sub-band CQIs are determined based on a second PMI corresponding to the second time unit, and wherein the third set of CQIs comprises at least one of a third wideband CQI and a third plurality of sub-band CQIs, and wherein the at least one of the third wideband CQI and the third plurality of sub-band CQIs are determined based on a third PMI corresponding to the third time unit.

In one embodiment, wherein receiving the CSI report comprises: receiving the first set of CQIs in a first part of the CSI report; and receiving at least one of the second set of CQIs and the third set of CQIs in a second part of the CSI report.

In one embodiment, wherein a payload of a wideband CQI in a set of CQIs with index iCQI of the plurality of sets of CQIs comprises at least one of: a first number of bits which indicate a value for the wideband CQI in the set of CQIs with index iCQI; a third number of bits which indicate a differential value between the wideband CQI in the set of CQIs with index iCQI and the wideband CQI in the first set of CQIs; and the third number of bits which indicate a differential value between the wideband CQI in the set of CQIs with index iCQI and the wideband CQI in the set of CQIs with index iCQI−1, and wherein a payload for one sub-band CQI of a plurality of sub-band CQIs in the set of CQIs with index iCQI comprises at least one of: a second number of bits which indicate a differential value between the one sub-band CQI of the plurality of sub-band CQIs in the set of CQIs with index iCQI and the wideband CQI in the set of CQIs with index iCQI; the third number of bits which indicate a differential value between the one sub-band CQI of the plurality of sub-band CQIs in the set of CQIs with index iCQI and the wideband CQI in the first set of CQIs; the second number or the third number of bits which indicate a differential value between the one sub-band CQI of the plurality of sub-band CQIs in the set of CQIs with index iCQI and the one sub-band CQI of the plurality of sub-band CQIs in the set of CQIs with index iCQI−1; and the third number of bits which indicate a differential value between the one sub-band CQI of the second plurality of sub-band CQIs and the wideband CQI with index iCQI−1 in the set of CQIs, and wherein iCQI is a positive integer, and iCQI is larger than 1.

In one embodiment, wherein a payload for the second wideband CQI comprises a first number of bits which indicate an absolute value for the second wideband CQI, and wherein the payload for a second sub-band CQI of the second plurality of sub-band CQIs comprises a second number of bits which indicate a differential value between the second sub-band CQI and the second wideband CQI.

In one embodiment, wherein a payload of the second wideband CQI comprises a third number of bits which indicate a differential value between the second wideband CQI and the first wideband CQI, and wherein the payload for a second sub-band CQI of the second plurality of sub-band CQIs comprises at least one of: the third number of bits which indicate a differential value between the second sub-band CQI and the first wideband CQI; the second number of bits which indicate a differential value between the second sub-band CQI and the second wideband CQI; and the third number of bits which indicate a differential value between the second sub-band CQI and the one sub-band CQI of the first plurality of sub-band CQIs.

In one embodiment, wherein a payload of the third wideband CQI comprises either one of: a third number of bits which indicate a differential value between the third wideband CQI and the second wideband CQI; or the third number of bits which indicate a differential value between the third wideband CQI and the first wideband CQI, and wherein the payload for a third sub-band CQI of the third plurality of sub-band CQIs comprises either one of: the second number of bits which indicate a differential value between the third sub-band CQI and the third wideband CQI; the third number of bits which indicate a differential value between the third sub-band CQI and the second sub-band CQI; or the third number of bits which indicate a differential value between the third sub-band CQI and a first sub-band CQI of the first plurality of sub-band CQIs.

In one embodiment, wherein a payload of the third wideband CQI comprises the first number of bits which indicate an absolute value for the third wideband CQI, and wherein the payload for a third sub-band CQI of the third plurality of sub-band CQIs comprises the second number or the third number of bits which indicate the differential value between the third sub-band CQI and the third wideband CQI.

In one embodiment, wherein the first time unit is one of: a starting time unit of a first plurality of time units; a starting time unit of a second plurality of time units, and the second plurality of time units comprise a second number of time units determined from the first plurality of time units, wherein each time unit in the second plurality of time units is after or no earlier than the first timing; and a time unit corresponding to a strongest set of CQIs of the plurality of sets of CQIs, wherein the strongest set of CQIs comprises a wideband CQI or a sub-band CQI with a largest value among the plurality of sets of CQIs, and the CSI report comprises the index value of the time unit corresponding to the strongest set of CQIs.

In one embodiment, wherein receiving the CSI report comprises: receiving an indication filed in a second part of the CSI report, the indication filed indicates the first plurality of time units.

In one embodiment, wherein a payload of the indication field is determined based on a fourth number of time units in the first plurality of time units and a number of sets of CQIs in the plurality of CQIs.

In one embodiment, wherein a payload of the indication field is determined based on the fifth number of time units in the second plurality of time units and a number of sets of CQIs in the plurality of sets of CQIs.

In one embodiment, wherein the first set of CQIs comprises a set of CQIs which is associated with a predetermined time unit in the first plurality of time units, wherein the predetermined time unit comprises at least one of: a starting time unit of the first plurality of time units; a starting time unit of a second plurality of time units; and the time unit corresponding to the strongest set of CQIs, and wherein the payload of the indication field is determined based on one of: the fourth number minus one and the number of sets of CQIs minus one; and the fifth number of time units in the second plurality of time units minus one and the number of sets of CQIs minus one.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 6-20. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method of a User Equipment (UE), the method comprising:
receiving, from a network, a Channel-State Information (CSI) Reference Signal (CSI-RS); and
sending, to the network, a CSI report at a first timing,
wherein the CSI report includes a Precoding Matrix Indicator (PMI) which indicates one or more precoder matrices associated with one or more time units,
wherein earliest of the one or more time units starts at a second timing after the first timing,
wherein the CSI report includes one or more Channel Quality Indicators (CQIs) which are associated with the one or more precoder matrices for the one or more time units,
wherein the one or more CQIs include a first CQI and a second CQI,
wherein the CSI report comprises two parts which include a Part 1 CSI report and a Part 2 CSI report, and
wherein the Part 1 CSI report contains the first CQI and the Part 2 CSI report contains the second CQI.

22. The method according to claim 21,
wherein the one or more time units include a first time unit,
wherein the one or more precoder matrices include first precoder matrices associated with the first time unit, and
wherein the first CQI is associated with the first precoder matrices for the first time unit.

23. The method according to claim 22,
wherein the one or more time units include a second time unit,
wherein the one or more precoder matrices include second precoder matrices associated with the second time unit, and
wherein the second CQI is associated with the second precoder matrices for the second time unit.

24. The method according to claim 21,
wherein the first timing is a first slot,
wherein the second timing is a second slot, and
wherein the one or more time units are related to one or more slot intervals.

25. The method according to claim 21,
wherein the one or more CQIs include a subband CQI.

26. The method according to claim 21,
wherein the one or more CQIs include a wideband CQI.

27. A method of a network device, the method comprising:
sending, to a User Equipment (UE), a Channel-State Information (CSI) Reference Signal (CSI-RS); and
receiving, from the UE, a CSI report at a first timing,
wherein the CSI report includes a Precoding Matrix Indicator (PMI) which indicates one or more precoder matrices associated with one or more time units,
wherein earliest of the one or more time units starts at a second timing after the first timing,
wherein the CSI report includes one or more Channel Quality Indicators (CQIs) which are associated with the one or more precoder matrices for the one or more time units,
wherein the one or more CQIs include a first CQI and a second CQI,
wherein the CSI report comprises two parts which include a Part 1 CSI report and a Part 2 CSI report, and
wherein the Part 1 CSI report contains the first CQI and the Part 2 CSI report contains the second CQI.

28. The method according to claim 27,
wherein the one or more time units include a first time unit,
wherein the one or more precoder matrices include first precoder matrices associated with the first time unit, and
wherein the first CQI is associated with the first precoder matrices for the first time unit.

29. The method according to claim 28,
wherein the one or more time units include a second time unit,
wherein the one or more precoder matrices include second precoder matrices associated with the second time unit, and
wherein the second CQI is associated with the second precoder matrices for the second time unit.

30. The method according to claim 27,
wherein the first timing is a first slot,
wherein the second timing is a second slot, and
wherein the one or more time units are related to one or more slot intervals.

31. The method according to claim 27,
wherein the one or more CQIs include a subband CQI.

32. The method according to claim 27,
wherein the one or more CQIs include a wideband CQI.

33. A User Equipment (UE) comprising:
a memory; and
a processor coupled with the memory, wherein the processor is configured to:
receive, from a network, a Channel-State Information (CSI) Reference Signal (CSI-RS), and
send, to the network, a CSI report at a first timing,
wherein the CSI report includes a Precoding Matrix Indicator (PMI) which indicates one or more precoder matrices associated with one or more time units,
wherein earliest of the one or more time units starts at a second timing after the first timing,
wherein the CSI report includes one or more Channel Quality Indicators (CQIs) which are associated with the one or more precoder matrices for the one or more time units,
wherein the one or more CQIs include a first CQI and a second CQI,
wherein the CSI report comprises two parts which include a Part 1 CSI report and a Part 2 CSI report, and
wherein the Part 1 CSI report contains the first CQI and the Part 2 CSI report contains the second CQI.

34. A network device comprising:
a memory; and
a processor coupled with the memory, wherein the processor is configured to:
send, to a User Equipment (UE), a Channel-State Information (CSI) Reference Signal (CSI-RS), and
receive, from the UE, a CSI report at a first timing,
wherein the CSI report includes a Precoding Matrix Indicator (PMI) which indicates one or more precoder matrices associated with one or more time units,
wherein earliest of the one or more time units starts at a second timing after the first timing,
wherein the CSI report includes one or more Channel Quality Indicators (CQIs) which are associated with the one or more precoder matrices for the one or more time units,
wherein the one or more CQIs include a first CQI and a second CQI,
wherein the CSI report comprises two parts which include a Part 1 CSI report and a Part 2 CSI report, and
wherein the Part 1 CSI report contains the first CQI and the Part 2 CSI report contains the second CQI.
